(19) United States
(12) Patent Application Publication
(10) Pub. No.: US 2004/0153227 A1
(43) Pub. Date: Aug. 5, 2004

(54) Fuzzy controller with a reduced number of sensors

(76) Inventors: Takahide Hagiwara, Iwata-shi (JP); Sergei V. Ulyanov, Crema (IT); Sergei A. Panfilov, Crema (IT); Kazuki Takahashi, Crema (IT); Chikako Kaneko, Iwata-shi (JP); Olga Diamante, Catania (IT)

Correspondence Address: KNOBBE MARTENS OLSON & BEAR LLP, 2040 MAIN STREET, FOURTEENTH FLOOR, IRVINE, CA, 92614, US

(21) Appl. No.: 10/662,978

(22) Filed: Sep. 15, 2003

Related U.S. Application Data
(60) Provisional application No. 60/410,741, filed on Sep. 13, 2002.

(51) Int. Cl. B62K 25/00; G06N 3/00

(52) U.S. Cl. 701/40; 706/13

(57) ABSTRACT

A control system for optimizing the performance of a vehicle suspension system by controlling the damping factor of one or more shock absorbers is described. In one embodiment, the control system uses a fuzzy neural network. A teaching signal for the fuzzy neural network is generated using road signal data and a mathematical model of the vehicle suspension system. The teaching signal is used to develop a knowledge base for the fuzzy neural network. In one embodiment, inputs to the fuzzy neural network include damper velocities, heave acceleration, pitch acceleration, and roll acceleration. In one embodiment, the heave acceleration signal from the teaching signal is filtered to develop inputs for the fuzzy neural network, thereby reducing the number of sensors. In one embodiment, a Fourier transform analysis of the heave acceleration signal is provided to the fuzzy neural network.

### REFERENCE TO RELATED APPLICATION

The present application claims priority benefit of U.S. Provisional Application No. 60/410,741, filed Sep. 13, 2002, titled “FUZZY CONTROLLER WITH A REDUCED NUMBER OF SENSORS”, the entire contents of which is hereby incorporated by reference.

### BACKGROUND OF THE INVENTION

1. Field of the Invention

This invention relates to an optimization control method for a shock absorber having a non-linear kinetic characteristic.

2. Description of the Related Art

Feedback control systems are widely used to maintain the output of a dynamic system at a desired value in spite of external disturbance forces that would move the output away from the desired value. For example, a household furnace controlled by a thermostat is an example of a feedback control system. The thermostat continuously measures the air temperature of the house, and when the temperature falls below a desired minimum temperature, the thermostat turns the furnace on. When the furnace has warmed the air above the desired minimum temperature, then the thermostat turns the furnace off. The thermostat-furnace system maintains the household temperature at a constant value in spite of external disturbances such as a drop in the outside air temperature. Similar types of feedback control are used in many applications.

A central component in a feedback control system is a controlled object, otherwise known as a process “plant,” whose output variable is to be controlled. In the above example, the plant is the house, the output variable is the air temperature of the house, and the disturbance is the flow of heat through the walls of the house. The plant is controlled by a control system. In the above example, the control system is the thermostat in combination with the furnace. The thermostat-furnace system uses simple on-off feedback control to maintain the temperature of the house. In many control environments, such as motor shaft position or motor speed control systems, simple on-off feedback control is insufficient. More advanced control systems rely on combinations of proportional feedback control, integral feedback control, and derivative feedback control. Feedback that is the sum of proportional plus integral plus derivative feedback is often referred to as PID control.

The PID control system is a linear control system that is based on a dynamic model of the plant. In classical control systems, a linear dynamic model is obtained in the form of dynamic equations, usually ordinary differential equations. The plant is assumed to be relatively linear, time invariant, and stable. However, many real-world plants are time varying, highly nonlinear, and unstable. For example, the dynamic model may contain parameters (e.g., masses, inductances, aerodynamic coefficients, etc.) which are either poorly known or depend on a changing environment. Under these conditions, a linear PID controller is insufficient.

Evaluating the motion characteristics of a nonlinear plant is often difficult, in part due to the lack of a general analysis method. Conventionally, when controlling a plant with nonlinear motion characteristics, it is common to find certain equilibrium points of the plant and the motion characteristics of the plant are linearized in a vicinity near an equilibrium point. Control is then based on evaluating the pseudo (linearized) motion characteristics near the equilibrium point. This technique works poorly, if at all, for plants described by models that are unstable or dissipative. The optimization control for a non-linear kinetic characteristic of a controlled process has not been well developed. A general analysis method for non-linear kinetic characteristic has not been previously available, so a control device suited for the linear-kinetic characteristic is often substituted. Namely, for the controlled process with the non-linear kinetic characteristic, a suitable balance point for the kinetic characteristic is picked. Then, the kinetic characteristic of the controlled process is linearized in a vicinity of the balance point, whereby the evaluation is conducted relative to pseudo-kinetic characteristics.

However, this method has several disadvantageous. Although the optimization control may be accurately conducted around the balance point, its accuracy decreases beyond this balance point. Further, this method cannot typically keep up with various kinds of environmental changes around the controlled process.

Shock absorbers used for automobiles and motor cycles are one example of a controlled process having the non-linear kinetic characteristic. The optimization of the non-linear kinetic characteristic has been long sought because vehicle's turning performances and ride are greatly affected by the damping characteristic and output of the shock absorbers. Moreover, the use of many sensors to sense system dynamics can increase the cost and complexity of the system.

### SUMMARY OF THE INVENTION

The present invention solves these and other problems by providing a model-based design methodology of robust intelligent semi-active suspension control system to a passenger car based on stochastic simulation and soft computing to reduce the number of sensors used in the system. In one embodiment, a globally-optimized teaching signal for damper control is generated by a genetic algorithm. A fitness function of the genetic algorithm is configured to satisfy conflicting requirements such as, ride comfort, stability, etc. Selection of input signals for the fuzzy controller is realized to provide accurate and robust control, thereby making it possible to reduce the number of sensors. In one embodiment, the knowledge base is optimized for various kinds of stochastic road signals on a computer, reducing or eliminating the need for actual field test data.

One embodiment of an electronically-controlled suspension system for an automobile uses sensors to collect information regarding the travel and velocity of various elements of the suspension system and/or the car body. The electronically-controlled suspension system uses the sensor data to calculate control parameters and control outputs to control the shock absorbers connected to the suspension system. In some systems, as many as three accelerometers and four position sensors are used to obtain the sensor information. The use of so many sensors increases the cost of the system. In one embodiment, a reduced number of sensors is used and the system supplements the lack of sensor information by using a well-learned knowledge base in a fuzzy controller. One embodiment includes an improved input signal set for better learning, consequently realizing better performance of the fuzzy controller with the reduced number of sensors.

In one embodiment, a single accelerometer is used to measure the vertical car body acceleration. From the vertical acceleration, other useful information can be extracted through filters. This information is supplied to the fuzzy controller.

In one embodiment, the suspension control uses a difference between the time differential (derivative) of entropy from the learning control unit and the time differential of the entropy inside the controlled process (or a model of the controlled process) as a measure of control performance. In one embodiment, the entropy calculation is based on a thermodynamic model of an equation of motion for a controlled process plant that is treated as an open dynamic system.

In one embodiment, the control system is trained by a genetic analyzer. The optimized control system provides an optimum control signal based on data obtained from one or more sensors. For example, in a suspension system, one or more angle and/or position sensors can be used. In an off-line (laboratory) learning mode, fuzzy rules are evolved using a kinetic model (or simulation) and an improved input signal set. Data from the kinetic model is provided to an entropy calculator which calculates input and output entropy production of the model. The input and output entropy productions are provided to a fitness function calculator that calculates a fitness function as a difference in entropy production rates for the genetic analyzer. The genetic analyzer uses the fitness function to develop a training signal for the off-line control system. Control parameters from the off-line control system are then provided to an online control system in the vehicle.

In one embodiment, a method for controlling a nonlinear object (a plant) by obtaining an entropy production difference between a time differentiation (dSᵤ/dt) of the entropy of the plant and a time differentiation (dS_{c}/dt) of the entropy provided to the plant from a controller trained using an improved input signal set. A genetic algorithm that uses the entropy production difference as a fitness (performance) function evolves a control rule in an off-line controller. The nonlinear stability characteristics of the plant are evaluated using a Lyapunov function. The genetic analyzer minimizes entropy and maximizes sensor information content. Control rules from the off-line controller are provided to an online controller to control suspension system. In one embodiment, the online controller controls the damping factor of one or more shock absorbers (dampers) in the vehicle suspension system.

### BRIEF DESCRIPTION OF THE DRAWINGS

The advantages and features of the disclosed invention will readily be appreciated by persons skilled in the art from the following detailed description when read in conjunction with the drawings listed below.

FIG. 1 is a block diagram illustrating a control system for a shock absorber.

FIG. 2A is a block diagram showing a fuzzy control unit that estimates an optimal throttle amount for each shock absorber and outputs signals according to the predetermined fuzzy rule based on the detection results.

FIG. 2B is a block diagram showing a learning control unit having a fuzzy neural network.

FIG. 3 is a schematic diagram of a four-wheel vehicle suspension system showing the parameters of the kinetic models for the vehicle and suspension system.

FIG. 4 is a detailed view of the parameters associated with the right-front wheel from FIG. 3.

FIG. 5 is a detailed view of the parameters associated with the left-front wheel from FIG. 3.

FIG. 6 is a detailed view of the parameters associated with the right-rear wheel from FIG. 3.

FIG. 7 is a detailed view of the parameters associated with the left-rear wheel from

FIG. 8 shows characteristics of the variable dampers.

FIG. 9 shows plots of road signals for four wheels of the vehicle.

FIG. 10 is a block diagram of a teaching signal generation scheme.

FIG. 11 shows sample teaching signals.

FIG. 12 is a block diagram of a learning scheme for a seven-sensor system.

FIG. 13 is a block diagram of a learning scheme for a single-sensor scheme.

FIG. 14 shows learning results for the seven-sensor system.

FIG. 15 shows learning results for the single-sensor system.

FIG. 16 is a block diagram of a fuzzy control simulation.

FIG. 17 shows simulation results of the teaching signal on a first sample road.

FIG. 18 shows simulation results of the teaching signal on a second sample road.

FIG. 19 shows field tests results of the first teaching signal road.

FIG. 20 shows field test results of the second teaching signal road.

FIG. 21 is a block diagram of a simulation system configuration.

### DETAILED DESCRIPTION

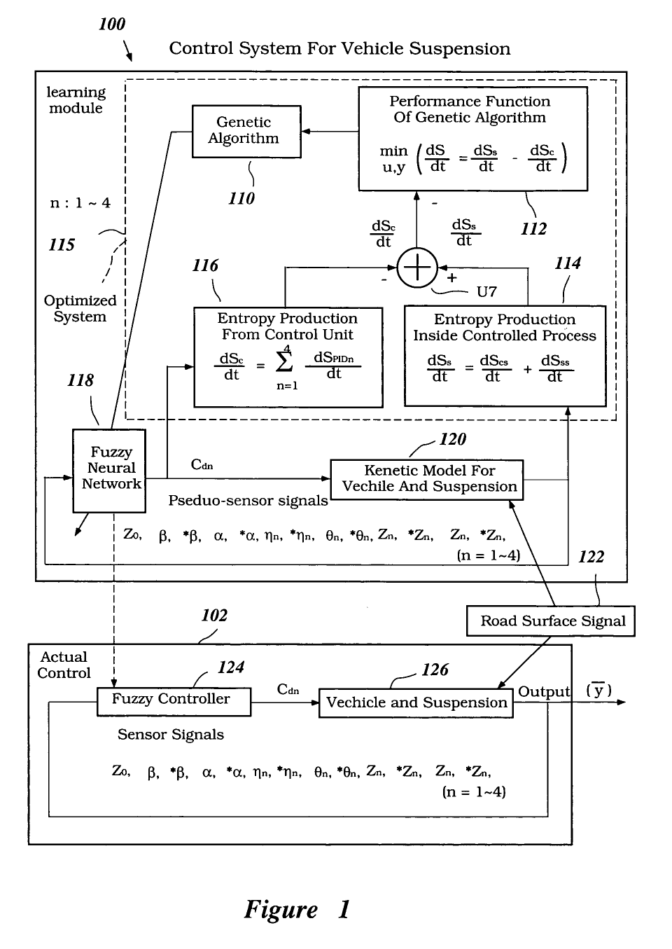

FIG. 1 is a block diagram illustrating one embodiment of an optimization control system 100 for controlling one or more shock absorbers in a vehicle suspension system.

This control system 100 is divided in an actual (online) control module 102 in the vehicle and a learning (offline) module 101. The learning module 101 includes a learning controller 118, such as, for example, a fuzzy neural network (FNN). The learning controller (hereinafter “the FNN 118”) can be any type of control system configured to receive a training input and adapt a control strategy using the training input. A control output from the FNN 118 is provided to a control input of a kinetic model 120 and to an input of a first entropy production calculator 116. A sensor output from the kinetic model is provided to a sensor input of the FNN 118 and to an input of a second entropy production calculator 114. An output from the first entropy production calculator 116 is provided to a negative input of an adder 119 and an output from the second entropy calculator 114 is provided to a positive input of the adder 119. An output from the adder 119 is provided to an input of a fitness (performance) function calculator 112. An output from the fitness function calculator 112 is provided to an input of a genetic analyzer 110. A training output from the genetic analyzer 110 is provided to a training input of the FNN 118.

The actual control module 102 includes a fuzzy controller 124. A control-rule output from the FNN 118 is provided to a control-rule input of a fuzzy controller 124. A sensor-data input of the fuzzy controller 124 receives sensor data from a suspension system 126. A control output from the fuzzy controller 124 is provided to a control input of the suspension system 126. A disturbance, such as a road-surface signal, is provided to a disturbance input of the kinetic model 120 and to the vehicle and suspension system 126.

The actual control module 102 is installed into a vehicle and controls the vehicle suspension system 126. The learning module 101 optimizes the actual control module 102 by using the kinetic model 120 of the vehicle and the suspension system 126. After the learning control module 101 is optimized by using a computer simulation, one or more parameters from the FNN 118 are provided to the actual control module 101.

In one embodiment, a damping coefficient control-type shock absorber is employed, wherein the fuzzy controller 124 outputs signals for controlling a throttle in an oil passage in one or more shock absorbers in the suspension system 126.

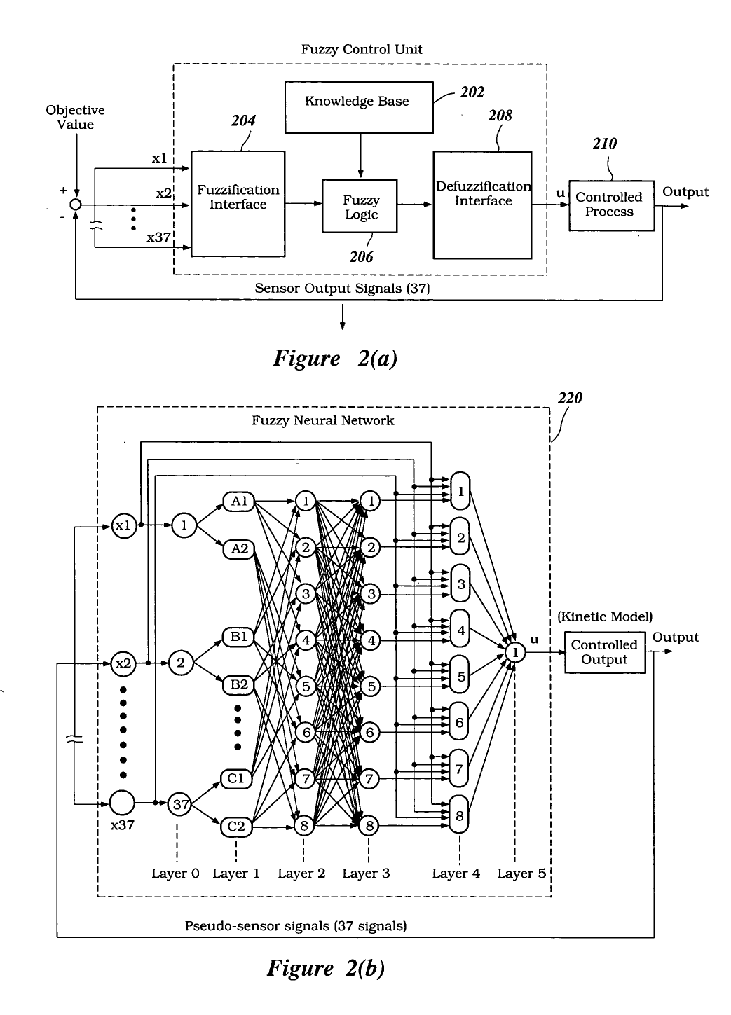

FIGS. 2A and 2B illustrate one embodiment of a fuzzy controller 200 suitable for use in the FNN 118 and/or the fuzzy controller 124. In the fuzzy controller 200, data from one or more sensors is provided to a fuzzification interface 204. An output from the fuzzification interface 204 is provided to an input of a fuzzy logic module 206. The fuzzy logic module 206 obtains control rules from a knowledge-base 202. An output from the fuzzy logic module 206 is provided to a de-fuzzification interface 208. A control output from the de-fuzzification interface 208 is provided to a controlled process 210 (e.g. the suspension system 126, the kinetic model 120, etc.).

The sensor data shown in FIGS. 1 and 2, can include, for example, vertical positions of the vehicle z₀, pitch angle β, roll angle α, suspension angle η for each wheel, arm angle θ for each wheel, suspension length z₆ for each wheel, and/or deflection z₁₂ for each wheel. The fuzzy control unit estimates the optimal throttle amount for each shock absorber and outputs signals according to the predetermined fuzzy rule based on the detection results.

The learning module 101 includes a kinetic model 120 of the vehicle and suspension to be used with the actual control module 101, a learning control module 118 having a fuzzy neural network corresponding to the actual control module 101 (as shown in FIG. 2B), and an optimizer module 115 for optimizing the learning control module 118.

The optimizer module 115 computes a difference between a time differential of entropy from the FNN 118 (dSc/dt) and a time differential of entropy inside the subject process (i.e., vehicle and suspensions) obtained from the kinetic model 120. The computed difference is used as a performance function by a genetic optimizer 110. The genetic optimizer 110 optimizes (trains) the FNN 118 by genetically evolving a teaching signal. The teaching signal is provided to a fuzzy neural network in the FNN 118. The genetic optimizer 110 optimizes the fuzzy neural network (FNN) such that an output of the FNN, when used as an input to the kinetic module 120, reduces the entropy difference between the time differentials of both entropy values.

The fuzzy rules from the FNN 118 are then provided to a fuzzy controller 124 in the actual control module 102. Thus, the fuzzy rule (or rules) used in the fuzzy controller 124 (in the actual control module 101), are determined based on an output from the FNN 118 (in the learning control unit), that is optimized by using the kinetic model 120 for the vehicle and suspension.

The genetic algorithm 110 evolves an output signal α based on a performance function ƒ. Plural candidates for α are produced and these candidates are paired according to which plural chromosomes (parents) are produced. The chromosomes are evaluated and sorted from best to worst by using the performance functions ƒ. After the evaluation for all parent chromosomes, good offspring chromosomes are selected from among the plural parent chromosomes, and some offspring chromosomes are randomly selected. The selected chromosomes are crossed so as to produce the parent chromosomes for the next generation. Mutation may also be provided. The second-generation parent chromosomes are also evaluated (sorted) and go through the same evolutionary process to produce the next-generation (i.e., third-generation) chromosomes. This evolutionary process is continued until it reaches a predetermined generation or the evaluation function ƒ finds a chromosome with a certain value. The outputs of the genetic algorithm are the chromosomes of the last generation. These chromosomes become input information α provided to the FNN 118.

In the FNN 118, a fuzzy rule to be used in the fuzzy controller 124 is selected from a set of rules. The selected rule is determined based on the input information α from the genetic algorithm 110. Using the selected rule, the fuzzy controller 124 generates a control signal C_{dn} for the vehicle and suspension system 126. The control signal adjusts the operation (damping factor) of one or more shock absorbers to produce a desired ride and handling quality for the vehicle.

The genetic algorithm 110 is a nonlinear optimizer that optimizes the performance function ƒ. As is the case with most optimizers, the success or failure of the optimization often ultimately depends on the selection of the performance function ƒ.

The fitness function 112 ƒ for the genetic algorithm 110 is given by

$$\begin{matrix}f = min \frac{ⅆ S}{ⅆ t} \\ where & ( 1 ) \\ \frac{ⅆ S}{ⅆ t} = ( \frac{ⅆ {S}_{c}}{ⅆ t} - \frac{ⅆ {S}_{u}}{ⅆ t} ) & ( 2 )\end{matrix}$$

The quantity dSᵤ/dt represents the rate of entropy production in the output x(t) of the kinetic model 120. The quantity dS_{c}/dt represents the rate of entropy production in the output C_{dn} of the FNN 118.

Entropy is a concept that originated in physics to characterize the heat, or disorder, of a system. It can also be used to provide a measure of the uncertainty of a collection of events, or, for a random variable, a distribution of probabilities. The entropy function provides a measure of the lack of information in the probability distribution. To illustrate, assume that p(x) represents a probabilistic description of the known state of a parameter, that p(x) is the probability that the parameter is equal to z. If p(x) is uniform, then the parameter p is equally likely to hold any value, and an observer will know little about the parameter p. In this case, the entropy function is at its maximum. However, if one of the elements of p(z) occurs with a probability of one, then an observer will know the parameter p exactly and have complete information about p. In this case, the entropy of p(x) is at its minimum possible value. Thus, by providing a measure of uniformity, the entropy function allows quantification of the information on a probability distribution.

It is possible to apply these entropy concepts to parameter recovery by maximizing the entropy measure of a distribution of probabilities while constraining the probabilities so that they satisfy a statistical model given measured moments or data. Though this optimization, the distribution that has the least possible information that is consistent with the data may be found. In a sense, one is translating all of the information in the data into the form of a probability distribution. Thus, the resultant probability distribution contains only the information in the data without imposing additional structure. In general, entropy techniques are used to formulate the parameters to be recovered in terms of probability distributions and to describe the data as constraints for the optimization. Using entropy formulations, it is possible to perform a wide range of estimations, address ill-posed problems, and combine information from varied sources without having to impose strong distributional assumptions.

Entropy-based optimization of the FNN is based on obtaining the difference between a time differentiation (dSᵤ/dt) of the entropy of the plant and a time differentiation (dS_{c}/dt) of the entropy provided to the kinetic model from the FNN 118 controller that controls the kinetic model 120, and then evolving a control rule using a genetic algorithm. The time derivative of the entropy is called the entropy production rate. The genetic algorithm 110 minimizes the difference between the entropy production rate of the kinetic model 120 (that is, the entropy production of the controlled process) (dSᵤ/dt) and the entropy production rate of the low-level controller (dS_{c}/dt) as a performance function. Nonlinear operation characteristics of the kinetic model (the kinetic model represents a physical plant) are calculated by using a Lyapunov function

The dynamic stability properties of the model 120 near an equilibrium point can be determined by use of Lyapunov functions as follows. Let V(x) be a continuously differentiable scalar function defined in a domain D⊂Rⁿ that contains the origin. The function V(x) is said to be positive definite if V(0)=0 and V(x)>0 for x≠0. The function V(x) is said to be positive semidefinite if V(x)≧0 for all x. A function V(x) is said to be negative definite or negative semidefinite if −V(x) is positive definite or positive semidefinite, respectively. The derivative of V along the trajectories \dot{x}=ƒ(x) is given by:

$$\dot{V} ( x ) = {\sum }_{i = 1}^{n} \frac{\partial V}{\partial {x}_{i}} {\dot{x}}_{i} = \frac{\partial V}{\partial x} f ( x ) \qquad ( 3 )$$

where ∂V/∂x is a row vector whose ith component is ∂V/∂xᵢ and the components of the n-dimensional vector ƒ(x) are locally Lipschitz functions of x, defined for all x in the domain D. The Lyapunov stability theorem states that the origin is stable if there is a continuously differentiable positive definite function V(x) so that \dot{V}(x) is negative definite. A function V(x) satisfying the conditions for stability is called a Lyapunov function.

The genetic algorithm realizes 110 the search of optimal controllers with a simple structure using the principle of minimum entropy production.

The fuzzy tuning rules are shaped by the learning system in the fuzzy neural network 118 with acceleration of fuzzy rules on the basis of global inputs provided by the genetic algorithm 110.

In general, the equation of motion for non-linear systems is expressed as follows by defining “q” as generalized coordinates, “f” and “g” random functions, “Fe” as control input.

q=ƒ(\dot{q},q)+g(q)−Fₑ (a)

In the above equation, when the dissipation term and control input in the second term are multiplied by a speed, the following equation can be obtained for the time differentials of the entropy.

$$\frac{ⅆ S}{ⅆ t} = f ( \dot{q} , q ) \dot{q} - Feq = \frac{ⅆ {S}_{u}}{ⅆ t} - \frac{ⅆ {S}_{c}}{ⅆ t} \qquad ( b )$$

dS/dt is a time differential of entropy for the entire system. dSᵤ/dt is a time differential of entropy for the plant, that is the controlled process. dS_{c}/dt is a time differential of entropy for the control system for the plant.

The following equation is selected as Lyapunov function for the equation (a).

V=(ΣEq²+S²)/2=(Σq²+(Sᵤ−S_{c})²)/2 (c)

The greater the integral of the Lyapunov function, the more stable the kinetic characteristic of the plant.

Thus, for the stabilization of the systems, the following equation is introduced as a relationship between the Lyapunov function and entropy production for the open dynamic system.

DV/dt=Σqq+(Sᵤ−S_{c}) (dSᵤ/dt−dS_{c}/dt)<0 (d)

Σqq<(Sᵤ−S_{c}) (dS_{c}/dt−dSᵤ/dt) (e)

A Duffing oscillator is one example of a dynamic system. In the Duffing oscillator, the equation of motion is expressed as:

\ddot{x}+\dot{x}+x+x³=0 (f)

the entropy production from this equation is calculated as:

dS/dt=x³ (g)

Further, Lyapunov function relative to the equation (f) becomes:

V=(½)x²+U(x), U(x)=(¼)x⁴−(½)x² (h)

If the equation (f) is modified by using the equation (h), it is expressed as:

$$\ddot{x} + x + \frac{\partial U ( x )}{\partial x} = 0 \qquad ( i )$$

If the left side of the equation (i) is multiplied by x as:

$$\ddot{x} + x + \frac{\partial U ( x )}{\partial x} x = 0$$

Then, if the Lyapunov function is differentiated by time, it becomes:

dV/dt=xx+(U(x)/x)x

If this is converted to a simple algebra, it becomes:

dV/dt=(1/T)(dS/dt) (j)

wherein “T” is a normalized factor.

dS/dt is used for evaluating the stability of the system. dSᵤ/dt is a time change of the entropy for the plant. −dS_{c}/dt is considered to be a time change of negative entropy given to the plant from the control system.

The present invention calculates waste such as disturbances for the entire control system of the plant based on a difference between the time differential dSᵤ/dt of the entropy of the plant that is a controlled process and time differential dSᵤ/dt of the entropy of the plant. Then, the evaluation is conducted by relating to the stability of the controlled process that is expressed by Lyapunov function. In other words, the smaller the difference of both entropy, the more stable the operation of the plants.

Suspension Control

In one embodiment, the control system 100 of FIGS. 1-2 is applied to a suspension control system, such as, for example, in an automobile, truck, tank, motorcycle, etc.

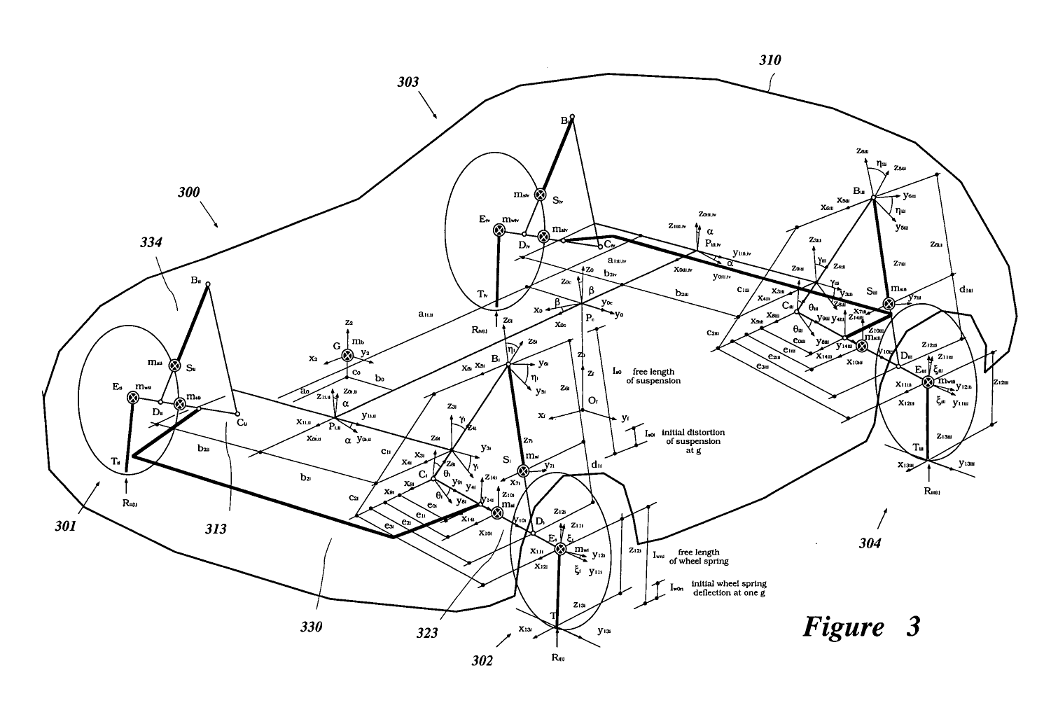

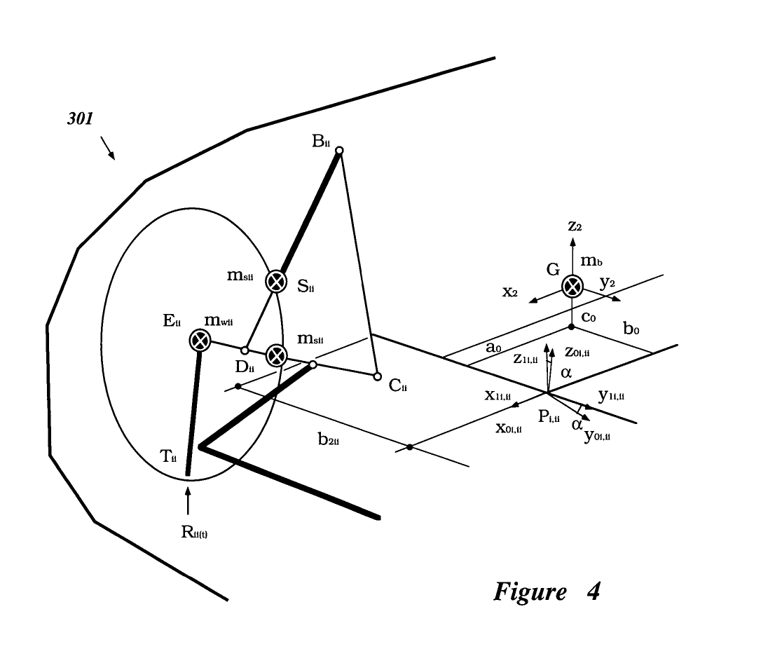

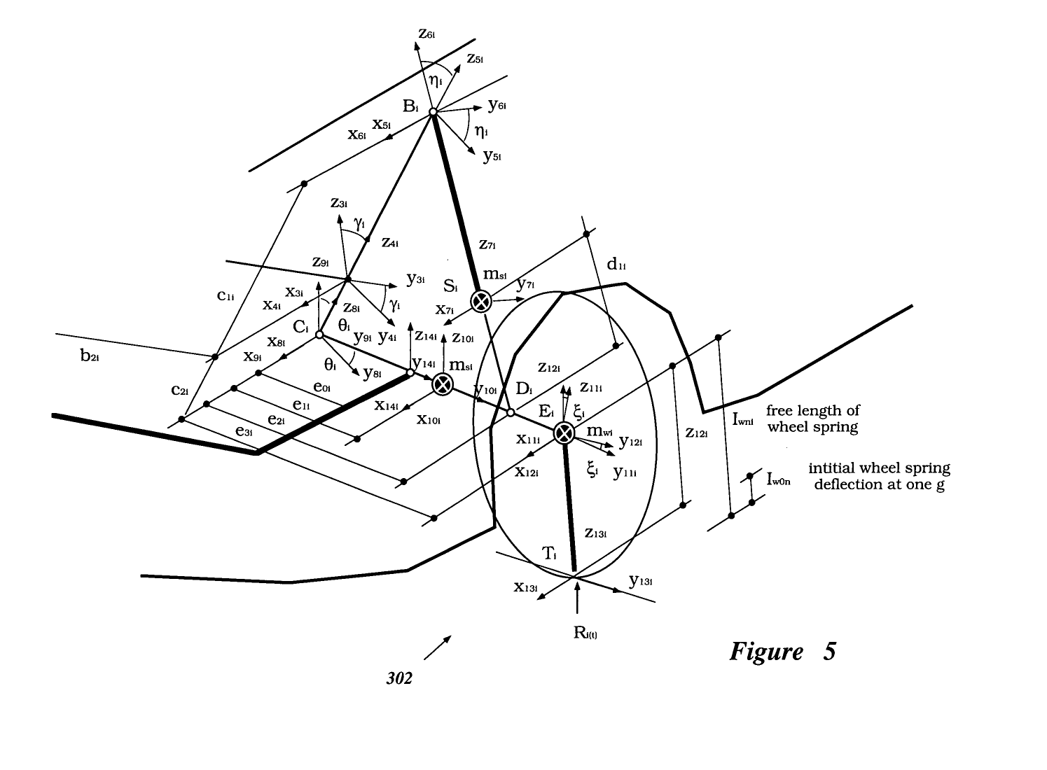

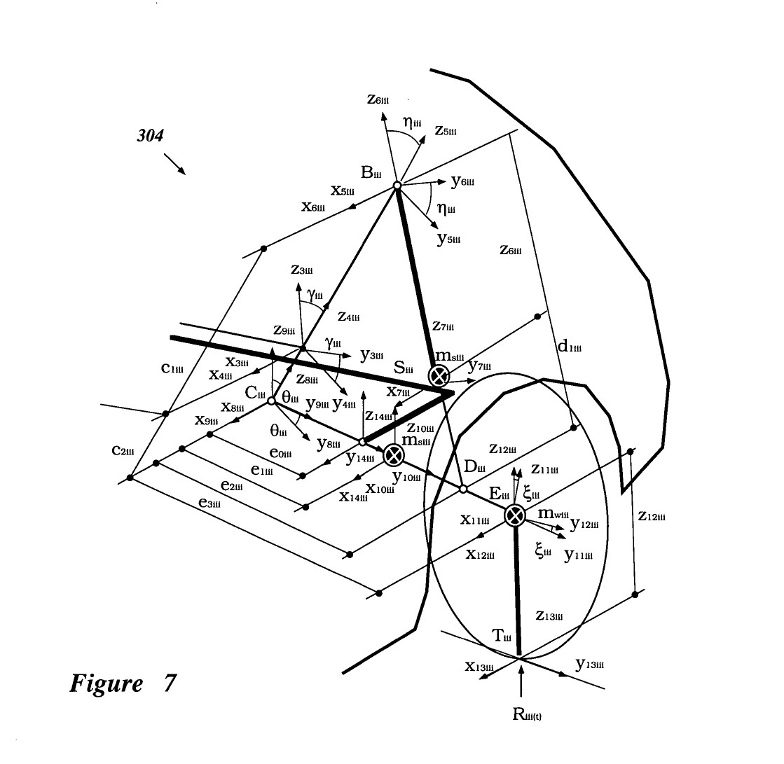

FIG. 3 is a schematic diagram of an automobile suspension system. In FIG. 3, a right front wheel 301 is connected to a right arm 313. A spring and damper linkage 334 controls the angle of the arm 313 with respect to a body 310. A left front wheel 302 is connected to a left arm 323 and a spring and damper 324 controls the angle of the arm 323. A front stabilizer 330 controls the angle of the left arm 313 with respect to the right arm 323. Detail views of the four wheels are shown in FIGS. 4-7. Similar linkages are shown for a right rear wheel 303 and a left rear wheel 304. The

In one embodiment of the suspension control system, the learning module 101 uses a kinetic model 120 for the vehicle and suspension. FIG. 3 illustrates each parameter of the kinetic models for the vehicle and suspensions. FIGS. 4-7 illustrate exploded views for each wheel as illustrated in FIG. 3.

A kinetic model 120 for the suspension system in the vehicle 300 shown in FIGS. 3-7 is developed as follows.

1. Description of Transformation Matrices

1.1 A Global Reference Coordinate xᵣ, yᵣ, zᵣ{r} is Assumed to be at the Geometric Center Pᵣ of the Vehicle Body 310.

The following are the transformation matrices to describe the local coordinates for:

{2} is a local coordinate in which an origin is the center of gravity of the vehicle body 310;

{7} is a local coordinate in which an origin is the center of gravity of the suspension;

{10n} is a local coordinate in which an origin is the center of gravity of the n'th arm;

{12n} is a local coordinate in which an origin is the center of gravity of the n'th wheel;

{13n} is a local coordinate in which an origin is a contact point of the n'th wheel relative to the road surface; and

{14} is a local coordinate in which an origin is a connection point of the stabilizer.

Note that in the development that follows, the wheels 302, 301, 304, and 303 are indexed using “i”, “ii”, “iii”, and “iv”, respectively.

1.2 Transformation Matrices.

As indicated, “n” is a coefficient indicating wheel positions such as i, ii, iii, and iv for left front, right front, left rear and right rear respectively. The local coordinate systems x₀, y₀, and z₀ {0} are expressed by using the following conversion matrix that moves the coordinate {r} along a vector (0,0,z₀)

$${}_{0}^{r} T = [ \begin{matrix}1 & 0 & 0 & 0 \\ 0 & 1 & 0 & 0 \\ 0 & 0 & 1 & {z}_{0} \\ 0 & 0 & 0 & 1\end{matrix} ]$$

Rotating the vector {r} along yᵣ with an angle β makes a local coordinate system x_{0c}, y_{0c}, z_{0c}{0r} with a transformation matrix _{0c}⁰T .

$${}_{0 c}^{0} T = [ \begin{matrix}cos β & 0 & sin β & 0 \\ 0 & 1 & 0 & 0 \\ - sin β & 0 & cos β & 0 \\ 0 & 0 & 0 & 1\end{matrix} ] \qquad ( 4 )$$

Transferring {0r} through the vector (a₁ₙ, 0, 0) makes a local coordinate system x_{0f}, y_{0f}, z_{0f}{0f} with a transformation matrix ^{0r}_{0f}T.

$${}_{0 n}^{0 c} T = [ \begin{matrix}1 & 0 & 0 & {a}_{1 n} \\ 0 & 1 & 0 & 0 \\ 0 & 0 & 1 & 0 \\ 0 & 0 & 0 & 1\end{matrix} ] \qquad ( 5 )$$

The above procedure is repeated to create other local coordinate systems with the following transformation matrices.

$$\begin{matrix}{}_{1 n}^{0 n} T = [ \begin{matrix}1 & 0 & 0 & 0 \\ 0 & cos α & - sin α & 0 \\ 0 & sin α & cos α & 0 \\ 0 & 0 & 0 & 1\end{matrix} ] & ( 6 ) \\ {}_{2}^{1 i} T = [ \begin{matrix}1 & 0 & 0 & {a}_{0} \\ 0 & 1 & 0 & {b}_{0} \\ 0 & 0 & 1 & {c}_{0} \\ 0 & 0 & 0 & 1\end{matrix} ] & ( 7 )\end{matrix}$$

1.3 Coordinates for the Wheels (Index n: i for the Left Front, ii for the Right Front, etc.) are Generated as Follows.

Transferring {1n} through the vector (0, b₂ₙ, 0) makes local coordinate system x₃ₙ, y₃ₙ, z₃ₙ {3n} with transformation matrix ^{1f}₃ₙT.

$$\begin{matrix}{}_{3 n}^{1 n} T = [ \begin{matrix}1 & 0 & 0 & 0 \\ 0 & 1 & 0 & {b}_{2 n} \\ 0 & 0 & 1 & 0 \\ 0 & 0 & 0 & 1\end{matrix} ] & ( 8 ) \\ {}_{4 n}^{3 n} T = [ \begin{matrix}1 & 0 & 0 & 0 \\ 0 & cos {γ}_{n} & - sin {γ}_{n} & 0 \\ 0 & sin {γ}_{n} & cos {γ}_{n} & 0 \\ 0 & 0 & 0 & 1\end{matrix} ] & ( 9 ) \\ {}_{5 n}^{4 n} T = [ \begin{matrix}1 & 0 & 0 & 0 \\ 0 & 1 & 0 & 0 \\ 0 & 0 & 1 & {c}_{1 n} \\ 0 & 0 & 0 & 1\end{matrix} ] & ( 10 ) \\ {}_{6 n}^{5 n} T = [ \begin{matrix}1 & 0 & 0 & 0 \\ 0 & cos {η}_{n} & - sin {η}_{n} & 0 \\ 0 & sin {η}_{n} & cos {η}_{n} & 0 \\ 0 & 0 & 0 & 1\end{matrix} ] & ( 11 ) \\ {}_{7 n}^{6 n} T = [ \begin{matrix}1 & 0 & 0 & 0 \\ 0 & 1 & 0 & 0 \\ 0 & 0 & 1 & {z}_{6 n} \\ 0 & 0 & 0 & 1\end{matrix} ] & ( 12 ) \\ {}_{8 n}^{4 n} T = [ \begin{matrix}1 & 0 & 0 & 0 \\ 0 & 1 & 0 & 0 \\ 0 & 0 & 1 & {c}_{2 n} \\ 0 & 0 & 0 & 1\end{matrix} ] & ( 13 ) \\ {}_{9 n}^{8 n} T = [ \begin{matrix}1 & 0 & 0 & 0 \\ 0 & cos {θ}_{n} & - sin {θ}_{n} & 0 \\ 0 & sin {θ}_{n} & cos {θ}_{n} & 0 \\ 0 & 0 & 0 & 1\end{matrix} ] & ( 14 ) \\ {}_{10 n}^{9 n} T = [ \begin{matrix}1 & 0 & 0 & 0 \\ 0 & 1 & 0 & {e}_{1 n} \\ 0 & 0 & 1 & 0 \\ 0 & 0 & 0 & 1\end{matrix} ] & ( 15 ) \\ {}_{11 n}^{9 n} T = [ \begin{matrix}1 & 0 & 0 & 0 \\ 0 & 1 & 0 & {e}_{3 n} \\ 0 & 0 & 1 & 0 \\ 0 & 0 & 0 & 1\end{matrix} ] & ( 16 ) \\ {}_{12 n}^{11 n} T = [ \begin{matrix}1 & 0 & 0 & 0 \\ 0 & cos {ζ}_{n} & - sin {ζ}_{n} & 0 \\ 0 & sin {ζ}_{n} & cos {ζ}_{n} & 0 \\ 0 & 0 & 0 & 1\end{matrix} ] & ( 17 ) \\ {}_{13 n}^{12 n} T = [ \begin{matrix}1 & 0 & 0 & 0 \\ 0 & 1 & 0 & 0 \\ 0 & 0 & 1 & {z}_{12 n} \\ 0 & 0 & 0 & 1\end{matrix} ] & ( 18 ) \\ {}_{14 n}^{9 n} T = [ \begin{matrix}1 & 0 & 0 & 0 \\ 0 & 1 & 0 & {e}_{0 n} \\ 0 & 0 & 1 & 0 \\ 0 & 0 & 0 & 1\end{matrix} ] & ( 19 )\end{matrix}$$

1.4 Some Matrices are Sub-Assembled to Make the Calculation Simpler.

$$( 20 )$$

$${}_{1 n}^{r} T = {}_{0}^{r} T {}_{0 n}^{0 c} T {}_{1 n}^{0 n} T = \\ [ \begin{matrix}1 & 0 & 0 & 0 \\ 0 & 1 & 0 & 0 \\ 0 & 0 & 1 & {z}_{0} \\ 0 & 0 & 0 & 1\end{matrix} ] [ \begin{matrix}cos β & 0 & sin β & 0 \\ 0 & 1 & 0 & 0 \\ - sin β & 0 & cos β & 0 \\ 0 & 0 & 0 & 1\end{matrix} ] [ \begin{matrix}1 & 0 & 0 & {a}_{1 n} \\ 0 & 1 & 0 & 0 \\ 0 & 0 & 1 & 0 \\ 0 & 0 & 0 & 1\end{matrix} ] [ \begin{matrix}1 & 0 & 0 & 0 \\ 0 & cos α & - sin α & 0 \\ 0 & sin α & cos α & 0 \\ 0 & 0 & 0 & 1\end{matrix} ] = \\ [ \begin{matrix}cos β & 0 & sin β & {a}_{1 n} cos β \\ 0 & 1 & 0 & 0 \\ - sin β & 0 & cos β & {z}_{0} - {a}_{1} sin β \\ 0 & 0 & 0 & 1\end{matrix} ] [ \begin{matrix}1 & 0 & 0 & 0 \\ 0 & cos α & - sin α & 0 \\ 0 & sin α & cos α & 0 \\ 0 & 0 & 0 & 1\end{matrix} ] = [ \begin{matrix}cos β & sin βsin α & sin βcos α & {a}_{1 n} cos β \\ 0 & cos α & - sin α & 0 \\ - sin β & cos βsin α & cos βcos α & {z}_{0} - {a}_{1} sin β \\ 0 & 0 & 0 & 1\end{matrix} ] \\ ( 21 ) \\ {}_{4 n}^{r} T = {}_{1 n}^{r} T {}_{3 n}^{1 n} T {}_{4 n}^{3 n} T = \\ [ \begin{matrix}cos β & sin βsin α & sin βcos α & {a}_{1 n} cos β \\ 0 & cos α & - sin α & 0 \\ - sin β & cos βsin α & cos βcos α & {z}_{0} - {a}_{1 n} sin β \\ 0 & 0 & 0 & 1\end{matrix} ] [ \begin{matrix}1 & 0 & 0 & 0 \\ 0 & 1 & 0 & {b}_{2 n} \\ 0 & 0 & 1 & 0 \\ 0 & 0 & 0 & 1\end{matrix} ] . \\ [ \begin{matrix}1 & 0 & 0 & 0 \\ 0 & cos {γ}_{n} & - sin {γ}_{n} & 0 \\ 0 & sin {γ}_{n} & cos {γ}_{n} & 0 \\ 0 & 0 & 0 & 1\end{matrix} ] = \\ [ \begin{matrix}cos β & sin βsin ( α + {γ}_{n} ) & sin βcos ( α + {γ}_{n} ) & {b}_{2 n} sin βsin α + {a}_{1 n} cos β \\ 0 & cos ( α + {γ}_{n} ) & - sin ( α + {γ}_{n} ) & {b}_{2 n} cos α \\ - sin β & cos βsin ( α + {γ}_{n} ) & cos βcos ( α + {γ}_{n} ) & {z}_{0} - {b}_{2 n} cos βsin α - {a}_{1 n} sin β \\ 0 & 0 & 0 & 1\end{matrix} ] \\ ( 22 ) \\ {}_{7 n}^{4 n} T = {}_{5 n}^{4 n} T {}_{6 n}^{5 n} T {}_{7 n}^{6 n} T = [ \begin{matrix}1 & 0 & 0 & 0 \\ 0 & 1 & 0 & 0 \\ 0 & 0 & 1 & {c}_{1 n} \\ 0 & 0 & 0 & 1\end{matrix} ] [ \begin{matrix}1 & 0 & 0 & 0 \\ 0 & cos {η}_{n} & - sin {η}_{n} & 0 \\ 0 & sin {η}_{n} & cos {η}_{n} & 0 \\ 0 & 0 & 0 & 1\end{matrix} ] [ \begin{matrix}1 & 0 & 0 & 0 \\ 0 & 1 & 0 & 0 \\ 0 & 0 & 1 & {z}_{6 n} \\ 0 & 0 & 0 & 1\end{matrix} ] = \\ [ \begin{matrix}1 & 0 & 0 & 0 \\ 0 & cos {η}_{n} & - sin {η}_{n} & 0 \\ 0 & sin {η}_{n} & cos {η}_{n} & {c}_{1 n} \\ 0 & 0 & 0 & 1\end{matrix} ] [ \begin{matrix}1 & 0 & 0 & 0 \\ 0 & 1 & 0 & 0 \\ 0 & 0 & 1 & {z}_{6 n} \\ 0 & 0 & 0 & 1\end{matrix} ] = [ \begin{matrix}1 & 0 & 0 & 0 \\ 0 & cos {θ}_{n} & - sin {θ}_{n} & {e}_{1 n} cos {θ}_{n} \\ 0 & sin {θ}_{n} & cos {θ}_{n} & {c}_{2 n} + {e}_{1 n} sin {θ}_{n} \\ 0 & 0 & 0 & 1\end{matrix} ] \\ ( 23 ) \\ {}_{12 n}^{4 n} T = {}_{8 n}^{4 n} T {}_{9 n}^{8 n} T {}_{11 n}^{9 n}{T}{}_{12 n}^{11 n} T = [ \begin{matrix}1 & 0 & 0 & 0 \\ 0 & 1 & 0 & 0 \\ 0 & 0 & 1 & {c}_{2 n} \\ 0 & 0 & 0 & 1\end{matrix} ] [ \begin{matrix}1 & 0 & 0 & 0 \\ 0 & cos {θ}_{n} & - sin {θ}_{n} & 0 \\ 0 & sin {θ}_{n} & cos {θ}_{n} & 0 \\ 0 & 0 & 0 & 1\end{matrix} ] [ \begin{matrix}1 & 0 & 0 & 0 \\ 0 & 1 & 0 & {e}_{3 n} \\ 0 & 0 & 1 & 0 \\ 0 & 0 & 0 & 1\end{matrix} ] = \\ [ \begin{matrix}1 & 0 & 0 & 0 \\ 0 & cos {θ}_{n} & - sin {θ}_{n} & 0 \\ 0 & sin {θ}_{n} & cos {θ}_{n} & {c}_{2 n} \\ 0 & 0 & 0 & 1\end{matrix} ] [ \begin{matrix}1 & 0 & 0 & 0 \\ 0 & 1 & 0 & {e}_{1 n} \\ 0 & 0 & 1 & 0 \\ 0 & 0 & 0 & 1\end{matrix} ] = [ \begin{matrix}1 & 0 & 0 & 0 \\ 0 & cos {θ}_{n} & - sin {θ}_{n} & {e}_{1 n} cos {θ}_{n} \\ 0 & sin {θ}_{n} & cos {θ}_{n} & {c}_{2 n} + {e}_{1 n} sin {θ}_{n} \\ 0 & 0 & 0 & 1\end{matrix} ] \\ ( 24 ) \\ {}_{12 n}^{4 n} T = {}_{8 n}^{4 n} T {}_{9 n}^{8 n} T {}_{11 n}^{9 n}{T}{}_{12 n}^{11 n} T = [ \begin{matrix}1 & 0 & 0 & 0 \\ 0 & 1 & 0 & 0 \\ 0 & 0 & 1 & {c}_{2 n} \\ 0 & 0 & 0 & 1\end{matrix} ] [ \begin{matrix}1 & 0 & 0 & 0 \\ 0 & cos {θ}_{n} & - sin {θ}_{n} & 0 \\ 0 & sin {θ}_{n} & cos {θ}_{n} & 0 \\ 0 & 0 & 0 & 1\end{matrix} ] [ \begin{matrix}1 & 0 & 0 & 0 \\ 0 & 1 & 0 & {e}_{3 n} \\ 0 & 0 & 1 & 0 \\ 0 & 0 & 0 & 1\end{matrix} ] \\ [ \begin{matrix}1 & 0 & 0 & 0 \\ 0 & cos {ζ}_{n} & - sin {ζ}_{n} & 0 \\ 0 & sin {ζ}_{n} & cos {ζ}_{n} & 0 \\ 0 & 0 & 0 & 1\end{matrix} ] = [ \begin{matrix}1 & 0 & 0 & 0 \\ 0 & cos {θ}_{n} & - sin {θ}_{n} & 0 \\ 0 & sin {θ}_{n} & cos {θ}_{n} & {c}_{2 n} \\ 0 & 0 & 0 & 1\end{matrix} ] [ \begin{matrix}1 & 0 & 0 & 0 \\ 0 & 1 & 0 & {e}_{3 n} \\ 0 & 0 & 1 & 0 \\ 0 & 0 & 0 & 1\end{matrix} ] \\ [ \begin{matrix}1 & 0 & 0 & 0 \\ 0 & cos {ζ}_{n} & - sin {ζ}_{n} & 0 \\ 0 & sin {ζ}_{n} & cos {ζ}_{n} & 0 \\ 0 & 0 & 0 & 1\end{matrix} ] = [ \begin{matrix}1 & 0 & 0 & 0 \\ 0 & cos {θ}_{n} & - sin {θ}_{n} & {e}_{3 n} cos {θ}_{n} \\ 0 & sin {θ}_{n} & cos {θ}_{n} & {c}_{2 n} + {e}_{3 n} sin {θ}_{n} \\ 0 & 0 & 0 & 1\end{matrix} ] \\ [ \begin{matrix}1 & 0 & 0 & 0 \\ 0 & cos {ζ}_{n} & - sin {ζ}_{n} & 0 \\ 0 & sin {ζ}_{n} & cos {ζ}_{n} & 0 \\ 0 & 0 & 0 & 1\end{matrix} ] = [ \begin{matrix}1 & 0 & 0 & 0 \\ 0 & cos ( {θ}_{n} + {ζ}_{n} ) & - sin ( {θ}_{n} + {ζ}_{n} ) & {e}_{3 n} cos {θ}_{n} \\ 0 & sin ( {θ}_{n} + {ζ}_{n} ) & cos ( {θ}_{n} + {ζ}_{n} ) & {c}_{2 n} + {e}_{3 n} sin {θ}_{n} \\ 0 & 0 & 0 & 1\end{matrix} ]$$

2. Description of all the Parts of the Model Both in Local Coordinate Systems and Relations to the Coordinate {r} or {1n} Referenced to the Vehicle Body 310.

2.1 Description in Local Coordinate Systems.

$${P}_{body}^{2} = {P}_{susp . n}^{7 n} = {P}_{arm . n}^{10 n} = {P}_{wheel . n}^{12 n} = {P}_{touchpoint . n}^{13 n} = {P}_{stab . n}^{14 n} = [ \begin{matrix}0 \\ 0 \\ 0 \\ 1\end{matrix} ] \qquad ( 25 )$$

2.2 Description in Global Reference Coordinate System {r}.

$$\begin{matrix}{P}_{body}^{r} = {}_{1 i}^{r}{T}{}_{2}^{1 i} {TP}_{body}^{2} ( 26 ) \\ = [ \begin{matrix}cos β & sin βsinα & sin βcosα & {a}_{1 i} cos β \\ 0 & cos α & - sin α & 0 \\ - sin β & cos β sin α & cos β cos α & {z}_{0} - {a}_{1 i} sin β \\ 0 & 0 & 0 & 1\end{matrix} ] [ \begin{matrix}1 & 0 & 0 & {a}_{0} \\ 0 & 1 & 0 & {b}_{0} \\ 0 & 0 & 1 & {c}_{0} \\ 0 & 0 & 0 & 1\end{matrix} ] [ \begin{matrix}0 \\ 0 \\ 0 \\ 1\end{matrix} ] \\ = [ \begin{matrix}{a}_{0} cos β + {b}_{0} sin βsin α + {c}_{0} sin βcos α + {a}_{1 i} cos β \\ {b}_{0} cos α - {c}_{0} sin α \\ - {a}_{0} sin β + {b}_{0} cos βsin α + {c}_{0} cos βcos α - {a}_{1 i} sin β \\ 1\end{matrix} ] \\ {P}_{suspn}^{r} = {}_{4 n}^{r}{T}{}_{7 n}^{4 n} {TP}_{suspn}^{7 n} ( 27 ) \\ = [ \begin{matrix}cos β & sin βsin ( α + {γ}_{n} ) & sin βcos ( α + {γ}_{n} ) & {b}_{2 n} sin βsinα + {a}_{1 n} cos β \\ 0 & cos ( α + {γ}_{n} ) & - sin ( α + {γ}_{n} ) & {b}_{2 n} cos α \\ - sin β & cos β sin ( α + {γ}_{n} ) & cos β cos ( α + {γ}_{n} ) & {z}_{0} + {b}_{2 n} cos βsin α - {a}_{1 n} sin β \\ 0 & 0 & 0 & 1\end{matrix} ] . \\ [ \begin{matrix}1 & 0 & 0 & 0 \\ 0 & cos {η}_{n} & - sin η & - {z}_{6 n} sin {η}_{n} \\ 0 & sin {η}_{n} & cos {η}_{n} & {c}_{1 n} + {z}_{6 n} cos {η}_{n} \\ 0 & 0 & 0 & 1\end{matrix} ] [ \begin{matrix}0 \\ 0 \\ 0 \\ 1\end{matrix} ] \\ = [ \begin{matrix}\{ {z}_{6 n} cos ( α + {γ}_{n} + {η}_{n} ) + {c}_{1 n} cos ( α + {γ}_{n} ) + {b}_{2 n} sin α \} sin β + {a}_{1 n} cos β \\ - {z}_{6 n} sin ( α + {γ}_{n} + {η}_{n} ) - {c}_{1 n} sin ( α + {γ}_{n} ) + {b}_{2 n} cos α \\ \{ {z}_{6 n} cos ( α + {γ}_{n} + {η}_{n} ) + {c}_{1 n} cos ( α + {γ}_{n} ) + {b}_{2 n} sin α \} cos β - {a}_{1 n} sin β \\ 1\end{matrix} ] \\ {P}_{arm . n}^{r} = {}_{4 n}^{r}{T}{}_{10 n}^{4 n} {TP}_{arm . n}^{10 n} ( 28 ) \\ = [ \begin{matrix}cos β & sin βsin ( α + {γ}_{n} ) & sin βcos ( α + {γ}_{n} ) & {b}_{2 n} sin βsinα + {a}_{1 n} cos β \\ 0 & cos ( α + {γ}_{n} ) & - sin ( α + {γ}_{n} ) & {b}_{2 n} cos α \\ - sin β & cos β sin ( α + {γ}_{n} ) & cos β cos ( α + {γ}_{n} ) & {z}_{0} + {b}_{2 n} cos βsin α - {a}_{1 n} sin β \\ 0 & 0 & 0 & 1\end{matrix} ] . \\ [ \begin{matrix}1 & 0 & 0 & 0 \\ 0 & cos {θ}_{n} & - sin {θ}_{n} & {e}_{3 n} cos {θ}_{n} \\ 0 & sin {θ}_{n} & cos {θ}_{n} & {c}_{2 n} + {e}_{1 n} sin {θ}_{n} \\ 0 & 0 & 0 & 1\end{matrix} ] [ \begin{matrix}0 \\ 0 \\ 0 \\ 1\end{matrix} ] \\ = [ \begin{matrix}\{ {e}_{1 n} sin ( α + {γ}_{n} + {θ}_{n} ) + {c}_{2 n} cos ( α + {γ}_{n} ) + {b}_{2 n} sin α \} sin β + {a}_{1 n} cos β \\ {e}_{1 n} cos ( α + {γ}_{n} + {θ}_{n} ) - {c}_{2 n} sin ( α + {γ}_{n} ) + {b}_{2 n} cos α \\ \{ {e}_{1 n} sin ( α + {γ}_{n} + {θ}_{n} ) + {c}_{2 n} cos ( α + {γ}_{n} ) + {b}_{2 n} sin α \} cos β - {a}_{1 n} sin β \\ 1\end{matrix} ] \\ {P}_{wheel . n}^{r} = {}_{4 n}^{r}{T}{}_{12 n}^{4 n} {TP}_{wheel . n}^{12 n} ( 29 ) \\ = [ \begin{matrix}cos β & sin βsin ( α + {γ}_{n} ) & sin βcos ( α + {γ}_{n} ) & {b}_{2 n} sin βsinα + {a}_{1 n} cos β \\ 0 & cos ( α + {γ}_{n} ) & - sin ( α + {γ}_{n} ) & {b}_{2 n} cos α \\ - sin β & cos β sin ( α + {γ}_{n} ) & cos β cos ( α + {γ}_{n} ) & {b}_{2 n} cos βsin α - {a}_{1 n} sin β \\ 0 & 0 & 0 & 1\end{matrix} ] . \\ [ \begin{matrix}1 & 0 & 0 & 0 \\ 0 & cos ( {θ}_{n} + {ζ}_{n} ) & - sin ( {θ}_{n} + {ζ}_{n} ) & {e}_{3 n} cos {θ}_{n} \\ 0 & sin ( {θ}_{n} + {ζ}_{n} ) & cos ( {θ}_{n} + {ζ}_{n} ) & {c}_{2 n} + {e}_{3 n} sin {θ}_{n} \\ 0 & 0 & 0 & 1\end{matrix} ] [ \begin{matrix}0 \\ 0 \\ 0 \\ 1\end{matrix} ] \\ = [ \begin{matrix}\{ {e}_{3 n} sin ( α + {γ}_{n} + {θ}_{n} ) + {c}_{2 n} cos ( α + {γ}_{n} ) + {b}_{2 n} sin α \} sin β + {a}_{1 n} cos β \\ {e}_{3 n} cos ( α + {γ}_{n} + {θ}_{n} ) - {c}_{2 n} sin ( α + {γ}_{n} ) + {b}_{2 n} cos α \\ {z}_{0} + \{ {e}_{3 n} sin ( α + {γ}_{n} + {θ}_{n} ) + {c}_{2 n} cos ( α + {γ}_{n} ) + {b}_{2 n} sin α \} cos β - {a}_{1 n} sin β \\ 1\end{matrix} ] \\ {P}_{touchpoint . n}^{r} = {}_{4 n}^{r}{T}{}_{12 n}^{4 n} {T}_{13 n}^{12 n} {TP}_{touchpoint . n}^{13 n } ( 30 ) \\ = [ \begin{matrix}cos β & sin βsin ( α + {γ}_{n} ) & sin βcos ( α + {γ}_{n} ) & {b}_{2 n} sin βsinα + {a}_{1 n} cos β \\ 0 & cos ( α + {γ}_{n} ) & - sin ( α + {γ}_{n} ) & {b}_{2 n} cos α \\ - sin β & cos β sin ( α + {γ}_{n} ) & cos β cos ( α + {γ}_{n} ) & {z}_{0} + {b}_{2 n} cos βsin α - {a}_{1 n} sin β \\ 0 & 0 & 0 & 1\end{matrix} ] . \\ [ \begin{matrix}1 & 0 & 0 & 0 \\ 0 & cos ( {θ}_{n} + {ζ}_{n} ) & - sin ( {θ}_{n} + {ζ}_{n} ) & {e}_{3 n} cos {θ}_{n} \\ 0 & sin ( {θ}_{n} + {ζ}_{n} ) & cos ( {θ}_{n} + {ζ}_{n} ) & {c}_{2 n} + {e}_{3 n} sin {θ}_{n} \\ 0 & 0 & 0 & 1\end{matrix} ] [ \begin{matrix}1 & 0 & 0 & 0 \\ 0 & 1 & 0 & 0 \\ 0 & 0 & 1 & {z}_{12 n} \\ 0 & 0 & 0 & 1\end{matrix} ] [ \begin{matrix}0 \\ 0 \\ 0 \\ 1\end{matrix} ] \\ = [ \begin{matrix}\{ {z}_{6 n} cos α + {e}_{3 n} sin ( α + {γ}_{n} + {θ}_{n} ) + {c}_{2 n} cos ( α + {γ}_{n} ) + {b}_{2 n} sin α \} sin β + {a}_{1 n} cos β \\ - {z}_{12 n} sin α + {e}_{3 n} cos ( α + {γ}_{n} + {θ}_{n} ) - {c}_{2 n} sin ( α + {γ}_{n} ) + {b}_{2 n} cos α \\ {z}_{0} + \{ {z}_{12 n} cos α + {e}_{3 n} sin ( α + {γ}_{n} + {θ}_{n} ) + {c}_{2 n} cos ( α + {γ}_{n} ) + {b}_{2 n} sin α \} cos β - {a}_{1 n} sin β \\ 1\end{matrix} ]\end{matrix}$$

where ζₙ is substituted by,

ζₙ=−γₙ−θₙ

because of the link mechanism to support a wheel at this geometric relation.

2.3 Description of the Stabilizer Linkage Point in the Local Coordinate System {1n}.

The stabilizer works as a spring in which force is proportional to the difference of displacement between both arms in a local coordinate system {1n} fixed to the body 310.

$$\begin{matrix}{P}_{stab . n}^{1 n} = {}_{3 n}^{1 n}{T}{}_{4 n}^{3 n} {T}_{8 n}^{4 n} {T}_{9 n}^{8 n} {T}_{14 n}^{9 n} {TP}_{stab . n}^{14 n} \\ = [ \begin{matrix}1 & 0 & 0 & 0 \\ 0 & 1 & 0 & {b}_{2 n} \\ 0 & 0 & 1 & 0 \\ 0 & 0 & 0 & 1\end{matrix} ] [ \begin{matrix}1 & 0 & 0 & 0 \\ 0 & cos {γ}_{n} & - sin {γ}_{n} & 0 \\ 0 & sin {γ}_{n} & cos {γ}_{n} & 0 \\ 0 & 0 & 0 & 1\end{matrix} ] [ \begin{matrix}1 & 0 & 0 & 0 \\ 0 & 1 & 0 & 0 \\ 0 & 0 & 1 & {c}_{2 n} \\ 0 & 0 & 0 & 1\end{matrix} ] \\ [ \begin{matrix}1 & 0 & 0 & 0 \\ 0 & cos {θ}_{n} & - sin {θ}_{n} & 0 \\ 0 & sin {θ}_{n} & cos {θ}_{n} & 0 \\ 0 & 0 & 0 & 1\end{matrix} ] [ \begin{matrix}1 & 0 & 0 & 0 \\ 0 & 1 & 0 & {e}_{0 n} \\ 0 & 0 & 1 & 0 \\ 0 & 0 & 0 & 1\end{matrix} ] [ \begin{matrix}0 \\ 0 \\ 0 \\ 1\end{matrix} ] \\ = [ \begin{matrix}0 \\ {e}_{0 n} cos ( {γ}_{n} + {θ}_{n} ) - {c}_{2 n} sin {γ}_{n} + {b}_{2 n} \\ {e}_{0 n} sin ( {γ}_{n} + {θ}_{n} ) + {c}_{2 n} cos {γ}_{n} \\ 0\end{matrix} ]\end{matrix} \qquad ( 31 )$$

3. Kinetic Energy, Potential Energy and Dissipative Functions for the <Body>, <Suspension>, <Arm>, <Wheel> and <Stabilizer>.

Kinetic energy and potential energy except by springs are calculated based on the displacement referred to the inertial global coordinate {r}. Potential energy by springs and dissipative functions are calculated based on the movement in each local coordinate.

$$\text{<} Body \text{>}$$

$$( 32 )$$

$${T}_{b}^{tr} = \frac{1}{2} {m}_{b} ( {\dot{x}}_{b}^{2} + {\dot{y}}_{b}^{2} + {\dot{z}}_{b}^{2} )$$

$$where$$

$$( 33 )$$

$${x}_{b} = ( {a}_{0} + {a}_{1 n} ) cos β + ( {b}_{0} sin α + {c}_{0} cos α ) sin β \\ {y}_{b} = {b}_{0} cos α - {c}_{0} sin α \\ {z}_{b} = {z}_{0} - ( {a}_{0} + {a}_{1 n} ) sin β + ( {b}_{0} sin α + {c}_{0} cos α ) cos β$$

$$and$$

$$( 34 )$$

$${q}_{j , k} = β , α , {z}_{0} \\ \frac{\partial {x}_{b}}{\partial α} = - ( {a}_{0} + {a}_{1 n} ) sin β + ( {b}_{0} sin α + {c}_{0} cos α ) cos β \\ \frac{\partial {x}_{b}}{\partial α} = ( {b}_{0} cos α - {c}_{0} sin α ) sin β \\ \frac{\partial {y}_{b}}{\partial β} = \frac{\partial {x}_{b}}{\partial {z}_{0}} = \frac{\partial {y}_{b}}{\partial {z}_{0}} = 0 \\ \frac{\partial {y}_{b}}{\partial α} = - {b}_{0} sin α - {c}_{0} cos α \\ \frac{\partial {z}_{b}}{\partial β} = - ( {a}_{0} + {a}_{1 n} ) cos β - ( {b}_{0} sin α + {c}_{0} cos α ) sin β \\ \frac{\partial {z}_{b}}{\partial α} = ( {b}_{0} cos α - {c}_{0} sin α ) cos β \\ \frac{\partial {z}_{b}}{\partial {z}_{0}} = 1$$

$$and thus$$

$$( 35 )$$

$${T}_{b}^{tr} = \frac{1}{2} {m}_{b} ( {\dot{x}}_{b}^{2} + {\dot{y}}_{b}^{2} + {\dot{z}}_{b}^{2} ) \\ = \frac{1}{2} {m}_{b} {\sum }_{j , k}^{} ( \frac{\partial {x}_{b}}{\partial {q}_{j}} \frac{\partial {x}_{b}}{\partial {q}_{k}} {\dot{q}}_{j} {\dot{q}}_{k} + \frac{\partial {y}_{b}}{\partial {q}_{j}} \frac{\partial {y}_{b}}{\partial {q}_{k}} {\dot{q}}_{j} {\dot{q}}_{k} + \frac{\partial {z}_{b}}{\partial {q}_{j}} \frac{\partial {z}_{b}}{\partial {q}_{k}} {\dot{q}}_{j} {\dot{q}}_{k} ) \\ = \frac{1}{2} {m}_{b} ⟨ {\dot{β}}^{2} {\{ - ( {a}_{0} + {a}_{1} ) sin β + ( {b}_{0} sin α + {c}_{0} cos α ) cos β \}}^{2} + \\ {\dot{α}}^{2} {\{ ( {b}_{0} cos α - {c}_{0} sin α ) sin β \}}^{2} + \\ {{\dot{α}}^{2} ( - {b}_{0} sin α - {c}_{0} cos α )}^{2} + \\ {\dot{β}}^{2} {\{ - ( {a}_{0} + {a}_{1} ) cos β - ( {b}_{0} sin α + {c}_{0} cos α ) sin β \}}^{2} + {\dot{α}}^{2} {\{ ( {b}_{0} cos α - {c}_{0} sin α ) cos β \}}^{2} + {\dot{z}}_{0}^{2} + \\ 2 \dot{α} \dot{β} [ \{ - ( {a}_{0} + {a}_{1} ) sin β + ( {b}_{0} sin α + {c}_{0} cos α ) cos β \} ( {b}_{0} cos α - {c}_{0} sin α ) sin β + \\ \{ - ( {a}_{0} + {a}_{1} ) cos β - ( {b}_{0} sin α + {c}_{0} cos α ) sin β \} ( {b}_{0} cos α - {c}_{0} sin α ) cos β ] - \\ 2 \dot{β} {\dot{z}}_{o} \{ ( {a}_{0} + {a}_{1 n} ) cos β + ( {b}_{0} sin α - {c}_{0} cos α ) sin β \} + \\ 2 \dot{α} {\dot{z}}_{0} ( {b}_{0} cos α - {c}_{0} sin α ) cos β ⟩ \\ = \frac{1}{2} {m}_{b} ⟨ {\dot{α}}^{2} ( {b}_{0}^{2} + {c}_{0}^{2} ) + {\dot{β}}^{2} \{ {( {a}_{0} + {a}_{1 i} )}^{2} + {( {b}_{0} sin α + {c}_{0} cos α )}^{2} \} + {\dot{z}}_{0}^{2} - \\ 2 \dot{α} \dot{β} ( {a}_{0} + {a}_{1 i} ) ( {b}_{0} cos α - {c}_{0} sin α ) - \\ 2 \dot{β} {\dot{z}}_{o} \{ ( {a}_{0} + {a}_{1 i} ) cos β + ( {b}_{0} sin α - {c}_{0} cos α ) sin β + \\ 2 \dot{α} {\dot{z}}_{0} ( {b}_{0} cos α - {c}_{0} sin α ) cos β ⟩ \\ ( 36 ) \\ {T}_{b}^{ro} = \frac{1}{2} ( {I}_{bx} {ω}_{bx}^{2} + {I}_{by} {ω}_{by}^{2} + {I}_{bz} {ω}_{bz}^{2} ) \\ where \\ {ω}_{bx} = \dot{α} \\ {ω}_{by} = \dot{β} \\ {ω}_{bz} = 0 \\ ∴ \\ {T}_{b}^{ro} = \frac{1}{2} ( {I}_{bx} {\dot{α}}^{2} + {I}_{by} {\dot{β}}^{2} ) \\ {U}_{b} = {m}_{b} {gz}_{b} = {m}_{b} g \{ - ( {a}_{0} + {a}_{1 n} ) sin β + ( {b}_{0} sin α + {c}_{0} cos α ) cos β \} \\ \text{<} Suspension \text{>} \\ ( 37 ) \\ {T}_{sn}^{tr} = \frac{1}{2} {m}_{sn} ( {\dot{x}}_{sn}^{2} + {\dot{y}}_{sn}^{2} + {\dot{z}}_{sn}^{2} ) \\ where \\ {x}_{sn} = \{ {z}_{6 n} cos ( α + {γ}_{n} + {η}_{n} ) + {c}_{1 n} cos ( α + {γ}_{n} ) + {b}_{2 n} sin α \} sin β + {a}_{1 n} cos β \\ {y}_{sn} = - {z}_{6 n} sin ( α + {γ}_{n} + {η}_{n} ) - {c}_{1 n} sin ( α + {γ}_{n} ) + {b}_{2 n} cos α \\ {z}_{sn} = {z}_{0} + \{ {z}_{6 n} cos ( α + {γ}_{n} + {η}_{n} ) + {c}_{1 n} cos ( α + {γ}_{n} ) + {b}_{2 n} sin α \} cos β - {a}_{1 n} sin β \\ ( 38 ) \\ {q}_{j , k} = {z}_{6 n} , {η}_{n} , α , β , {z}_{0} \\ \frac{\partial {x}_{sn}}{\partial {z}_{6 n}} = cos ( α + {γ}_{n} + {η}_{n} ) sin β \\ \frac{\partial {x}_{sn}}{\partial {η}_{n}} = - {z}_{6 n} sin ( α + {γ}_{n} + {η}_{n} ) sin β \\ \frac{\partial {x}_{sn}}{\partial α} = \{ - {z}_{6 n} sin ( α + {γ}_{n} + {η}_{n} ) - {c}_{1 n} sin ( α + {γ}_{n} ) + {b}_{2 n} cos α \} sin β \\ \frac{\partial {x}_{sn}}{\partial β} = \{ {z}_{6 n} cos ( α + {γ}_{n} + {η}_{n} ) + {c}_{1 n} cos ( α + {γ}_{n} ) + {b}_{2 n} sin α \} cos β - {a}_{1 n} sin β \\ \frac{\partial {y}_{sn}}{\partial {z}_{6 n}} = - sin ( α + {γ}_{n} + {η}_{n} ) \\ \frac{\partial {y}_{sn}}{\partial {η}_{n}} = - {z}_{6 n} cos ( α + {γ}_{n} + {η}_{n} ) \\ \frac{\partial {y}_{sn}}{\partial α} = - {z}_{6 n} cos ( α + {γ}_{n} + {η}_{n} ) - {c}_{1 n} cos ( α + {γ}_{n} ) - {b}_{2 n} sin α \\ \frac{\partial {y}_{sn}}{\partial β} = \frac{\partial {x}_{sn}}{\partial {z}_{0}} = \frac{\partial {y}_{sn}}{\partial {z}_{0}} = 0 \\ \frac{\partial {z}_{sn}}{\partial {z}_{0}} = 1 \\ ( 39 ) \\ \frac{\partial {z}_{sn}}{\partial {z}_{6 n}} = cos ( α + {γ}_{n} + {η}_{n} ) cos β \\ \frac{\partial {z}_{sn}}{\partial {η}_{n}} = - {z}_{6 n} sin ( α + {γ}_{n} + {η}_{n} ) cos β \\ \frac{\partial {z}_{sn}}{\partial α} = \{ - {z}_{6 n} sin ( α + {γ}_{n} + {η}_{n} ) - {c}_{1 n} sin ( α + {γ}_{n} ) + {b}_{2 n} cos α \} cos β \\ \frac{\partial {z}_{sn}}{\partial β} = - \{ {z}_{6 n} cos ( α + {γ}_{n} + {η}_{n} ) + {c}_{1 n} cos ( α + {γ}_{n} ) + {b}_{2 n} sin α \} sin β - {a}_{1 n} cos β \\ ∴ \\ ( 40 ) \\ {T}_{sn}^{tr} = \frac{1}{2} {m}_{sn} ( {\dot{x}}_{sn}^{2} + {\dot{y}}_{sn}^{2} + {\dot{z}}_{sn}^{2} ) \\ = \frac{1}{2} {m}_{sn} {\sum }_{j , k}^{} ( \frac{\partial {x}_{sn}}{\partial {q}_{j}} \frac{\partial {x}_{sn}}{\partial {q}_{k}} {\dot{q}}_{j} {\dot{q}}_{k} + \frac{\partial {y}_{sn}}{\partial {q}_{j}} \frac{\partial {y}_{sn}}{\partial {q}_{k}} {\dot{q}}_{j} {\dot{q}}_{k} + \frac{\partial {z}_{sn}}{\partial {q}_{j}} \frac{\partial {z}_{sn}}{\partial {q}_{k}} {\dot{q}}_{j} {\dot{q}}_{k} ) \\ ( 41 ) \\ = \frac{1}{2} {m}_{sn} ⟨ {\dot{z}}_{6 n}^{2} + {\dot{η}}_{n}^{2} {z}_{6 n}^{2} + {\dot{α}}^{2} [ {z}_{6 n}^{2} + {c}_{1 n}^{2} + {b}_{2 n}^{2} + \\ 2 \{ {z}_{6 n} {c}_{1 n} cos {η}_{n} - {z}_{6 n} {b}_{2 n} sin ( {γ}_{n} + {η}_{n} ) - {c}_{1 n} {b}_{2 n} sin {γ}_{n} \} ] + \\ {{\dot{β}}^{2} [ \{ {z}_{6 n} cos ( α + {γ}_{n} + {η}_{n} ) + {c}_{1 n} cos ( α + {γ}_{n} ) + {b}_{2 n} sin α ) \}}^{2} + {a}_{1 n}^{2} ] + {\dot{z}}_{0}^{2} + \\ 2 {\dot{z}}_{6 n} \dot{α} \{ {c}_{1 n} sin {η}_{n} + {b}_{2 n} cos ( {γ}_{n} + {η}_{n} ) \} - \\ 2 {\dot{z}}_{6 n} \dot{β} {a}_{1 n} cos ( α + {γ}_{n} + {η}_{n} ) + \\ 2 {\dot{η}}_{n} \dot{α} {z}_{6 n} \{ {z}_{6 n} + {c}_{1 n} cos {η}_{n} - {b}_{2 n} sin ( {γ}_{n} + {η}_{n} ) \} + \\ 2 {\dot{η}}_{n} \dot{β} {z}_{6 n} {a}_{1 n} sin ( α + {γ}_{n} + {η}_{n} ) + \\ 2 \dot{α} \dot{β} {a}_{1 n} \{ {z}_{6 n} sin ( α + {γ}_{n} + {η}_{n} ) + {c}_{1 n} sin ( α + {γ}_{n} ) - {b}_{2 n} cos α \} + \\ 2 {\dot{z}}_{6 n} {\dot{z}}_{0} cos ( α + {γ}_{n} + {η}_{n} ) cos β - \\ 2 {\dot{η}}_{n} {\dot{z}}_{0} {z}_{6 n} sin ( α + {γ}_{n} + {η}_{n} ) cos β + \\ 2 \dot{α} {\dot{z}}_{0} \{ {z}_{6 n} sin ( α + {γ}_{n} + {η}_{n} ) - {c}_{1 n} sin ( α + {γ}_{n} ) + {b}_{2 n} cos α \} cos β + \\ 2 \dot{β} {\dot{z}}_{0} [ \{ {z}_{6 n} cos ( α + {γ}_{n} + {η}_{n} ) + {c}_{1 n} sin ( α + {γ}_{n} ) + {b}_{2 n} cos α \} sin β + {α}_{1 n} cos β ] \\ ⟩$$

$$( 42 )$$

$${T}_{sn}^{ro} ≅ 0 \\ {U}_{sn} = {m}_{sn} {gz}_{sn} + \frac{1}{2} {{k}_{sn} ( {z}_{6 n} - {l}_{sn} )}^{2} \\ = {m}_{sn} g [ {z}_{0} + \{ {z}_{6 n} cos ( α + {γ}_{n} + {η}_{n} ) + {c}_{1 n} cos ( α + {γ}_{n} ) + \\ {b}_{2 n} sin α \} cos β - {a}_{1 n} sin β ] + \frac{1}{2} {{k}_{sn} ( {z}_{6 n} - {l}_{sn} )}^{2} \\ {F}_{sn} = - \frac{1}{2} {c}_{sn} {\dot{z}}_{6 n}^{2} \\ \text{<} Arm \text{>}$$

$$( 43 )$$

$${T}_{an}^{tr} = \frac{1}{2} {m}_{an} ( {\dot{x}}_{an}^{2} + {\dot{y}}_{an}^{2} + {\dot{z}}_{an}^{2} )$$

$$where$$

$$( 44 )$$

$${x}_{an} = \{ {e}_{1 n} sin ( α + {γ}_{n} + {θ}_{n} ) + {c}_{2 n} cos ( α + {γ}_{n} ) + {b}_{2 n} sin α \} sin β + {a}_{1 n} cos β \\ {y}_{an} = {e}_{1 n} cos ( α + {γ}_{n} + {θ}_{n} ) - {c}_{2 n} sin ( α + {γ}_{n} ) + {b}_{2 n} cos α \\ {z}_{an} = {z}_{0} + \{ {e}_{1 n} sin ( α + {γ}_{n} + {θ}_{n} ) + {c}_{2 n} cos ( α + {γ}_{n} ) + {b}_{2 n} sin α \} cos β - {a}_{1 n} sin β$$

$$and$$

$$( 45 )$$

$${q}_{j , k} = {θ}_{n} , α , β , {z}_{0} \\ \frac{\partial {x}_{an}}{\partial {θ}_{n}} = {e}_{1 n} cos ( α + {γ}_{n} + {θ}_{n} ) sin β \\ \frac{\partial {x}_{an}}{\partial α} = \{ {e}_{1 n} cos ( α + {γ}_{n} + {θ}_{n} ) - {c}_{2 n} sin ( α + {γ}_{n} ) + {b}_{2 n} cos α \} sin β \\ \frac{\partial {x}_{an}}{\partial β} = \{ {e}_{1 n} sin ( α + {γ}_{n} + {θ}_{n} ) + {c}_{2 n} cos ( α + {γ}_{n} ) + {b}_{2 n} sin α \} cos β - {a}_{1 n} sin β \\ \frac{\partial {y}_{an}}{\partial {θ}_{n}} = - {e}_{1 n} sin ( α + {γ}_{n} + {θ}_{n} ) \\ \frac{\partial {y}_{an}}{\partial α} = - {e}_{1 n} sin ( α + {γ}_{n} + {θ}_{n} ) - {c}_{2 n} cos ( α + {γ}_{n} ) - {b}_{2 n} sin α \\ \frac{\partial {y}_{an}}{\partial β} = \frac{\partial {x}_{an}}{\partial {z}_{0}} = \frac{\partial {y}_{an}}{\partial {z}_{0}} = 0 \\ \frac{\partial {z}_{an}}{\partial {θ}_{n}} = {e}_{1 n} cos ( α + {γ}_{n} + {θ}_{n} ) cos β \\ \frac{\partial {z}_{an}}{\partial α} = \{ {e}_{1 n} cos ( α + {γ}_{n} + {θ}_{n} ) - {c}_{2 n} sin ( α + {γ}_{n} ) + {b}_{2 n} cos α \} cos β \\ \frac{\partial {z}_{an}}{\partial β} = - \{ {ⅇ}_{1 n} sin ( α + {γ}_{n} + {θ}_{n} ) + {c}_{2 n} cos ( α + {γ}_{n} ) + {b}_{2 n} sin α \} sin β - {a}_{1 n} cos β \\ \frac{\partial {z}_{an}}{\partial {z}_{0}} = 1$$

$$thus$$

$$( 46 )$$

$${T}_{an}^{tr} = \frac{1}{2} {m}_{an} ( {\dot{x}}_{an}^{2} + {\dot{y}}_{an}^{2} + {\dot{z}}_{an}^{2} ) \\ = \frac{1}{2} {m}_{an} {\sum }_{j , k}^{} ( \frac{\partial {x}_{an}}{\partial {q}_{j}} \frac{\partial {x}_{an}}{\partial {q}_{k}} {\dot{q}}_{j} {\dot{q}}_{k} + \frac{\partial {y}_{an}}{\partial {q}_{j}} \frac{\partial {y}_{an}}{\partial {q}_{k}} {\dot{q}}_{j} {\dot{q}}_{k} + \frac{\partial {z}_{an}}{\partial {q}_{j}} \frac{\partial {z}_{an}}{\partial {q}_{k}} {\dot{q}}_{j} {\dot{q}}_{k} )$$

$$( 47 ) \\ = \frac{1}{2} {m}_{an} ⟨ {\dot{θ}}_{n}^{2} {e}_{1 n}^{2} + {\dot{α}}^{2} [ {e}_{1 n}^{2} + {c}_{2 n}^{2} + {b}_{2 n}^{2} - 2 \{ {e}_{1 n} {c}_{2 n} sin {θ}_{n} + {e}_{1 n} {b}_{2 n} cos ( {γ}_{n} + {θ}_{n} ) + {c}_{2 n} {b}_{2 n} sin {γ}_{n} \} ] + \\ {\dot{β}}^{2} [ {\{ {e}_{1 n} sin ( α + {γ}_{n} + {θ}_{n} ) + {c}_{2 n} cos ( α + {γ}_{n} ) + {b}_{2 n} sin α \}}^{2} + {a}_{1 n}^{2} ] + {\dot{z}}_{0}^{2} + \\ 2 \dot{θ} \dot{α} {e}_{1 n} \{ {e}_{1 n} - {c}_{2 n} sin {θ}_{n} + {b}_{2 n} cos ( {γ}_{n} + {θ}_{n} ) \} - \\ 2 {\dot{θ}}_{n} \dot{β} {e}_{1 n} {a}_{1 n} cos ( α + {γ}_{n} + {θ}_{n} ) - 2 \dot{α} \dot{β} {a}_{1 n} \{ {ⅇ}_{1 n} cos ( α + {γ}_{n} + {θ}_{n} ) - {c}_{1 n} sin ( α + {γ}_{n} ) + {b}_{2 n} cos α \} - \\ 2 {\dot{θ}}_{n} {\dot{z}}_{0} {e}_{1 n} cos ( α + {γ}_{n} + {θ}_{n} ) cos β + \\ 2 \dot{α} {\dot{z}}_{0} \{ {e}_{1 n} cos ( α + {γ}_{n} + {θ}_{n} ) - {c}_{2 n} sin ( α + {γ}_{n} ) + {b}_{2 n} cos α \} cos β + \\ 2 \dot{β} {\dot{z}}_{0} [ \{ {e}_{1 n} sin ( α + {γ}_{n} + {θ}_{n} ) + {c}_{2 n} cos ( α + {γ}_{n} ) + {b}_{2 n} sin α \} sin β + {α}_{1 n} cos β ] ⟩$$

$$( 48 )$$

$${T}_{an}^{ro} = \frac{1}{2} {I}_{ax} {ω}_{ax}^{2} \\ = \frac{1}{2} {{I}_{ax} ( \dot{α} + {\dot{θ}}_{n} )}^{2} \\ {U}_{an} = {m}_{an} {gz}_{an} \\ = {m}_{an} g [ {z}_{0} + \{ {e}_{1 n} sin ( α + {γ}_{n} + {θ}_{n} ) + {c}_{2 n} cos ( α + {γ}_{n} ) + {b}_{2 n} sin α \} cos β - {a}_{1 n} sin β ] \\ \text{<} Wheel \text{>}$$

$$( 49 )$$

$${T}_{wn}^{tr} = \frac{1}{2} {m}_{wn} ( {\dot{x}}_{wn}^{2} + {\dot{y}}_{wn}^{2} + {\dot{z}}_{wn}^{2} )$$

$$where$$

$$( 50 )$$

$${x}_{wn} = \{ {e}_{3 n} sin ( α + {γ}_{n} + {θ}_{n} ) + {c}_{2 n} cos ( α + {γ}_{n} ) + {b}_{2 n} sin α \} sin β + {a}_{1 n} cos β \\ {y}_{wn} = {e}_{3 n} cos ( α + {γ}_{n} + {θ}_{n} ) - {c}_{2 n} sin ( α + {γ}_{n} ) + {b}_{2 n} cos α \\ {z}_{wn} = {z}_{0} + \{ {e}_{3 n} sin ( α + {γ}_{n} + {θ}_{n} ) + {c}_{2 n} cos ( α + {γ}_{n} ) + {b}_{2 n} sin α \} cos β - {a}_{1 n} sin β$$

Substituting mₐₙ with m_{wn} and e₁ₙ with e₃ₙ in the equation for the arm, yields an equation for the wheel as:

$$\begin{matrix}{T}_{wn}^{tr} = \frac{1}{2} {m}_{wn} ⟨ {\dot{θ}}_{n}^{2} {e}_{3 n}^{2} + {\dot{α}}^{2} [ {ⅇ}_{3 n}^{2} + {c}_{2 n}^{2} + {b}_{2 n}^{2} - 2 \{ {e}_{3 n} {c}_{2 n} sin {θ}_{n} + {e}_{3 n} {b}_{2 n} cos ( {γ}_{n} + {θ}_{n} ) + {c}_{2 n} {b}_{2 n} sin {γ}_{n} \} ] + \\ {\dot{β}}^{2} [ {\{ {e}_{3 n} sin ( α + {γ}_{n} + {θ}_{n} ) + {c}_{2 n} cos ( α + {γ}_{n} ) + {b}_{2 n} sin α \}}^{2} + {a}_{1 n}^{2} ] + {\dot{z}}_{0}^{2} + \\ 2 \dot{θ} \dot{α} {e}_{3 n} \{ {e}_{3 n} - {c}_{2 n} sin {θ}_{n} + {b}_{2 n} cos ( {γ}_{n} + {θ}_{n} ) \} - \\ 2 {\dot{θ}}_{n} \dot{β} {e}_{3 n} {a}_{1 n} cos ( α + {γ}_{n} + {θ}_{n} ) - 2 \dot{α} \dot{β} {a}_{1 n} \{ {e}_{3 n} cos ( α + {γ}_{n} + {θ}_{n} ) - {c}_{1 n} sin ( α + {γ}_{n} ) + {b}_{2 n} cos α \} + \\ 2 {θ}_{n} {z}_{0} {e}_{3 n} cos ( α + {γ}_{n} + {θ}_{n} ) cos β + \\ 2 \dot{α} {\dot{z}}_{0} \{ {e}_{3 n} cos ( α + {γ}_{n} + {θ}_{n} ) - {c}_{2 n} sin ( α + {γ}_{n} ) + {b}_{2 n} cos α \} cos β - \\ 2 \dot{β} {\dot{z}}_{0} [ \{ {e}_{3 n} sin ( α + {γ}_{n} + {θ}_{n} ) + {c}_{2 n} sin ( α + {γ}_{n} ) + {b}_{2 n} sin α \} sin β + {α}_{1 n} cos β ] ⟩ & ( 51 ) \\ {T}_{wn}^{ro} = 0 \\ {U}_{wn} = {m}_{wn} {gz}_{wn} + \frac{1}{2} {{k}_{wn} ( {z}_{12 n} - {l}_{wn} )}^{2} \\ = {m}_{wn} g [ {z}_{0} + \{ {e}_{3 n} sin ( α + {γ}_{n} + {θ}_{n} ) + {c}_{2 n} cos ( α + {γ}_{n} ) + {b}_{2 n} sin α \} cos β - {a}_{1 n} sin β ] + \frac{1}{2} {{k}_{wn} ( {z}_{12 n} - {l}_{wn} )}^{2} \\ {F}_{wn} = - \frac{1}{2} {c}_{wn} {\dot{z}}_{12 n}^{2} \\ & ( 52 ) \\ \text{<} Stabilizer \text{>} \\ {T}_{zn}^{tr} ≅ 0 & ( 53 ) \\ {T}_{zn}^{ro} ≅ 0 & ( 54 ) \\ {U}_{zi , ii} ≅ \frac{1}{2} {{k}_{zi} ( {z}_{zi} - {z}_{zii} )}^{2} \\ = \frac{1}{2} {{k}_{zi} [ \{ {e}_{0 i} sin ( {γ}_{i} + {θ}_{i} ) + {c}_{2 i} cos {γ}_{i} \} - \{ {e}_{0 ii} sin ( {γ}_{ii} + {θ}_{ii} ) + {c}_{2 ii} cos {γ}_{ii} \} ]}^{2} \\ = \frac{1}{2} {k}_{zi} {e}_{0 i}^{2} {\{ sin ( {γ}_{i} + {θ}_{i} ) + sin ( {γ}_{ii} + {θ}_{ii} ) \}}^{2} \\ where {e}_{0 ii} = - {e}_{0 i} , {c}_{2 ii} = {c}_{2 i} , {γ}_{ii} = - {γ}_{i} \\ {U}_{ziii , iv} ≅ \frac{1}{2} {{k}_{ziii} ( {z}_{ziii} - {z}_{ziv} )}^{2} \\ = \frac{1}{2} {{k}_{ziii} [ \{ {e}_{0 iii} sin ( {γ}_{iii} + {θ}_{iii} ) + {c}_{2 iii} cos {γ}_{iii} \} - \{ {e}_{0 iv} sin ( {γ}_{iv} + {θ}_{iv} ) + {c}_{2 iv} cos {γ}_{iv} \} ]}^{2} \\ = \frac{1}{2} {k}_{ziii} {e}_{0 iii}^{2} {\{ sin ( {γ}_{iii} + {θ}_{iii} ) + sin ( {γ}_{iv} + {θ}_{iiv} ) \}}^{2} \\ where {e}_{0 ii} = - {e}_{0 iii} {c}_{2 iv} = {c}_{2 iii} , {γ}_{iv} = - {γ}_{iii} & ( 55 ) \\ {F}_{zn} ≅ 0 & ( 56 )\end{matrix}$$

Therefore the total kinetic energy is:

$${T}_{tot} = {T}_{b}^{tr} + {\sum }_{n = i}^{iv} \vert {T}_{sn}^{tr} + {T}_{an}^{tr} + {T}_{wn}^{tr} + {T}_{b}^{ro} + {T}_{an}^{ro} \vert ( 57 )$$

$$( 58 )$$

$${T}_{tot} = {T}_{b}^{tr} + {\sum }_{n = i}^{iv} \vert {T}_{sn}^{tr} + {T}_{an}^{tr} + {T}_{wn}^{tr} + {T}_{b}^{ro} + {T}_{an}^{ro} \vert = \frac{1}{2} {m}_{b} ⟨ {\dot{α}}^{2} ( {b}_{0}^{2} + {c}_{0}^{2} ) + {\dot{β}}^{2} \{ {( {a}_{0} + {a}_{1 i} )}^{2} + {( {b}_{0} sin α + {c}_{0} cos α )}^{2} \} + {\dot{z}}_{0}^{2} - 2 \dot{α} \dot{β} ( {a}_{0} + {a}_{1 i} ) ( {b}_{0} cos α - {c}_{0} sin α ) - 2 \dot{β} {\dot{z}}_{0} \{ ( {a}_{0} + {a}_{1 i} ) cos β + ( {b}_{0} sin α + {c}_{0} cos α ) sin β \} + 2 \dot{a} {\dot{z}}_{0} ( {b}_{0} cos α - {c}_{0} sin α ) cos β ⟩ + {\sum }_{n = i}^{iv} \vert \frac{1}{2} {m}_{sn} ⟨ {\dot{z}}_{6 n}^{2} + {\dot{η}}_{n}^{2} {z}_{6 n}^{2} + {\dot{α}}^{2} [ {z}_{6 n}^{2} + {c}_{1 n}^{2} + {b}_{2 n}^{2} + 2 \{ {z}_{6 n} {c}_{1 n} cos {η}_{n} - {z}_{6 n} {b}_{2 n} sin ( {γ}_{n} + {η}_{n} ) - {c}_{1 n} {b}_{2 n} sin {γ}_{n} \} ] + {\dot{β}}^{2} [ {\{ {z}_{6 n} cos ( α + {γ}_{n} + {η}_{n} ) + {c}_{1 n} cos ( α + {γ}_{n} ) + {b}_{2 n} sin α \}}^{2} + {a}_{1 n}^{2} ] + {\dot{z}}_{0}^{2} + 2 {\dot{z}}_{6 n} \dot{α} \{ {c}_{1 n} sin {η}_{n} + {b}_{2 n} cos ( {γ}_{n} + {η}_{n} ) \} - 2 {\dot{z}}_{6 n} \dot{β} {a}_{1 n} cos ( α + {γ}_{n} + {η}_{n} ) + 2 {\dot{η}}_{n} \dot{α} {z}_{6 n} \{ {z}_{6 n} + {c}_{1 n} cos {η}_{n} - {b}_{2 n} sin ( {γ}_{n} + {η}_{n} ) \} + 2 {\dot{η}}_{n} \dot{β} {z}_{6 n} {a}_{1 n} sin ( α + {γ}_{n} + {η}_{n} ) + 2 \dot{α} \dot{β} {a}_{1 n} \{ {z}_{6 n} sin ( α + {γ}_{n} + {η}_{n} ) + {c}_{1 n} sin ( α + {γ}_{n} ) - {b}_{2 n} cos α \} + 2 {\dot{z}}_{6 n} {\dot{z}}_{0} cos ( α + {γ}_{n} + {η}_{n} ) cos β - 2 {\dot{η}}_{n} {\dot{z}}_{0} {z}_{6 n} sin ( α + {γ}_{n} + {η}_{n} ) cos β + 2 \dot{α} {\dot{z}}_{0} \{ - {z}_{6 n} sin ( α + {γ}_{n} + {η}_{n} ) - {c}_{1 n} sin ( α + {γ}_{n} ) + {b}_{2 n} cos α \} cos β - 2 \dot{β} {\dot{z}}_{0} [ \{ {z}_{6 n} cos ( α + {γ}_{n} + {η}_{n} ) - {c}_{1 n} cos ( α + {γ}_{n} ) + {b}_{2 n} sin α \} + {a}_{1 n} cos β ] ⟩ + \frac{1}{2} {m}_{an} ⟨ {\dot{θ}}_{n}^{2} {e}_{1 n}^{2} + {\dot{α}}^{2} [ {e}_{1 n}^{2} + {c}_{2 n}^{2} + {b}_{2 n}^{2} - 2 \{ {e}_{1 n} {c}_{2 n} sin {θ}_{n} + {e}_{1 n} {b}_{2 n} cos ( {γ}_{n} + {θ}_{n} ) + {c}_{2 n} {b}_{2 n} sin {γ}_{n} \} ] + {\dot{β}}^{2} [ {\{ {e}_{1 n} sin ( α + {γ}_{n} + {θ}_{n} ) + {c}_{2 n} cos ( α + {γ}_{n} ) + {b}_{2 n} sin α \}}^{2} + {a}_{1 n}^{2} ] + {\dot{z}}_{0}^{2} + 2 \dot{θ} \dot{α} {e}_{1 n} \{ {e}_{1 n} - {c}_{2 n} sin {θ}_{n} + {b}_{2 n} cos ( {γ}_{n} + {θ}_{n} ) \} - 2 {\dot{θ}}_{n} \dot{β} {e}_{1 n} {a}_{1 n} cos ( α + {γ}_{n} + {θ}_{n} ) - 2 \dot{α} \dot{β} {a}_{1 n} \{ {e}_{1 n} cos ( α + {γ}_{n} + {θ}_{n} ) - {c}_{1 n} sin ( α + {γ}_{n} ) + {b}_{2 n} cos α \} + 2 {\dot{θ}}_{n} {\dot{z}}_{0} {e}_{1 n} cos ( α + {γ}_{n} + {θ}_{n} ) cos β + 2 \dot{α} {\dot{z}}_{0} \{ {e}_{1 n} cos ( α + {γ}_{n} + {θ}_{n} ) - {c}_{2 n} sin ( α + {γ}_{n} ) + {b}_{2 n} cos α \} cos β - 2 \dot{β} {\dot{z}}_{0} [ \{ {e}_{1 n} sin ( α + {γ}_{n} + {θ}_{n} ) + {c}_{2 n} cos ( α + {γ}_{n} ) + {b}_{2 n} sin α \} + {a}_{1 n} cos β ⟩ + \frac{1}{2} {m}_{wn} ⟨ {\dot{θ}}_{n}^{2} {e}_{3 n}^{2} + {\dot{α}}^{2} [ {e}_{3 n}^{2} + {c}_{2 n}^{2} + {b}_{2 n}^{2} - 2 \{ {e}_{3 n} {c}_{2 n} sin {θ}_{n} - {e}_{3 n} {b}_{2 n} cos ( {γ}_{n} + {θ}_{n} ) + {c}_{2 n} {b}_{2 n} sin {γ}_{n} \} ] + {\dot{β}}^{2} [ {\{ {e}_{3 n} sin ( α + {γ}_{n} + {θ}_{n} ) + {c}_{2 n} cos ( α + {γ}_{n} ) + {b}_{2 n} sin α \}}^{2} + {a}_{1 n}^{2} ] + {\dot{z}}_{0}^{2} + 2 \dot{θ} \dot{α} {e}_{3 n} \{ {e}_{3 n} - {c}_{2 n} sin {θ}_{n} + {b}_{2 n} cos ( {γ}_{n} + {θ}_{n} ) \} - 2 {\dot{θ}}_{n} \dot{β} {e}_{3 n} {a}_{1 n} cos ( α + {γ}_{n} + {θ}_{n} ) - 2 \dot{α} \dot{β} {a}_{1 n} \{ {e}_{3 n} cos ( α + {γ}_{n} + {θ}_{n} ) - {c}_{1 n} sin ( α + {γ}_{n} ) + {b}_{2 n} cos α \} + 2 {\dot{θ}}_{n} {\dot{z}}_{0} {e}_{3 n} cos ( α + {γ}_{n} + {η}_{n} ) cos β + 2 \dot{α} {\dot{z}}_{0} \{ {e}_{3 n} cos ( α + {γ}_{n} + {θ}_{n} ) - {c}_{2 n} sin ( α + {γ}_{n} ) + {b}_{2 n} cos α \} cos β - 2 \dot{β} {\dot{z}}_{0} [ \{ {e}_{3 n} sin ( α + {γ}_{n} + {θ}_{n} ) - {c}_{2 n} cos ( α + {γ}_{n} ) + {b}_{2 n} sin α \} + {a}_{1 n} cos β ⟩ + \frac{1}{2} ( {I}_{bx} {\dot{α}}^{2} + {I}_{by} {\dot{β}}^{2} ) + \frac{1}{2} {{I}_{anx} ( \dot{α} + {\dot{θ}}_{n} )}^{2} \vert \\ ( 59 ) \\ = \frac{1}{2} [ {\dot{α}}^{2} {m}_{bb1} + {\dot{β}}^{2} \{ {m}_{ba1} + {{m}_{b} ( {b}_{0} sin α + {c}_{0} cos α )}^{2} \} + {\dot{z}}_{0}^{2} {m}_{b} - 2 \dot{α} ( \dot{β} {m}_{ba} - {\dot{z}}_{0} {m}_{b} cos β ) ( {b}_{0} cos α - {c}_{0} sin α ) - 2 \dot{β} {\dot{z}}_{0} \{ {m}_{ba} cos β + {m}_{b} ( {b}_{0} sin α + {c}_{0} cos α ) sin β \} ] + \frac{1}{2} {\sum }_{n = i}^{iv} \vert {m}_{sn} ( {\dot{z}}_{6 n}^{2} + {\dot{η}}_{n}^{2} {z}_{6 n}^{2} ) + {\dot{θ}}_{n}^{2} {m}_{aw21n} + {\dot{z}}_{0}^{2} {m}_{sawn} + {\dot{α}}^{2} ⟨ {m}_{sawln} + {m}_{sn} {z}_{6 n} [ {z}_{6 n} + 2 {m}_{sn} \{ {c}_{1 n} cos {η}_{n} - {b}_{2 n} sin ( {γ}_{n} + {η}_{n} ) \} ] - 2 {m}_{aw1n} \{ {c}_{2 n} sin {θ}_{n} - {b}_{2 n} cos ( {γ}_{n} + {θ}_{n} ) \} ⟩ + {\dot{β}}^{2} ⟨ {m}_{saw2n} + {m}_{sn} {\{ {z}_{6 n} cos ( α + {γ}_{n} + {η}_{n} ) + {c}_{1 n} cos ( α + {γ}_{n} ) + {b}_{2 n} sin α \}}^{2} + {m}_{an} {\{ {e}_{1} sin ( α + {γ}_{n} + {θ}_{n} ) + {c}_{2 n} cos ( α + {γ}_{n} ) + {b}_{2 n} sin α \}}^{2} + {m}_{wn} {\{ {e}_{3} sin ( α + {γ}_{n} + {θ}_{n} ) + {c}_{2 n} cos ( α + {γ}_{n} ) + {b}_{2 n} sin α \}}^{2} ⟩ + 2 {\dot{z}}_{6 n} \dot{α} {m}_{sn} \{ {c}_{1 n} sin {η}_{n} + {b}_{2 n} cos ( {γ}_{n} + {η}_{n} ) \} - 2 {\dot{z}}_{6 n} \dot{β} {ma}_{1 n} cos ( α + {γ}_{n} + {η}_{n} ) + 2 {\dot{η}}_{n} \dot{α} {m}_{sn} {z}_{6 n} \{ {z}_{6 n} + {c}_{1 n} cos {η}_{n} - {b}_{2 n} sin ( {γ}_{n} + {η}_{n} ) \} + 2 {\dot{η}}_{n} \dot{β} {m}_{sn} {z}_{6 n} {a}_{1 n} sin ( α + {γ}_{n} + {η}_{n} ) + 2 \dot{θ} \dot{α} [ {m}_{aw21n} - {m}_{aw1n} \{ {c}_{2 n} sin {θ}_{n} - {b}_{2 n} cos ( {γ}_{n} + {θ}_{n} ) \} ] - 2 \dot{θ} \dot{β} {m}_{aw1n} {a}_{1 n} cos ( α + {γ}_{n} + {θ}_{n} ) + 2 \dot{α} \dot{β} {a}_{1 n} \{ {m}_{sawcn} sin ( α + {γ}_{n} ) - {m}_{sawbn} cos α + {m}_{sn} {z}_{6 n} sin ( α + {γ}_{n} + {η}_{n} ) - {m}_{aw1n} cos ( α + {γ}_{n} + {θ}_{n} ) \} + 2 {\dot{z}}_{6 n} {\dot{z}}_{0} {m}_{sn} cos ( α + {γ}_{n} + {η}_{n} ) cos β - 2 ( \dot{α} + {\dot{η}}_{n} ) {\dot{z}}_{0} {z}_{6 n} {m}_{sn} sin ( α + {γ}_{n} + {η}_{n} ) cos β + 2 {\dot{θ}}_{n} {\dot{z}}_{0} {m}_{aw1n} cos ( α + {γ}_{n} + {θ}_{n} ) cos β + 2 \dot{α} {\dot{z}}_{0} \{ {m}_{aw1n} sin ( α + {γ}_{n} + {θ}_{n} ) - {m}_{sawcn} sin ( α + {γ}_{n} ) + {m}_{sawbn} cos α \} cos β - 2 \dot{β} {\dot{z}}_{0} [ \{ {z}_{6 n} {m}_{sn} cos ( α + {γ}_{n} + {η}_{n} ) - {m}_{aw1n} sin ( α + {γ}_{n} ) + {m}_{sawcn} cos ( α + {γ}_{n} ) + {m}_{sawbn} sin α \} sin β + {m}_{sawan} cos β ] ⟩ \vert \\ where \\ ( 60 ) \\ {m}_{ba} = {m}_{b} ( {a}_{0} + {a}_{1 i} ) \\ {m}_{bb1} = {m}_{b} ( {b}_{0}^{2} + {c}_{0}^{2} ) + {I}_{bx} \\ {m}_{ba1} = {{m}_{b} ( {a}_{0} + {a}_{1 i} )}^{2} + {I}_{by} \\ {m}_{sawn} = {m}_{sn} + {m}_{an} + {m}_{wn} \\ {m}_{sawan} = ( {m}_{sn} + {m}_{an} + {m}_{wn} ) {a}_{1 n} \\ {m}_{sawbn} = ( {m}_{sn} + {m}_{an} + {m}_{wn} ) {b}_{2 n} \\ {m}_{sawcn} = {m}_{sn} {c}_{1 n} + ( {m}_{an} + {m}_{wn} ) {c}_{2 n} \\ {m}_{saw2n} = ( {m}_{sn} + {m}_{an} + {m}_{wn} ) {a}_{1 n}^{2} \\ {m}_{saw1n} = {m}_{an} {e}_{1 n}^{2} + {m}_{wn} {e}_{3 n}^{2} + {m}_{sn} ( {c}_{1 n}^{2} + {b}_{2 n}^{2} - 2 {c}_{1 n} {b}_{2 n} sin {γ}_{n} ) + \\ ( {m}_{an} + {m}_{wn} ) ( {c}_{2 n}^{2} + {b}_{2 n}^{2} - 2 {c}_{2 n} {b}_{2 n} sin {γ}_{n} ) + {I}_{axn} \\ {m}_{aw21n} = {m}_{an} {e}_{1 n}^{2} + {m}_{wn} {e}_{3 n}^{2} + {I}_{axn} \\ {m}_{aw1n} = {m}_{an} {e}_{1 n} + {m}_{wn} {e}_{3 n} \\ {m}_{aw2n} = {m}_{an} {e}_{1 n}^{2} + {m}_{wn} {e}_{3 n}^{2}$$

Hereafter variables and coefficients which have index “n” implies implicit or explicit that they require summation with n=i, ii, iii, and iv.

Total potential energy is:

$$\begin{matrix}{U}_{tot} = {U}_{b} + {\sum }_{n = i}^{iv} \vert {U}_{sn} + {U}_{an} + {U}_{wn} + {U}_{zn} \vert & ( 61 ) \\ = {m}_{b} g \{ {z}_{0} - ( {a}_{0} + {a}_{1 n} ) sin β + ( {b}_{0} sin α + {c}_{0} cos α ) cos β \} + \\ {\sum }_{n = i}^{iv} \vert {m}_{sn} g [ {z}_{0} + \{ {z}_{6 n} cos ( α + {γ}_{n} + {η}_{n} ) + {c}_{1 n} cos ( α + {γ}_{n} ) + {b}_{2 n} sin α \} cos β - {a}_{1 n} sin β ] + \frac{1}{2} {{k}_{sn} ( {z}_{6 n} - {l}_{sn} )}^{2} + \\ {m}_{an} g [ {z}_{0} + \{ {e}_{1 n} sin ( α + {γ}_{n} + {θ}_{n} ) + {c}_{2 n} cos ( α + {γ}_{n} ) + {b}_{2 n} sin α \} cos β - {a}_{1 n} sin β ] + \\ {m}_{wn} g [ {z}_{0} + \{ {e}_{3 n} sin ( α + {γ}_{n} + {θ}_{n} ) + {c}_{2 n} cos ( α + {γ}_{n} ) + {b}_{2 n} sin α \} cos β - {a}_{1 n} sin β ] + \frac{1}{2} {{k}_{wn} ( {z}_{12 n} - {l}_{wn} )}^{2} \vert + \\ \frac{1}{2} {k}_{zi} {e}_{oi}^{2} {\{ sin ( {γ}_{i} + {θ}_{i} ) + sin ( {γ}_{ii} + {θ}_{ii} ) \}}^{2} + \frac{1}{2} {k}_{ziii} {e}_{oiii}^{2} {\{ sin ( {γ}_{iii} + {θ}_{iii} ) + sin ( {γ}_{iv} + {θ}_{iv} ) \}}^{2} & ( 62 ) \\ = g \{ {z}_{0} {m}_{b} - {m}_{ba} sin β + {m}_{b} ( {b}_{0} sin α + {c}_{0} cos α ) cos β \} + \\ {\sum }_{n = i}^{iv} ⟨ g [ \{ {z}_{0} {m}_{sawn} + {m}_{sn} {z}_{6 n} cos ( α + {γ}_{n} + {η}_{n} ) + {m}_{aw1n} sin ( α + {γ}_{n} + {θ}_{n} ) + {m}_{sawcn} cos ( α + {γ}_{n} ) + \\ {m}_{sawbn} sin α \} cos β - {m}_{sawan} sin β ] + \frac{1}{2} {{k}_{sn} ( {z}_{6 n} - {l}_{sn} )}^{2} + \frac{1}{2} {{k}_{wn} ( {z}_{12 n} - {l}_{wn} )}^{2} ⟩ + \\ \frac{1}{2} {k}_{zi} {e}_{0 i}^{2} {\{ sin ( {γ}_{i} + {θ}_{i} ) + sin ( {γ}_{ii} + {θ}_{ii} ) \}}^{2} + \\ \frac{1}{2} {k}_{ziii} {e}_{oiii}^{2} {\{ sin ( {γ}_{iii} + {θ}_{iii} ) + sin ( {γ}_{iv} + {θ}_{iv} ) \}}^{2} & ( 63 ) \\ where \\ {m}_{ba} = {m}_{b} ( {a}_{0} + {a}_{1 i} ) \\ {m}_{sawan} = ( {m}_{sn} + {m}_{an} + {m}_{wn} ) {a}_{1 n} \\ {m}_{sawbn} = ( {m}_{sn} + {m}_{an} + {m}_{wn} ) {b}_{2 n} \\ {m}_{sawcn} = {m}_{sn} {c}_{1 n} + ( {m}_{an} + {m}_{wn} ) {c}_{2 n} \\ {γ}_{ii} = - {γ}_{i} & ( 64 )\end{matrix}$$

4. Lagrange's Equation

The Lagrangian is written as:

$$( 65 ) \\ L = {T}_{tot} - {U}_{tot} = \frac{1}{2} [ {\dot{α}}^{2} {m}_{bb1} + {\dot{β}}^{2} \{ {m}_{ba1} + {{m}_{b} ( {b}_{0} sin α + {c}_{0} cos α )}^{2} \} + {\dot{z}}_{0}^{2} {m}_{b} - ( 2 \dot{α} \dot{β} {m}_{ba} - {\dot{z}}_{0} {m}_{b} cos β ) ( {b}_{0} cos α - {c}_{0} sin α ) ] - 2 \dot{β} {\dot{z}}_{0} \{ {m}_{ba} cos β + {m}_{b} ( {b}_{0} sin α + {c}_{0} cos α ) sin β \} ] + \frac{1}{2} {\sum }_{n = i}^{iv} \vert {m}_{sn} ( {\dot{z}}_{6 n}^{2} + {\dot{η}}_{n}^{2} {z}_{6 n}^{2} ) + {\dot{θ}}_{n}^{2} {m}_{aw21n} + {\dot{z}}_{0}^{2} {m}_{sawn} + {\dot{α}}^{2} ⟨ {m}_{saw1n} + {m}_{sn} {z}_{6 n} [ {z}_{6 n} + 2 \{ {c}_{1 n} cos {η}_{n} - {b}_{2 n} sin ( {γ}_{n} + {η}_{n} ) \} ] - 2 {m}_{aw1n} \{ {c}_{2 n} sin {θ}_{n} - {b}_{2 n} cos ( {γ}_{n} + {θ}_{n} ) \} ⟩ + {\dot{β}}^{2} ⟨ {m}_{saw2n} + {m}_{sn} {\{ {z}_{6 n} cos ( α + {γ}_{n} + {η}_{n} ) + {c}_{1 n} cos ( α + {γ}_{n} ) + {b}_{2 n} sin α \}}^{2} + {m}_{an} {\{ {e}_{1} sin ( α + {γ}_{n} + {θ}_{n} ) + {c}_{2 n} cos ( α + {γ}_{n} ) + {b}_{2 n} sin α \}}^{2} + {m}_{wn} {\{ {e}_{3} sin ( α + {γ}_{n} + {θ}_{n} ) + {c}_{2 n} cos ( α + {γ}_{n} ) + {b}_{2 n} sin α \}}^{2} ⟩ + 2 {\dot{z}}_{6 n} \dot{α} {m}_{sn} \{ {c}_{1 n} sin {η}_{n} + {b}_{2 n} cos ( {γ}_{n} + {η}_{n} ) \} - 2 {\dot{z}}_{6 n} \dot{β} {m}_{sn} {a}_{1 n} cos ( α + {γ}_{n} + {η}_{n} ) + 2 {\dot{η}}_{n} \dot{α} {m}_{sn} {z}_{6 n} \{ {z}_{6 n} + {c}_{1 n} cos {η}_{n} - {b}_{2 n} sin ( {γ}_{n} + {η}_{n} ) \} + 2 {\dot{η}}_{n} \dot{β} {m}_{sn} {z}_{6 n} {a}_{1 n} sin ( α + {γ}_{n} + {η}_{n} ) + 2 \dot{θ} \dot{α} [ {m}_{aw21n} - {m}_{aw1n} \{ {c}_{2 n} sin {θ}_{n} - {b}_{2 n} cos ( {γ}_{n} + {θ}_{n} ) \} ] - 2 \dot{θ} \dot{β} {m}_{aw1n} {a}_{1 n} cos ( α + {γ}_{n} + {θ}_{n} ) + 2 \dot{α} \dot{β} {a}_{1 n} \{ {m}_{sawcn} sin ( α + {γ}_{n} ) - {m}_{sawbn} cos α + {m}_{sn} {z}_{6 n} sin ( α + {γ}_{n} + {η}_{n} ) - {m}_{aw1n} cos ( α + {γ}_{n} + {θ}_{n} ) \} + 2 {\dot{z}}_{0} \{ {\dot{z}}_{6 n} {m}_{sn} cos ( α + {γ}_{n} + {η}_{n} ) + ( \dot{α} + {\dot{θ}}_{n} ) {m}_{aw1n} cos ( α + {γ}_{n} + {θ}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α - \dot{β} {m}_{sawcn} \} cos β - 2 \dot{β} {\dot{z}}_{0} [ \{ {z}_{6 n} {m}_{sn} cos ( α + {γ}_{n} + {η}_{n} ) - {m}_{aw1n} sin ( α + {γ}_{n} + {θ}_{n} ) + {m}_{sawcn} cos ( α + {γ}_{n} ) + {m}_{sawbn} sin α \} sin β \} \vert - g \{ {z}_{0} {m}_{b} - {m}_{ba} sin β + {m}_{b} ( {b}_{0} sin α + {c}_{0} cos α ) cos β \} - \frac{1}{2} {k}_{zi} {e}_{0 i}^{2} {\{ sin ( {γ}_{i} + {θ}_{i} ) + sin ( {γ}_{ii} + {θ}_{ii} ) \}}^{2} - \frac{1}{2} {k}_{ziii} {e}_{0 iii}^{2} {\{ sin ( {γ}_{iii} + {θ}_{iii} ) + sin ( {γ}_{iv} + {θ}_{iv} ) \}}^{2} - {\sum }_{n = i}^{iv} ⟨ g [ {z}_{0} {m}_{sawn} + \{ {m}_{sn} {z}_{6 n} cos ( α + {γ}_{n} + {η}_{n} ) + {m}_{aw1n} sin ( α + {γ}_{n} + {θ}_{n} ) + {m}_{sawcn} cos ( α + {γ}_{n} ) + {m}_{sawbn} sin α \} cos β - {m}_{sawan} sin β ] + \frac{1}{2} {{k}_{sn} ( {z}_{6 n} - {l}_{sn} )}^{2} + \frac{1}{2} {{k}_{wn} ( {z}_{12 n} - {l}_{wn} )}^{2} ⟩ \\ ( 66 ) \\ \frac{\partial L}{\partial {z}_{0}} = - g ( {m}_{b} + {m}_{sawn} ) \\ \frac{\partial L}{\partial {\dot{z}}_{0}} = {\dot{z}}_{0} {m}_{b} + \dot{α} {m}_{b} cos β ( {b}_{0} cos α - {c}_{0} sin α ) - \dot{β} \{ {m}_{ba} cos β + {m}_{b} ( {b}_{0} sin α + {c}_{0} cos α ) sin β \} + {\dot{z}}_{0} {m}_{sawn} + \{ {z}_{6 n} {m}_{sn} cos ( α + {γ}_{n} + {η}_{n} ) + ( \dot{α} + {\dot{θ}}_{n} ) {m}_{aw1n} cos ( α + {γ}_{n} + {θ}_{n} ) - ( \dot{α} + {\dot{η}}_{n} ) {z}_{6 n} {m}_{sn} sin ( α + {γ}_{n} + {θ}_{n} ) - \dot{α} {m}_{sawcn} sin ( α + {γ}_{n} ) + \dot{α} {m}_{sawbn} cos α - \dot{β} {m}_{sawan} \} cos β - \dot{β} \{ {m}_{aw1n} sin ( α + {γ}_{n} + {θ}_{n} ) - {z}_{6 n} {m}_{sn} cos ( α + {γ}_{n} + {η}_{n} ) + {m}_{sawcn} cos ( α + {γ}_{n} ) + {m}_{sawbn} sin α \} sin β \\ \frac{ⅆ}{ⅆ t} ( \frac{\partial L}{\partial {\dot{z}}_{0}} ) = {\ddot{z}}_{0} ( {m}_{b} + {m}_{sawn} ) + \ddot{α} {m}_{b} ( {b}_{0} cos α - {c}_{0} sin α ) - \dot{β} \dot{α} {m}_{b} sin β ( {b}_{0} cos α - {c}_{0} sin α ) + {\dot{α}}^{2} {m}_{b} cos β ( {b}_{0} sin α + {c}_{0} cos α ) - \ddot{β} \{ {m}_{ba} cos β + {m}_{b} ( {b}_{0} sin α + {c}_{0} cos α ) sin β \} + \dot{β} \{ \dot{β} {m}_{ba} sin β + \dot{α} {m}_{b} ( {b}_{0} cos α - {c}_{0} sin α ) sin β + \dot{β} {m}_{b} ( {b}_{0} sin α + {c}_{0} cos α ) cos β \} + \{ {\ddot{z}}_{6 n} {m}_{sn} cos ( α + {γ}_{n} + {η}_{n} ) - ( \dot{α} + {\dot{η}}_{n} ) {\dot{z}}_{6 n} {m}_{sn} sin ( α + {γ}_{n} + {η}_{n} ) \} - ( \ddot{α} + {\ddot{η}}_{n} ) {z}_{6 n} {m}_{sn} sin ( α + {γ}_{n} + {η}_{n} ) - ( \dot{α} + {\dot{η}}_{n} ) {\dot{z}}_{6 n} {m}_{sn} sin ( α + {γ}_{n} + {η}_{n} ) - {( \dot{α} + {\dot{η}}_{n} )}^{2} {z}_{6 n} {m}_{sn} cos ( α + {γ}_{n} + {η}_{n} ) - \ddot{α} {m}_{sawcn} sin ( α + {γ}_{n} ) - {\dot{α}}^{2} {m}_{sawcn} sin ( α + {γ}_{n} ) + \ddot{α} {m}_{sawbn} cos α - {\dot{α}}^{2} {m}_{sawbn} sin α - \ddot{β} {m}_{sawan} \} cos β - \dot{β} \{ {\dot{z}}_{6 n} {m}_{sn} cos ( α + {γ}_{n} + {η}_{n} ) - ( \dot{α} + {\dot{θ}}_{n} ) {m}_{aw1n} cos ( α + {γ}_{n} + {θ}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) - \dot{α} {m}_{sawbn} cos α - \dot{β} {m}_{sawan} \} sin β - \ddot{β} \{ {m}_{aw1n} sin ( α + {γ}_{n} + {θ}_{n} ) + {z}_{6 n} {m}_{sn} cos ( α + {γ}_{n} + {η}_{n} ) + {m}_{awcn} cos ( α + {γ}_{n} ) + {m}_{sawbn} sin α \} sin β - \dot{β} \{ ( \dot{α} + {\dot{θ}}_{n} ) {m}_{aw1n} cos ( α + {γ}_{n} + {θ}_{n} ) + {z}_{6 n} {m}_{sn} cos ( α + {γ}_{n} + {η}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α \} sin β - {\dot{β}}^{2} \{ {m}_{aw1n} sin ( α + {γ}_{n} + {θ}_{n} ) - {z}_{6 n} {m}_{sn} cos ( α + {γ}_{n} + {η}_{n} ) + {m}_{sawcn} cos ( α + {γ}_{n} ) + {m}_{sawbn} sin α \} cos β \\ \frac{\partial L}{\partial β} = - \dot{α} {\dot{z}}_{0} {m}_{b} sin β ( {b}_{0} cos α - {c}_{0} sin α ) + \dot{β} {\dot{z}}_{0} \{ {m}_{ba} sin β - {m}_{b} ( {b}_{0} sin α - {c}_{0} cos α ) cos β \} ) g \{ {m}_{ba} cos β + {m}_{b} ( {b}_{0} sin α + {c}_{0} cos α ) sin β \} + ⟨ g [ \{ {m}_{sn} {z}_{6 n} cos ( α + {γ}_{n} + {η}_{n} ) + {m}_{aw1n} sin ( α + {γ}_{n} + {θ}_{n} ) + {m}_{sawcn} cos ( α + {γ}_{n} ) + {m}_{sawbn} sin α \} sin β + {m}_{sawan} cos β ] - {\dot{z}}_{0} \{ {\dot{z}}_{6 n} {m}_{sn} cos ( α + {γ}_{n} + {η}_{n} ) + ( \dot{α} + {\dot{θ}}_{n} ) {m}_{aw1n} cos ( α + {γ}_{n} + {θ}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α - \dot{β} {m}_{sawan} \} sin β + \dot{β} {\dot{z}}_{0} \{ {m}_{aw1n} sin ( α + {γ}_{n} + {θ}_{n} ) + {z}_{6 n} {m}_{sn} cos ( α + {γ}_{n} + {η}_{n} ) + {m}_{sawcn} cos ( α + {γ}_{n} ) + {m}_{sawbn} sin α \} cos β ⟩ \\ ( 67 ) \\ \frac{\partial L}{\partial α} = \{ {\dot{β}}^{2} {m}_{b} ( {b}_{0} cos α - {c}_{0} sin α ) + \dot{α} \dot{β} {m}_{ba} \} ( {b}_{0} sin α + {c}_{0} cos α ) - \dot{α} {\dot{z}}_{0} {m}_{b} cos β ( {b}_{0} sin α + {c}_{0} cos α ) - \dot{β} {\dot{z}}_{0} {m}_{b} ( {b}_{0} cos α - {c}_{0} sin α ) sin β + {\dot{\vert β}}^{2} ⟨ {m}_{sn} \{ {z}_{6 n} cos ( α + {γ}_{n} + {η}_{n} ) + {c}_{1 n} cos ( α + {γ}_{n} ) + {b}_{2 n} sin α \} \{ - {z}_{6 n} sin ( α + {γ}_{n} + {η}_{n} ) - {c}_{1 n} sin ( α + {γ}_{n} ) + {b}_{2 n} cos α \} + {m}_{an} \{ {e}_{1 n} sin ( α + {γ}_{n} + {θ}_{n} ) + {c}_{2 n} cos ( α + {γ}_{n} ) + {b}_{2 n} sin α \} \{ {e}_{1} cos ( α + {γ}_{n} + {θ}_{n} ) - {c}_{2 n} sin ( α + {γ}_{n} ) + {b}_{2 n} cos α \} + {m}_{wn} \{ {e}_{3 n} sin ( α + {γ}_{n} + {θ}_{n} ) + {c}_{2 n} cos ( α + {γ}_{n} ) + {b}_{2 n} sin α \} \{ {e}_{3} cos ( α + {γ}_{n} + {θ}_{n} ) - {c}_{2 n} sin ( α + {γ}_{n} ) + {b}_{2 n} cos α \} ⟩ + {\dot{z}}_{6 n} \dot{β} {m}_{sn} {a}_{1 n} sin ( α + {γ}_{n} + {η}_{n} ) + {\dot{η}}_{n} \dot{β} {m}_{sn} {z}_{6 n} {a}_{1 n} cos ( α + {γ}_{n} + {η}_{n} ) + \dot{θ} {\dot{β}}_{aw1n} {a}_{1 n} sin ( α + {γ}_{n} + {θ}_{n} ) + \dot{α} \dot{β} {a}_{1 n} \{ {m}_{sawcn} cos ( α + {γ}_{n} ) + {m}_{sawbn} sin α + {m}_{sn} {z}_{6 n} cos ( α + {γ}_{n} + {η}_{n} ) + {m}_{aw1n} sin ( α + {γ}_{n} + {θ}_{n} ) \} - {\dot{z}}_{0} ( {\dot{z}}_{6 n} {m}_{sn} sin ( α + {γ}_{n} + {η}_{n} ) + ( \dot{α} + {\dot{θ}}_{n} ) {m}_{aw1n} sin ( α + {γ}_{n} + {θ}_{n} ) + ( \dot{α} + {\dot{η}}_{n} ) {z}_{6 n} {m}_{sn} cos ( α + {γ}_{n} + {η}_{n} ) + \dot{α} {m}_{sawcn} cos ( α + {γ}_{n} ) + \dot{α} {m}_{sawbn} sin α \} cos β - \dot{β} {\dot{z}}_{0} [ \{ {m}_{aw1n} cos ( α + {γ}_{n} + {θ}_{n} ) - {z}_{6 n} {m}_{sn} sin ( α + {γ}_{n} + {η}_{n} ) - {m}_{sawcn} sin ( α + {γ}_{n} ) + {m}_{sawbn} cos α \} sin β \vert - {gm}_{b} ( {b}_{0} cos α - {c}_{0} sin α ) cos β + g \{ {m}_{sn} {z}_{6 n} sin ( α + {γ}_{n} + {η}_{n} ) - {m}_{aw1n} cos ( α + {γ}_{n} + {θ}_{n} ) + {m}_{sawcn} sin ( α + {γ}_{n} ) - {m}_{sawbn} cos α \} cos β \\ ( 68 ) \\ \frac{\partial L}{\partial {η}_{n}} = {\dot{α}}^{2} {m}_{sn} {z}_{6 n} \{ - {c}_{1 n} sin {η}_{n} - {b}_{2 n} cos ( {γ}_{n} + {η}_{n} ) \} + {\dot{β}}^{2} {m}_{sn} \{ {z}_{6 n} cos ( α + {γ}_{n} + {η}_{n} ) + {c}_{1 n} cos ( α + {γ}_{n} ) + {b}_{2 n} sin α \} \{ - {z}_{6 n} sin ( α + {γ}_{n} + {η}_{n} ) \} + {\dot{z}}_{6 n} \dot{α} {m}_{sn} \{ {c}_{1 n} cos {η}_{n} - {b}_{2 n} sin ( {γ}_{n} + {η}_{n} ) \} + {\dot{z}}_{6 n} \dot{β} {m}_{sn} {a}_{1 n} sin ( α + {γ}_{n} + {η}_{n} ) - {\dot{η}}_{n} \dot{α} {m}_{sn} {z}_{6 n} \{ {c}_{1 n} sin {η}_{n} + {b}_{2 n} cos ( {γ}_{n} + {η}_{n} ) \} + {\dot{η}}_{n} \dot{β} {m}_{sn} {z}_{6 n} {a}_{1 n} cos ( α + {γ}_{n} + {η}_{n} ) + \dot{α} \dot{β} {a}_{1 n} {m}_{sn} {z}_{6 n} cos ( α + {γ}_{n} + {η}_{n} ) + {gm}_{sn} {z}_{6 n} sin ( α + {γ}_{n} + {η}_{n} ) cos β - {\dot{z}}_{0} \{ {\dot{z}}_{6 n} {m}_{sn} sin ( α + {γ}_{n} + {η}_{n} ) + ( \dot{α} + {\dot{η}}_{n} ) {z}_{6 n} {m}_{sn} cos ( α + {γ}_{n} + {η}_{n} ) \} cos β + \dot{β} {\dot{z}}_{0} {z}_{6 n} {m}_{sn} sin ( α + {γ}_{n} + {η}_{n} ) sin β \\ ( 69 ) \\ \frac{\partial L}{\partial {θ}_{n}} = - {k}_{zi} {e}_{0 i}^{2} \{ sin ( {γ}_{i} + {θ}_{i} ) + sin ( {γ}_{ii} + {θ}_{ii} ) \} \{ cos ( {γ}_{i} + {θ}_{i} ) + cos ( {γ}_{ii} + {θ}_{ii} ) \} - {k}_{ziii} {e}_{0 iii}^{2} \{ sin ( {γ}_{iii} + {θ}_{iii} ) + sin ( {γ}_{iv} + {θ}_{iv} ) \} \{ cos ( {γ}_{iii} + {θ}_{iii} ) + cos ( {γ}_{iv} + {θ}_{iv} ) \} - {\dot{α}}^{2} {m}_{aw1n} \{ {c}_{2 n} cos {θ}_{n} + {b}_{2 n} sin ( {γ}_{n} + {θ}_{n} ) \} + {\dot{β}}^{2} ⟨ {m}_{an} \{ {e}_{1 n} sin ( α + {γ}_{n} + {θ}_{n} ) + {c}_{2 n} cos ( α + {γ}_{n} ) + {b}_{2 n} sin α \} {e}_{1 n} cos ( α + {γ}_{n} + {θ}_{n} ) + {m}_{wn} \{ {e}_{3 n} sin ( α + {γ}_{n} + {θ}_{n} ) + {c}_{2 n} cos ( α + {γ}_{n} ) + {b}_{2 n} sin α \} {e}_{3 n} cos ( α + {γ}_{n} + {θ}_{n} ) ⟩ - \dot{θ} \dot{α} {m}_{aw1n} \{ {c}_{2 n} cos {θ}_{n} + {b}_{2 n} sin ( {γ}_{n} + {θ}_{n} ) \} + \dot{θ} \dot{β} {m}_{aw1n} {a}_{1 n} sin ( α + {γ}_{n} + {θ}_{n} ) + \dot{α} \dot{β} {a}_{1 n} {m}_{aw1n} sin ( α + {γ}_{n} + {θ}_{n} ) - {gm}_{aw1n} cos ( α + {γ}_{n} + {θ}_{n} ) cos β - {\dot{z}}_{0} ( \dot{α} + {\dot{θ}}_{n} ) {m}_{aw1n} sin ( α + {γ}_{n} + {θ}_{n} ) cos β - \dot{β} {\dot{z}}_{0} {m}_{aw1n} cos ( α + {γ}_{n} + {θ}_{n} ) sin β \\ ( 70 ) \\ \frac{\partial L}{\partial {z}_{6 n}} = {m}_{sn} {\dot{η}}_{n}^{2} {z}_{6 n} + {\dot{α}}^{2} {m}_{sn} [ {z}_{6 n} + \{ {c}_{1 n} cos {η}_{n} - {b}_{2 n} sin ( {γ}_{n} + {η}_{n} ) \} ] + {\dot{β}}^{2} {m}_{sn} \{ {z}_{6 n} cos ( α + {γ}_{n} + {η}_{n} ) + {c}_{1 n} cos ( α + {γ}_{n} ) + {b}_{2 n} sin α \} cos ( α + {γ}_{n} + {η}_{n} ) + {\dot{η}}_{n} \dot{α} {m}_{sn} \{ 2 {z}_{6 n} + {c}_{1 n} cos {η}_{n} - {b}_{2 n} sin ( {γ}_{n} + {η}_{n} ) \} + {\dot{η}}_{n} \dot{β} {m}_{sn} {a}_{1 n} sin ( α + {γ}_{n} + {η}_{n} ) + \dot{α} \dot{β} {a}_{1 n} {m}_{sn} sin ( α + {γ}_{n} + {η}_{n} ) - {gm}_{sn} cos ( α + {γ}_{n} + {η}_{n} ) cos β - {k}_{sn} ( {z}_{6 n} - {l}_{sn} ) - ( \dot{α} + {\dot{η}}_{n} ) {\dot{z}}_{0} {m}_{sn} sin ( α + {γ}_{n} + {η}_{n} ) cos β - \dot{β} {\dot{z}}_{0} {m}_{sn} cos ( α + {γ}_{n} + {η}_{n} ) sin β \\ ( 71 ) \\ \frac{\partial L}{\partial {z}_{12 n}} = - {k}_{wn} ( {z}_{12 n} - {l}_{wn} ) \\ ( 72 ) \\ \frac{\partial L}{\partial \dot{β}} = \dot{β} ⟨ {m}_{saw2n} + {m}_{ba1} + {{m}_{b} ( {b}_{0} sin α + {c}_{0} cos α )}^{2} + {m}_{sn} {\{ {z}_{6 n} cos ( α + {γ}_{n} + {η}_{n} ) + {c}_{1 n} cos ( α + {γ}_{n} ) + {b}_{2 n} sin α \}}^{2} + {m}_{an} {\{ {e}_{1 n} sin ( α + {γ}_{n} + {θ}_{n} ) + {c}_{2 n} cos ( α + {γ}_{n} ) + {b}_{2 n} sin α \}}^{2} + {m}_{wn} {\{ {e}_{3 n} sin ( α + {γ}_{n} + {θ}_{n} ) + {c}_{2 n} cos ( α + {γ}_{n} ) + {b}_{2 n} sin α \}}^{2} ⟩ - \dot{α} {m}_{ba} ( {b}_{0} cos α - {c}_{0} sin α ) - {\dot{z}}_{6 n} {m}_{sn} {a}_{1 n} cos ( α + {γ}_{n} + {η}_{n} ) + {\dot{η}}_{n} {m}_{sn} {z}_{6 n} {a}_{1 n} sin ( α + {γ}_{n} + {η}_{n} ) - \dot{θ} {m}_{aw1n} {a}_{1 n} cos ( α + {γ}_{n} + {θ}_{n} ) + \dot{α} {a}_{1 n} \{ {m}_{sawcn} sin ( α + {γ}_{n} ) - {m}_{sawbn} cos α + {m}_{sn} {z}_{6 n} sin ( α + {γ}_{n} + {η}_{n} ) - {m}_{aw1n} cos ( α + {γ}_{n} + {θ}_{n} ) \} - {\dot{z}}_{0} [ \{ {m}_{b} {b}_{0} sin α + {c}_{0} cos α ) + {m}_{aw1n} sin ( α + {γ}_{n} + {η}_{n} ) + {z}_{6 n} {m}_{sn} cos ( α + {γ}_{n} + {η}_{n} ) + {m}_{sawcn} cos ( α + {γ}_{n} ) + {m}_{sawbn} sin α \} sin β + ( {m}_{ba} + {m}_{sawcn} ) cos β ]$$

$$( 73 )$$

$$\frac{ⅆ}{ⅆ t} ( \frac{\partial L}{\partial \dot{β}} ) = \ddot{β} ⟨ {m}_{saw2n} + {m}_{ba1} + {{m}_{b} ( {b}_{0} sin α + {c}_{0} cos α )}^{2} + {m}_{sn} {\{ {z}_{6 n} cos ( α + {γ}_{n} + {η}_{n} ) + {c}_{1 n} cos ( α + {γ}_{n} ) + {b}_{2 n} sin α \}}^{2} + {m}_{an} {\{ {e}_{1 n} sin ( α + {γ}_{n} + {θ}_{n} ) + {c}_{2 n} cos ( α + {γ}_{n} ) + {b}_{2 n} sin α \}}^{2} + {m}_{wn} {\{ {e}_{3 n} sin ( α + {γ}_{n} + {θ}_{n} ) + {c}_{2 n} cos ( α + {γ}_{n} ) + {b}_{2 n} sin α \}}^{2} ⟩ + 2 \dot{β} ⟨ \dot{α} {m}_{b} ( {b}_{0} sin α + {c}_{0} cos α ) ( {b}_{0} cos α - {c}_{0} sin α ) + {m}_{sn} \{ {z}_{6 n} cos ( α + {γ}_{n} + {η}_{n} ) + {c}_{1 n} cos ( α + {γ}_{n} ) + {b}_{2 n} sin α \} \{ {\dot{z}}_{6 n} cos ( α + {γ}_{n} + {η}_{n} ) - ( \dot{α} + {\dot{η}}_{n} ) {z}_{6 n} sin ( α + {γ}_{n} + {η}_{n} ) - \dot{α} [ {c}_{1 n} sin ( α + {γ}_{n} ) - {b}_{2 n} cos α ] \} + {m}_{an} \{ {e}_{1 n} sin ( α + {γ}_{n} + {θ}_{n} ) + {c}_{2 n} cos ( α + {γ}_{n} ) + {b}_{2 n} sin α \} \{ ( \dot{α} + {\dot{θ}}_{n} ) {e}_{1 n} cos ( α + {γ}_{n} + {θ}_{n} ) - \dot{α} [ {c}_{2 n} sin ( α + {γ}_{n} ) - {b}_{2 n} cos α ] \} + {m}_{wn} \{ {e}_{3 n} sin ( α + {γ}_{n} + {θ}_{n} ) + {c}_{2 n} cos ( α + {γ}_{n} ) + {b}_{2 n} sin α \} \{ ( \dot{α} + {\dot{θ}}_{n} ) {e}_{3 n} sin ( α + {γ}_{n} + {θ}_{n} ) - \dot{α} [ {c}_{2 n} sin ( α + {γ}_{n} ) - {b}_{2 n} cos α ] \} ⟩ - \ddot{α} {m}_{ba} ( {b}_{0} cos α - {c}_{0} sin α ) + {\dot{α}}^{2} {m}_{ba} ( {b}_{0} sin α + {c}_{0} cos α ) - {\ddot{z}}_{6 n} {m}_{sn} {a}_{1 n} cos ( α + {γ}_{n} + {η}_{n} ) + {\dot{z}}_{6 n} ( \dot{α} + {\dot{η}}_{n} ) {m}_{sn} {a}_{1 n} sin ( α + {γ}_{n} + {η}_{n} ) + {\ddot{η}}_{n} {m}_{sn} {z}_{6 n} {a}_{1 n} sin ( α + {γ}_{n} + {η}_{n} ) + {\dot{η}}_{n} {m}_{sn} {\dot{z}}_{6 n} {a}_{1 n} sin ( α + {γ}_{n} + {η}_{n} ) + {\dot{η}}_{n} ( \dot{α} + {\dot{η}}_{n} ) {m}_{sn} {z}_{6 n} {a}_{1 n} cos ( α + {γ}_{n} + {η}_{n} ) - {\ddot{θ}}_{n} {m}_{aw1n} {a}_{1 n} cos ( α + {γ}_{n} + {θ}_{n} ) + {\dot{θ}}_{n} ( \dot{α} + \dot{θ} ) {m}_{aw1n} {a}_{1 n} sin ( α + {γ}_{n} + {θ}_{n} ) + \ddot{α} {a}_{1 n} \{ {m}_{sawcn} sin ( α + {γ}_{n} ) - {m}_{sawbn} cos α + {m}_{sn} {z}_{6 n} sin ( α + {γ}_{n} + {η}_{n} ) - {m}_{aw1n} cos ( α + {γ}_{n} + {θ}_{n} ) \} + \dot{α} {a}_{1 n} \{ \dot{α} {m}_{sawcn} cos ( α + {γ}_{n} ) + \dot{α} {m}_{sawbn} sin α + ( \dot{α} + {\dot{η}}_{n} ) {m}_{sn} {z}_{6 n} cos ( α + {γ}_{n} + {η}_{n} ) + {m}_{sn} {\dot{z}}_{6 n} sin ( α + {γ}_{n} + {η}_{n} ) + ( \dot{α} + {\dot{θ}}_{n} ) {m}_{aw1n} sin ( α + {γ}_{n} + {θ}_{n} ) \} - {\ddot{z}}_{0} [ \{ {m}_{b} ( {b}_{0} sin α + {c}_{0} cos α ) + {m}_{aw1n} sin ( α + {γ}_{n} + {θ}_{n} ) + {z}_{6 n} {m}_{sn} cos ( α + {γ}_{n} + {η}_{n} ) + {m}_{sawcn} cos ( α + {γ}_{n} ) + {m}_{sawbn} sin α \} sin β + ( {m}_{ba} + {m}_{sawan} cos β ] - {\dot{z}}_{0} [ \{ \dot{α} {m}_{b} ( {b}_{0} cos α - {c}_{0} sin α ) + ( \dot{α} + {\dot{θ}}_{n} ) {m}_{aw1n} cos ( α + {γ}_{n} + {θ}_{n} ) + {\dot{z}}_{6 n} {m}_{sn} ( α + {γ}_{n} + {η}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α \} sin β + \dot{β} \{ {m}_{b} ( {b}_{0} sin α + {c}_{0} cos α ) + {m}_{aw1n} sin ( α + {γ}_{n} + {θ}_{n} ) + {z}_{6 n} {m}_{sn} cos ( α + {γ}_{n} + {η}_{n} ) + {m}_{sawcn} cos ( α + {γ}_{n} ) + {m}_{sawbn} sin α \} cos β - β ( {m}_{ba} + {m}_{sawan} ) sin β ] \\ ( 74 ) \\ \frac{\partial L}{\partial \dot{α}} = \dot{α} {m}_{bb1} - \dot{β} {m}_{ba} ( {b}_{0} cos α - {c}_{0} sin α ) + {\dot{z}}_{0} {m}_{b} cos β ( {b}_{0} cos α - {c}_{0} sin α ) + \dot{α} ⟨ {m}_{saw1n} + {m}_{sn} {z}_{6 n} [ {z}_{6 n} + 2 \{ {c}_{1 n} cos {η}_{n} - {b}_{2 n} sin ( {γ}_{n} + {η}_{n} ) \} ] - 2 {m}_{aw1n} \{ {c}_{2 n} sin {θ}_{n} - {b}_{2 n} cos ( {γ}_{n} + {θ}_{n} ) \} ⟩ + {\dot{z}}_{6 n} {m}_{sn} \{ {c}_{1 n} sin {η}_{n} + {b}_{2 n} cos ( {γ}_{n} + {η}_{n} ) \} + {\dot{η}}_{n} {m}_{sn} {z}_{6 n} \{ {z}_{6 n} + {c}_{1 n} cos {η}_{n} - {b}_{2 n} sin ( {γ}_{n} + {η}_{n} ) \} + \dot{θ} [ {m}_{aw21n} - {m}_{aw1n} \{ {c}_{2 n} sin {θ}_{n} - {b}_{2 n} cos ( {γ}_{n} + {θ}_{n} ) \} ] + \dot{β} {a}_{1 n} \{ {m}_{sawcn} sin ( α + {γ}_{n} ) - {m}_{sawbn} cos α + {m}_{sn} {z}_{6 n} sin ( α + {γ}_{n} + {η}_{n} ) - {m}_{aw1n} cos ( α + {γ}_{n} + {θ}_{n} ) \} + {\dot{z}}_{0} \{ {m}_{aw1n} cos ( α + {γ}_{n} + {θ}_{n} ) - {z}_{6 n} {m}_{sn} sin ( α + {γ}_{n} + {η}_{n} ) - {m}_{sawcn} sin ( α + {γ}_{n} ) + {m}_{sawbn} cos α \} cos β \\ ( 75 ) \\ \frac{ⅆ}{ⅆ t} ( \frac{\partial L}{\partial \dot{α}} ) = - \ddot{β} {m}_{ba} ( {b}_{0} cos α - {c}_{0} sin α ) + \dot{β} \dot{α} {m}_{ba} ( {b}_{0} sin α + {c}_{0} cos α ) + {\ddot{z}}_{0} {m}_{b} cos β ( {b}_{0} cos α - {c}_{0} sin α ) - \dot{β} {\dot{z}}_{0} {m}_{b} sin β ( {b}_{0} cos α - {c}_{0} sin α ) - \dot{α} {\dot{z}}_{0} {m}_{b} cos β ( {b}_{0} sin α + {c}_{0} cos α ) + \ddot{α} ⟨ {m}_{bb1} + {m}_{saw1n} + {m}_{sn} {z}_{6 n} [ {z}_{6 n} + 2 \{ {c}_{1 n} cos {η}_{n} - {b}_{2 n} sin ( {γ}_{n} + {η}_{n} ) \} ] - 2 {m}_{aw1n} \{ {c}_{2 n} sin {θ}_{n} - {b}_{2 n} cos ( {γ}_{n} + {θ}_{n} ) \} ⟩ + \dot{α} ⟨ {m}_{sn} {\dot{z}}_{6 n} [ {z}_{6 n} + 2 \{ {c}_{1 n} cos {η}_{n} - {b}_{2 n} sin ( {γ}_{n} + {η}_{n} ) \} ] + {m}_{sn} {z}_{6 n} [ {\dot{z}}_{6 n} - 2 {\dot{η}}_{n} \{ {c}_{1 n} sin {η}_{n} + {b}_{2 n} cos ( {γ}_{n} + {η}_{n} ) \} ] - 2 {\dot{θ}}_{n} {m}_{aw1n} \{ {c}_{2 n} cos {θ}_{n} + {b}_{2 n} sin ( {γ}_{n} + {θ}_{n} ) \} ⟩ + {\ddot{z}}_{6 n} {m}_{sn} \{ {c}_{1 n} sin {η}_{n} + {b}_{2 n} cos ( {γ}_{n} + {η}_{n} ) \} + {\dot{z}}_{6 n} {\dot{η}}_{n} {m}_{sn} \{ {c}_{1 n} cos {η}_{n} - {b}_{2 n} sin ( {γ}_{n} + {η}_{n} ) \} + {\ddot{η}}_{n} {m}_{sn} {z}_{6 n} \{ {z}_{6 n} + {c}_{1 n} cos {η}_{n} - {b}_{2 n} sin ( {γ}_{n} + {η}_{n} ) \} + {\dot{η}}_{n} {m}_{sn} {\dot{z}}_{6 n} \{ {z}_{6 n} + {c}_{1 n} cos {η}_{n} - {b}_{2 n} sin ( {γ}_{n} + {η}_{n} ) \} + {\dot{η}}_{n} {m}_{sn} {z}_{6 n} [ {\dot{z}}_{6 n} - {\dot{η}}_{n} [ {c}_{1 n} sin {η}_{n} + {b}_{2 n} cos ( {γ}_{n} + {η}_{n} ) ] \} + \ddot{θ} [ {m}_{aw21n} - {m}_{aw1n} \{ {c}_{2 n} sin {θ}_{n} - {b}_{2 n} cos ( {γ}_{n} + {θ}_{n} ) \} ] - {\dot{θ}}_{n}^{2} {m}_{aw1n} \{ {c}_{2 n} cos {θ}_{n} + {b}_{2 n} sin ( {γ}_{n} + {θ}_{n} ) \} ] + \ddot{β} {a}_{1 n} \{ {m}_{sawcn} sin ( α + {γ}_{n} ) - {m}_{sawbn} cos α + {m}_{sn} {z}_{6 n} sin ( α + {γ}_{n} + {η}_{n} ) - {m}_{aw1n} cos ( α + {γ}_{n} + {θ}_{n} ) \} + \dot{β} {a}_{1 n} \{ \dot{α} [ {m}_{sawcn} cos ( α + {γ}_{n} ) + {m}_{sawbn} sin α ] + {m}_{sn} {\dot{z}}_{6 n} sin ( α + {γ}_{n} + {η}_{n} ) + ( \dot{α} + {\dot{η}}_{n} ) {m}_{sn} {z}_{6 n} cos ( α + {γ}_{n} + {η}_{n} ) + ( \dot{α} + {\dot{θ}}_{n} ) {m}_{aw1n} sin ( α + {γ}_{n} + {θ}_{n} ) \} - {\ddot{z}}_{0} \{ {m}_{aw1n} cos ( α + {γ}_{n} + {θ}_{n} ) + {z}_{6 n} {m}_{sn} sin ( α + {γ}_{n} + {η}_{n} ) - {m}_{sawcn} sin ( α + {γ}_{n} ) + {m}_{sawbn} cos α \} cos β - {\dot{z}}_{0} \{ - ( \dot{α} + {\dot{θ}}_{n} ) {m}_{aw1n} sin ( α + {γ}_{n} + {θ}_{n} ) + {\dot{z}}_{6 n} {m}_{sn} sin ( α + {γ}_{n} + {η}_{n} ) - ( \dot{α} + {\dot{η}}_{n} ) {z}_{6 n} {m}_{sn} cos ( α + {γ}_{n} + {η}_{n} ) - \dot{α} {m}_{sawcn} cos ( α + {γ}_{n} ) - \dot{α} {m}_{sawbn} sin α \} cos β - \dot{β} {\dot{z}}_{0} \{ {m}_{aw1n} cos ( α + {γ}_{n} + {θ}_{n} ) - {z}_{6 n} {m}_{sn} sin ( α + {γ}_{n} + {η}_{n} ) - {m}_{sawcn} sin ( α + {γ}_{n} ) + {m}_{sawbn} cos α \} sin β \\ ( 76 ) \\ \frac{\partial L}{\partial {\dot{η}}_{n}} = {m}_{sn} {\dot{η}}_{n} {z}_{6 n}^{2} + \dot{α} {m}_{sn} {z}_{6 n} \{ {z}_{6 n} + {c}_{1 n} cos {η}_{n} - {b}_{2 n} sin ( {γ}_{n} + {η}_{n} ) \} + \dot{β} {m}_{sn} {z}_{6 n} {a}_{1 n} sin ( α + {γ}_{n} + {η}_{n} ) - {\dot{z}}_{0} {z}_{6 n} {m}_{sn} sin ( α + {γ}_{n} + {η}_{n} ) cos β \\ ( 77 ) \\ \frac{ⅆ}{ⅆ t} ( \frac{\partial L}{\partial {\dot{η}}_{n}} ) = {m}_{sn} {\ddot{η}}_{n} {z}_{6 n}^{2} + 2 {m}_{sn} {\dot{η}}_{n} {\dot{z}}_{6 n} {z}_{6 n} + \ddot{α} {m}_{sn} {z}_{6 n} \{ {z}_{6 n} + {c}_{1 n} cos {η}_{n} - {b}_{2 n} sin ( {γ}_{n} + {η}_{n} ) \} + \dot{α} {m}_{sn} {\dot{z}}_{6 n} \{ {z}_{6 n} + {c}_{1 n} cos {η}_{n} - {b}_{2 n} sin ( {γ}_{n} + {η}_{n} ) \} + \dot{α} {m}_{sn} {z}_{6 n} \{ {\dot{z}}_{6 n} - {\dot{η}}_{n} [ {c}_{1 n} sin {η}_{n} + {b}_{2 n} cos ( {γ}_{n} + {η}_{n} ) ] \} + \ddot{β} {m}_{sn} {z}_{6 n} {a}_{1 n} sin ( α + {γ}_{n} + {η}_{n} ) + \dot{β} {m}_{sn} {\dot{z}}_{6 n} {a}_{1 n} sin ( α + {γ}_{n} + {η}_{n} ) + \dot{β} ( \dot{α} + {\dot{η}}_{n} ) {m}_{sn} {z}_{6 n} {a}_{1 n} cos ( α + {γ}_{n} + {η}_{n} ) - {\ddot{z}}_{0} {z}_{6 n} {m}_{sn} sin ( α + {γ}_{n} + {η}_{n} ) cos β - {\dot{z}}_{0} {z}_{6 n} {m}_{sn} sin ( α + {γ}_{n} + {η}_{n} ) cos β - ( \dot{α} + {\dot{η}}_{n} ) {\dot{z}}_{0} {z}_{6 n} {m}_{sn} cos ( α + {γ}_{n} + {η}_{n} ) cos β - \dot{β} {\dot{z}}_{0} {z}_{6 n} {m}_{sn} sin ( α + {γ}_{n} + {η}_{n} ) cos β \\ ( 78 ) \\ \frac{\partial L}{\partial {\dot{θ}}_{n}} = {\dot{θ}}_{n} {m}_{aw21n} + \dot{α} [ {m}_{aw21n} - {m}_{aw1n} \{ {c}_{2 n} sin {θ}_{n} - {b}_{2 n} cos ( {γ}_{n} + {θ}_{n} ) \} ] - \dot{β} {m}_{aw1n} {a}_{1 n} cos ( α + {γ}_{n} + {θ}_{n} ) + {\dot{z}}_{0} {m}_{aw1n} cos ( α + {γ}_{n} + {θ}_{n} ) cos β \\ ( 79 ) \\ \frac{ⅆ}{ⅆ t} ( \frac{\partial L}{\partial {\dot{θ}}_{n}} ) = {\ddot{θ}}_{n} {m}_{aw21n} + \ddot{α} [ {m}_{aw21n} - {m}_{aw1n} \{ {c}_{2 n} sin {θ}_{n} - {b}_{2 n} cos ( {γ}_{n} + {θ}_{n} ) \} ] - \dot{α} {\dot{θ}}_{n} {m}_{aw1n} \{ {c}_{2 n} cos {θ}_{n} + {b}_{2 n} sin ( {γ}_{n} + {θ}_{n} ) \} - \ddot{β} {m}_{aw1n} {a}_{1 n} cos ( α + {γ}_{n} + {θ}_{n} ) + \dot{β} ( \dot{α} + {\dot{θ}}_{n} ) {m}_{aw1n} {a}_{1 n} sin ( α + {γ}_{n} + {θ}_{n} ) + {\ddot{z}}_{0} {m}_{aw1n} cos ( α + {γ}_{n} + {θ}_{n} ) cos β - ( \dot{α} + {\dot{θ}}_{n} ) {\dot{z}}_{0} {m}_{aw1n} sin ( α + {γ}_{n} + {θ}_{n} ) cos β - \dot{β} {\dot{z}}_{0} {m}_{aw1n} cos ( α + {γ}_{n} + {θ}_{n} ) sin β \\ ( 80 ) \\ \frac{\partial L}{\partial {\dot{z}}_{6 n}} = {m}_{sn} {\dot{z}}_{6 n} + \dot{α} {m}_{sn} \{ {c}_{1 n} sin {η}_{n} + {b}_{2 n} cos ( {γ}_{n} + {η}_{n} ) \} - \dot{β} {m}_{sn} {a}_{1 n} cos ( α + {γ}_{n} + {η}_{n} ) + {\dot{z}}_{0} {m}_{sn} cos ( α + {γ}_{n} + {η}_{n} ) cos β \\ ( 81 ) \\ \frac{ⅆ}{ⅆ t} ( \frac{\partial L}{\partial {\dot{z}}_{6 n}} ) = {m}_{sn} {\ddot{z}}_{6 n} + \ddot{α} {m}_{sn} \{ {c}_{1 n} sin {η}_{n} + {b}_{2 n} cos ( {γ}_{n} + {η}_{n} ) \} + \dot{α} {\dot{η}}_{n} {m}_{sn} \{ {c}_{1 n} cos {η}_{n} - {b}_{2 n} sin ( {γ}_{n} + {η}_{n} ) \} - \ddot{β} {m}_{sn} {a}_{1 n} cos ( α + {γ}_{n} + {η}_{n} ) + \dot{β} ( \dot{α} + {\dot{η}}_{n} ) {m}_{sn} {a}_{1 n} sin ( α + {γ}_{n} + {η}_{n} ) + {\ddot{z}}_{0} {m}_{sn} cos ( α + {γ}_{n} + {η}_{n} ) cos β - ( \dot{α} + {\dot{η}}_{n} ) {\dot{z}}_{0} {m}_{sn} sin ( α + {γ}_{n} + {η}_{n} ) cos β - \dot{β} {\dot{z}}_{0} {m}_{sn} cos ( α + {γ}_{n} + {η}_{n} ) sin β \\ ( 82 ) \\ \frac{\partial L}{\partial {\dot{z}}_{12 n}} = 0 \\ ( 83 ) \\ \frac{ⅆ}{ⅆ t} ( \frac{\partial L}{\partial {\dot{z}}_{12 n}} ) = 0$$

The dissipative function is:

$${F}_{tot} = - \frac{1}{2} ( {c}_{sn} {\dot{z}}_{6 n}^{2} + {c}_{wn} {\dot{z}}_{12 n}^{2} ) \qquad ( 84 )$$

The constraints are based on geometrical constraints, and the touch point of the road and the wheel. The geometrical constraint is expressed as

e₂ₙ cos θₙ=−(z₆ₙ−d₁ₙ) sin ηₙ

e₂ₙ sin θₙ−(z₆ₙ−d₁ₙ) cos ηₙ=c₁ₙ−c₂ₙ (85)

The touch point of the road and the wheel is defined as

$${z}_{tn} = {z}_{{P}_{touchpoint \cdot n}^{r}} \\ = {z}_{0} + \{ {z}_{12 n} cos α + {e}_{3 n} sin ( α + {γ}_{n} + {θ}_{n} ) + {c}_{2 n} cos ( α + {γ}_{n} ) \\ + {b}_{2 n} sin α \} cos β - {a}_{1 n} sin β \\ = {R}_{n} ( t ) \qquad ( 86 )$$

where Rₙ(t) is road input at each wheel.

Differentials are:

\dot{θ}ₙe₂ sin θₙ−\dot{z}₆ₙ sin \dot{η}ₙ−ηₙ(z₆ₙ−d₁ₙ) cos ηₙ=0

\dot{θ}ₙe₂ₙ cos θₙ−\dot{z}₆ₙ cos ηₙ+\dot{η}ₙ(z₆ₙ−d₁ₙ) sin ηₙ=0

\dot{z}₀={\dot{z}₁₂ₙ cos α−\dot{α}z₁₂ₙ sin α+(\dot{α}+\dot{θ}ₙ)e₃ₙ cos (α+γₙ+θₙ)

−\dot{α}c₂ₙ sin (α+γₙ)+\dot{α}b₂ₙ cos α{ cos β

−β[{z₁₂ₙ cos α+e₃ₙ sin (α+γₙ+θₙ)

+c₂ₙ cos (α+γₙ)+b₂ₙ sin α} sin β+a₁ₙ cos β]−\dot{R}ₙ(t)=0 (87)

Since the differentials of these constraints are written as

$${\sum }_{j} {a}_{lnj} ⅆ {\dot{q}}_{j} + {a}_{lnt} ⅆ t = 0 ( l = 1 , 2 , 3 n = i , ii , iii , iv ) \qquad ( 88 )$$

then the values a₁ₙⱼ are obtained as follows.

a₁ₙ₀=0

a₂ₙ₀=0

a₃ₙ₀=1

a=1n10, a₁ₙ₂=0, a₁ₙ₃=−(z₆ₙ−d₁ₙ) cos ηₙ, a₁ₙ₄=e₂ₙ sin θₙ, a₁ₙ₅=−sin ηₙ, a₁ₙ₆=0

a₂ₙ₁=0, a₂ₙ₂=0, a₂ₙ₃=(z₆ₙ−d₁ₙ) sin ηₙ, a₂ₙ₄=e₂ₙ cos θₙ, a₂ₙ₅=−cos θₙ, a₂ₙ₆=0

a₃ₙ₁=−{z₁₂ₙ cos α+e₃ₙ sin (α+γₙ+θₙ)+c₂ₙ cos (α+γₙ)+b₂ₙ sin α} sin β+a₁ₙ cos β,

a₃ₙ₂={−z₁₂ₙ sin α+e₃ₙ cos (α+γₙ+θₙ)−c₂ₙ sin (α+γₙ)+b₂ₙ cos α} cos β,

a₃ₙ₃=0, a₃ₙ₄=e₃ₙ cos (α+γₙ=θₙ) cos β, a₃ₙ₅=0, a₃ₙ₆=cos α cos β (89)

From the above, Lagrange's equation becomes

$$\begin{matrix} \frac{ⅆ}{ⅆ t} ( \frac{\partial L}{\partial {\dot{q}}_{j}} ) - \frac{\partial L}{\partial {q}_{j}} = {Q}_{j} + {\sum }_{l , n} {λ}_{l n} {a}_{l nj} \\ where \\ {q}_{0} = {z}_{0} & ( 90 ) \\ \begin{matrix}\begin{matrix}{q}_{1} = β , & {q}_{2} = α , & {q}_{3 i} = {η}_{i} , & {q}_{4 i} = {θ}_{i} , & {q}_{5 i} = {z}_{6 i} , & {q}_{6 i} = {z}_{12 i} \\ & & {q}_{3 ii} = {η}_{ii} , & {q}_{4 ii} = {θ}_{ii} , & {q}_{5 ii} = {z}_{6 ii} , & {q}_{6 ii} = {z}_{12 ii} \\ & & {q}_{3 iii} = {η}_{iii} , & {q}_{4 iii} = {θ}_{iii} , & {q}_{5 iii} = {z}_{6 iii} , & {q}_{6 iii} = {z}_{12 iii} \\ & & {q}_{3 iv} = {η}_{iv} , & {q}_{4 iv} = {θ}_{iv} , & {q}_{5 iv} = {z}_{6 iv} , & {q}_{6 iv} = {z}_{12 iv}\end{matrix} \\ \frac{ⅆ}{ⅆ t} ( \frac{\partial L}{\partial {\dot{z}}_{θ}} ) - \frac{\partial L}{\partial {z}_{θ}} = \frac{\partial F}{\partial {\dot{z}}_{0}} + {\sum }_{l , n} {λ}_{l n} {a}_{l n0} l = 1 , 2 , 3 n = i , ii , iii , iv\end{matrix} & ( 91 ) \\ {\ddot{z}}_{0} ( {m}_{b} + {m}_{sawn} ) + \ddot{α} {m}_{b} cos β ( {b}_{0} cos α - {c}_{0} sin α ) - \dot{β} \dot{α} {m}_{b} sin β ( {b}_{0} cos α - {c}_{0} sin α ) - {\dot{α}}^{2} {m}_{b} cos β ( {b}_{0} sin α - {c}_{0} cos α ) - \ddot{β} \{ {m}_{ba} cos β + {m}_{b} ( {b}_{0} sin α - {c}_{0} cos α ) sin β \} + \dot{β} \{ \dot{β} {m}_{ba} sin β + \dot{a} {m}_{b} ( {b}_{0} cos α - {c}_{0} sin α ) sin β + \dot{β} {m}_{b} ( {b}_{0} sin α - {c}_{0} cos α ) - cos β \} + \{ {z}_{6 n} {m}_{sn} cos ( α + {γ}_{n} + {η}_{n} ) - ( \dot{α} + {\dot{η}}_{n} ) {\dot{z}}_{6 n} {m}_{sn} sin ( α + {γ}_{n} + {η}_{n} ) + ( \ddot{α} + {\ddot{θ}}_{n} ) {m}_{awln} cos ( α + {γ}_{n} + {θ}_{n} ) - {( \dot{α} + {\dot{θ}}_{n} )}^{2} {m}_{awln} sin ( α + {γ}_{n} + {θ}_{n} ) + ( \ddot{α} + {\ddot{θ}}_{n} ) {z}_{6 n} {m}_{sn} sin ( α + {γ}_{n} + {η}_{n} ) - {( \dot{α} + {\dot{η}}_{n} )}^{2} {z}_{6 n} {m}_{sn} & \\ sin ( α + {γ}_{n} + {η}_{n} ) + {( \dot{α} + {\dot{θ}}_{n} )}^{2} {z}_{6 n} {m}_{sn} cos ( α + {γ}_{n} + {η}_{n} ) - \ddot{α} {m}_{sawcn} sin ( α + {γ}_{n} ) - {\dot{α}}^{2} {m}_{sawcn} cos ( α + {γ}_{n} ) + \ddot{α} {m}_{sawbn} cos α - {\dot{α}}^{2} {m}_{sawbn} sin α - \ddot{β} {m}_{sawan} \} cos β - \dot{β} \{ {\dot{z}}_{6 n} {m}_{sn} cos ( α + {γ}_{n} + {η}_{n} ) + ( \dot{α} + {\dot{θ}}_{n} ) {m}_{awln} cos ( α + {γ}_{n} + {θ}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α - \dot{β} {m}_{sawan} \} sin β - & \\ \ddot{β} \{ {m}_{awln} sin ( α + {γ}_{n} + {θ}_{n} ) - {z}_{6 n} {m}_{sn} cos ( α + {γ}_{n} + {η}_{n} ) + {m}_{sawcn} cos ( α + {γ}_{n} ) + {m}_{sawbn} sin α \} sin β - \dot{β} \{ ( \dot{α} + {\dot{θ}}_{n} ) {m}_{awln} cos ( α + {γ}_{n} + {θ}_{n} ) - {\dot{z}}_{6 n} {m}_{sn} cos ( α + {γ}_{n} + {η}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α \} sin β - {\dot{β}}^{2} \{ {m}_{awln} sin ( α + {γ}_{n} + {θ}_{n} ) + {z}_{6 n} {m}_{sn} cos ( α + {γ}_{n} + {η}_{n} ) + {m}_{sawcn} cos ( α + {γ}_{n} ) + {m}_{sawbn} sin α \} cos β + g ( {m}_{b} + {m}_{sawn} ) = {λ}_{3 n} & \\ {\ddot{z}}_{0} ( {m}_{b} + {m}_{sawn} ) + \ddot{α} {m}_{b} cos β ( {b}_{0} cos α - {c}_{0} sin α ) - {\dot{α}}^{2} {m}_{b} cos β ( {b}_{0} sin α - {c}_{0} cos α ) - \ddot{β} \{ {m}_{ba} cos β + {m}_{b} ( {b}_{0} sin α - {c}_{0} cos α ) sin β \} + \dot{β} \{ \dot{β} ( {m}_{ba} + {m}_{sawan} ) sin β + \dot{β} {m}_{b} ( {b}_{0} sin α - {c}_{0} cos α ) cos β \} + \{ {\ddot{z}}_{6 n} {m}_{sn} cos ( α + {γ}_{n} + {η}_{n} ) - 2 ( \dot{α} + {\dot{η}}_{n} ) {\dot{z}}_{6 n} {m}_{sn} sin ( α + {γ}_{n} + {η}_{n} ) + & \\ ( \ddot{α} + {\ddot{θ}}_{n} ) {m}_{aw1n} cos ( α + {γ}_{n} + {θ}_{n} ) - {( \dot{α} + {\dot{θ}}_{n} )}^{2} {m}_{aw1n} sin ( α + {γ}_{n} + {θ}_{n} ) - ( \ddot{α} + {\ddot{θ}}_{n} ) {z}_{6 n} {m}_{sn} sin ( α + {γ}_{n} + {η}_{n} ) - {( \dot{α} + {\dot{θ}}_{n} )}^{2} {z}_{6 n} {m}_{sn} cos ( α + {γ}_{n} + {η}_{n} ) - \ddot{α} {m}_{sawcn} sin ( α + {γ}_{n} ) - {\dot{α}}^{2} {m}_{sawcn} cos ( α + {γ}_{n} ) + \ddot{α} {m}_{sawbn} cos α - {\dot{α}}^{2} {m}_{sawbn} sin α - \ddot{β} {m}_{sawan} \} cos β - 2 \dot{β} \{ {\dot{z}}_{6 n} {m}_{sn} cos ( α + {γ}_{n} + {η}_{n} ) + ( \dot{α} + {\dot{θ}}_{n} ) {m}_{aw1n} cos ( α + {γ}_{n} + {θ}_{n} ) - & \\ ( \dot{α} + {η}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α \} sin β - ( \ddot{β} sin β + {\dot{β}}^{2} cos β ) \{ {m}_{aw1n} sin ( α + {γ}_{n} + {θ}_{n} ) + {z}_{6 n} {m}_{sn} cos ( α + {γ}_{n} + {η}_{n} ) + {m}_{sawcn} cos ( α + {γ}_{n} ) + {m}_{sawbn} sin α \} + g ( {m}_{b} + {m}_{sawn} ) = {λ}_{3 n} & \\ {\ddot{z}}_{0} = {λ}_{3 n} - g - \frac{\begin{matrix}\ddot{α} {m}_{b} {C}_{β} {A}_{2} - {\dot{α}}^{2} {m}_{b} {A}_{1} - \ddot{β} \{ {m}_{ba} {C}_{β} + {m}_{b} {A}_{1} {S}_{β} \} + \\ \dot{β} \{ {m}_{ba} {S}_{β} + \dot{β} {m}_{b} {A}_{1} {C}_{β} \} + \{ {\ddot{z}}_{6 n} {m}_{sn} {C}_{α γ η} - \\ 2 ( \dot{α} + {\dot{η}}_{n} ) {\dot{z}}_{6 n} {m}_{sn} {S}_{αγη} + ( \ddot{α} + {\ddot{θ}}_{n} ) {m}_{aw1n} {C}_{αγη} - \\ {( \dot{α} + {\dot{θ}}_{n} )}^{2} {m}_{aw1n} {S}_{αγη} - ( \ddot{α} + {\ddot{η}}_{n} ) {z}_{6 n} {m}_{sn} {S}_{αγη} - \\ {( \dot{α} + {\dot{η}}_{n} )}^{2} {z}_{6 n} {m}_{sn} {C}_{αγη} - \ddot{α} {m}_{sawcn} {S}_{αγη} - {\dot{α}}^{2} {m}_{sawcn} {C}_{αγη} + \\ \ddot{α} {m}_{sawcn} {C}_{α} - {\dot{α}}^{2} {m}_{sawbn} {S}_{α} - \\ \ddot{β} {m}_{sawan} \} {C}_{β} - 2 \dot{β} \{ {\dot{z}}_{6 n} {m}_{sn} {C}_{αγη} + \\ ( \dot{α} + {\dot{θ}}_{n} ) {m}_{aw1n} {C}_{αγη} - ( \dot{α} + {\dot{η}}_{n} ) {z}_{6 n} {m}_{sn} {S}_{αγη} - \\ \dot{α} {m}_{sawcn} {S}_{αγη} + \dot{α} {m}_{sawbn} {C}_{α} - \dot{β} {m}_{sawan} / 2 \} S β - \\ \begin{matrix}( \ddot{β} {S}_{β} + {\dot{β}}^{2} {C}_{β} ) \{ {m}_{aw1n} {S}_{αγη} + {z}_{6 n} {m}_{sn} {C}_{αγη} + \\ {m}_{sawcn} {C}_{αγη} + {m}_{sawbn} {S}_{α} \}\end{matrix}\end{matrix}}{{m}_{bsawn}} & \\ \frac{ⅆ}{ⅆ t} ( \frac{\partial L}{\partial \dot{β}} ) - \frac{\partial L}{\partial β} = \frac{\partial F}{\partial \dot{β}} + {\sum }_{l , n} {λ}_{ln} {a}_{ln1} l = 1 , 2 , 3 n = i , ii , iii , iv & ( 92 ) \\ \ddot{β} ⟨ {m}_{saw2n} + {m}_{ba1} + {{m}_{b} ( {b}_{0} sin α + {c}_{0} cos α )}^{2} + {m}_{sn} {\{ {z}_{6 n} cos ( α + {γ}_{n} + {η}_{n} ) + {c}_{1 n} cos ( α + {γ}_{n} ) + {b}_{2 n} sin α \}}^{2} + {m}_{an} {\{ {e}_{1 n} sin ( α + {γ}_{n} + {θ}_{n} ) + {c}_{2 n} cos ( α + {γ}_{n} ) + {b}_{2 n} sin α \}}^{2} + {m}_{wn} {\{ {e}_{3 n} sin ( α + {γ}_{n} + {θ}_{n} ) + {c}_{2 n} cos ( α + {γ}_{n} ) + {b}_{2 n} sin α \}}^{2} ⟩ + 2 \dot{β} ⟨ \dot{α} {m}_{b} ( {b}_{0} sin α + {c}_{0} cos α ) ( {b}_{0} cos α - {c}_{0} sin α ) + {m}_{sn} \{ {z}_{6 n} cos ( α + {γ}_{n} + {η}_{n} ) + {c}_{1 n} cos ( α + {γ}_{n} ) + & ( 93 ) \\ {b}_{2 n} sin α \} \{ {\dot{z}}_{6 n} cos ( α + {γ}_{n} + {η}_{n} ) - ( \dot{α} + {\dot{η}}_{n} ) {z}_{6 n} sin ( α + {γ}_{n} + {η}_{n} ) - \dot{α} [ {c}_{1 n} sin ( α + {γ}_{n} ) - {b}_{2 n} cos α ] \} + {m}_{an} \{ {e}_{1 n} sin ( α + {γ}_{n} + {θ}_{n} ) + {c}_{2 n} cos ( α + {γ}_{n} ) + {b}_{2 n} sin α \} \{ ( \dot{α} + {\dot{θ}}_{n} ) {e}_{1 n} cos ( α + {γ}_{n} + {θ}_{n} ) - \dot{α} [ {c}_{2 n} sin ( α + {γ}_{n} ) - {b}_{2 n} cos α ] \} + {m}_{wn} \{ {e}_{3 n} sin ( α + {γ}_{n} + {θ}_{n} ) + {c}_{2 n} cos ( α + {γ}_{n} ) + {b}_{2 n} sin α \} \{ ( \dot{α} + {\dot{θ}}_{n} ) {e}_{3 n} sin ( α + {γ}_{n} + {θ}_{n} ) - \dot{α} [ {c}_{2 n} sin ( α + {γ}_{n} ) - {b}_{2 n} cos α ] \} ⟩ - & \\ \ddot{α} {m}_{ba} ( {b}_{0} cos α - {c}_{0} sin α ) + {\dot{α}}^{2} {m}_{ba} ( {b}_{0} sin α + {c}_{0} cos α ) - {\ddot{z}}_{6 n} {m}_{sn} {a}_{1 n} cos ( α + {γ}_{n} + {η}_{n} ) + {\dot{z}}_{6 n} ( \dot{α} + {\dot{η}}_{n} ) {m}_{sn} {a}_{1 n} sin ( α + {γ}_{n} + {η}_{n} ) + {\ddot{η}}_{n} {m}_{sn} {z}_{6 n} {a}_{1 n} sin ( α + {γ}_{n} + {η}_{n} ) + {\dot{η}}_{n} {m}_{sn} {\dot{z}}_{6 n} {a}_{1 n} sin ( α + {γ}_{n} + {η}_{n} ) + {\dot{η}}_{n} ( \dot{α} + {\dot{η}}_{n} ) {m}_{sn} {z}_{6 n} {a}_{1 n} cos ( α + {γ}_{n} + {η}_{n} ) - {\ddot{θ}}_{n} {m}_{aw1n} {a}_{1 n} cos ( α + {γ}_{n} + {θ}_{n} ) + {\dot{θ}}_{n} ( \dot{α} + {\dot{θ}}_{n} ) {m}_{aw1n} {a}_{1 n} sin ( α + {γ}_{n} + {θ}_{n} ) + \ddot{α} {a}_{1 n} \{ {m}_{sawcn} sin ( α + {γ}_{n} ) - {m}_{sawbn} cos α + & \\ {m}_{sn} {z}_{6 n} sin ( α + {γ}_{n} + {η}_{n} ) - {m}_{aw1n} cos ( α + {γ}_{n} + {θ}_{n} ) \} + \dot{α} {a}_{1 n} \{ \dot{α} {m}_{sawcn} cos ( α + {γ}_{n} ) + \dot{α} {m}_{sawbn} sin α + ( \dot{α} + {\dot{η}}_{n} ) {m}_{sn} {z}_{6 n} cos ( α + {γ}_{n} + {η}_{n} ) + {m}_{sn} {\dot{z}}_{6 n} sin ( α + {γ}_{n} + {η}_{n} ) + ( \dot{α} + {\dot{θ}}_{n} ) {m}_{aw1n} sin ( α + {γ}_{n} + {θ}_{n} ) \} - {\ddot{z}}_{0} [ \{ {m}_{b} ( {b}_{0} sin α + {c}_{0} cos α ) + {m}_{aw1n} sin ( α + {γ}_{n} + {θ}_{n} ) + {z}_{6 n} {m}_{sn} cos ( α + {γ}_{n} + {η}_{n} ) + {m}_{sawcn} cos ( α + γ ) + {m}_{sawbn} sin α \} sin β + ( {m}_{ba} + {m}_{sawan} cos β ) ] - {\dot{z}}_{0} [ \{ \dot{α} {m}_{b} ( {b}_{0} cos α - {c}_{0} sin α ) + & \\ ( \dot{α} + {\dot{θ}}_{n} ) {m}_{aw1n} cos ( α + {γ}_{n} + {θ}_{n} ) + {\dot{z}}_{6 n} {m}_{sn} cos ( α + {γ}_{n} + {η}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α \} sin β + \dot{β} {\dot{z}}_{0} \{ {m}_{b} ( {b}_{0} sin α + {c}_{0} cos α ) + {m}_{aw1n} sin ( α + {γ}_{n} + {θ}_{n} ) + {z}_{6 n} {m}_{sn} cos ( α + {γ}_{n} + {η}_{n} ) + {m}_{sawcn} cos ( α + {γ}_{n} ) + {m}_{sawbn} sin α \} cos β - ( {m}_{ba} + {m}_{sawan} sin β ) ] + & \\ \dot{ α} {\dot{z}}_{0} {m}_{b} sin β ( {b}_{0} cos α - {c}_{0} sin α ) - \dot{β} {\dot{z}}_{0} \{ {m}_{ba} sin β - {m}_{b} ( {b}_{0} sin α + {c}_{0} cos α ) cos β \} - g \{ {m}_{ba} cos β + {m}_{b} ( {b}_{0} sin α + {c}_{0} cos α ) sin β \} - ⟨ g [ \{ {m}_{sn} {z}_{6 n} cos ( α + {γ}_{n} + {η}_{n} ) + {m}_{aw1n} sin ( α + {γ}_{n} + {θ}_{n} ) + {m}_{sawcn} cos ( α + {γ}_{n} ) + {m}_{sawbn} sin α \} sin β + {m}_{sawan} cos β ] - {\dot{z}}_{0} \{ {\dot{z}}_{6 n} {m}_{sn} cos ( α + {γ}_{n} + {η}_{n} ) + & \\ ( \dot{α} + {\dot{θ}}_{n} ) {m}_{aw1n} cos ( α + {γ}_{n} + {θ}_{n} ) - ( \dot{α} + {\dot{η}}_{n} ) {z}_{6 n} {m}_{sn} sin ( α + {γ}_{n} + {η}_{n} ) - \dot{α} {m}_{sawcn} sin ( α + {γ}_{n} ) + \dot{α} {m}_{sawbn} cos α - \dot{β} {m}_{sawan} \} sin β \} - \dot{β} {\dot{z}}_{0} \{ {m}_{aw1n} sin ( α + {γ}_{n} + {θ}_{n} ) + {z}_{6 n} {m}_{sn} cos ( α + {γ}_{n} + {η}_{n} ) + {m}_{sawcn} cos ( α + {γ}_{n} ) + {m}_{sawbn} sin α \} cos β ⟩ = {λ}_{3 n} [ - \{ {z}_{12 n} cos α + {e}_{3 n} sin ( α + {γ}_{n} + {θ}_{n} ) + {c}_{2 n} cos ( α + {γ}_{n} ) + {b}_{2 n} sin α \} sin β + {a}_{1 n} cos β ] & \\ \ddot{β} ( {m}_{saw2n} + {m}_{ba1} + {m}_{b} {A}_{1}^{2} + {m}_{sn} {B}_{1}^{2} + {m}_{an} {B}_{2}^{2} + {m}_{wn} {B}_{3}^{2} ) + 2 \dot{β} [ \dot{α} {m}_{b} {A}_{1} {A}_{2} + {m}_{sn} {B}_{1} \{ {\dot{z}}_{6 n} {C}_{αγη n} - ( \dot{α} + {\dot{η}}_{n} ) {z}_{6 n} {S}_{αγη n} - \dot{α} {A}_{4} \} + {m}_{an} {B}_{2} \{ ( \dot{α} + {\dot{θ}}_{n} ) {e}_{1 n} {C}_{αγθ n} - \dot{α} {A}_{6} \} + {m}_{wn} {B}_{3} \{ ( \dot{α} + {\dot{θ}}_{n} ) {e}_{3 n} {S}_{αγθ n} - \dot{α} {A}_{6} \} ] - \ddot{α} {m}_{ba} {A}_{2} + {\dot{α}}^{2} {m}_{ba} {A}_{1} - {\ddot{z}}_{6 n} {m}_{sn} {a}_{1 n} {C}_{αγη n} + 2 {\dot{z}}_{6 n} ( \dot{α} + {\dot{η}}_{n} ) {m}_{sn} {a}_{1 n} {S}_{αγη n} + {\ddot{η}}_{n} {m}_{sn} {z}_{6 n} {a}_{1 n} {S}_{αγη h} + {\dot{η}}_{n} ( 2 \dot{α} + {\dot{η}}_{n} ) {m}_{sn} {z}_{6 n} {a}_{1 n} {C}_{αγη n} - {\ddot{θ}}_{n} {m}_{aw1n} {a}_{1 n} {C}_{αγθ n} + {\dot{θ}}_{n} ( 2 \dot{α} + {\dot{θ}}_{n} ) {m}_{aw1n} {a}_{1 n} {S}_{αγ θ n} + & ( 94 ) \\ \ddot{α} {a}_{1 n} \{ {m}_{sawcn} {S}_{αγ n} - {m}_{sawbn} {C}_{α} + {m}_{sn} {z}_{6 n} {S}_{αγη n} - {m}_{aw1n} {C}_{αγ θ n} \} + {\dot{α}}^{2} {a}_{1 n} \{ {m}_{sawcn} {C}_{αγ n} + {m}_{sawbn} {S}_{α} + {m}_{sn} {z}_{6 n} {C}_{αγ η n} + {m}_{aw1n} {S}_{αγθ n} \} - {\ddot{z}}_{0} [ \{ {m}_{b} ( {b}_{0} {S}_{α} + {c}_{0} {C}_{α} ) + {m}_{aw1n} {S}_{αγ η n} + {z}_{6 n} {m}_{sn} {C}_{αγ η n} + {m}_{sawcn} {C}_{αγ n} + {m}_{sawbn} {S}_{α} \} {S}_{β} + ( {m}_{ba} + {m}_{sawan} ) {C}_{β} ] + {\dot{z}}_{0} ( 1 - \dot{β} ) ( {m}_{ba} + {m}_{sawan} ) sin β - g [ {m}_{ba} {C}_{β} + {m}_{b} {A}_{1} {S}_{β} + \{ {m}_{sn} {z}_{6 n} {C}_{αγη n} + {m}_{aw1n} {S}_{αγθ n} + {m}_{sawcn} {C}_{αγ n} + {m}_{sawbn} {S}_{α} \} {S}_{β} + {m}_{sawan} {C}_{β} ] = {λ}_{3 n} [ - \{ {z}_{12 n} {C}_{α} + {e}_{3 n} {S}_{αγθ n} + {c}_{2 n} {C}_{αγ n} + {b}_{2 n} {S}_{α} \} {S}_{β} + {a}_{1 n} {C}_{β} ] & \\ \ddot{β} = \frac{\begin{matrix}2 \dot{β} [ \dot{α} {m}_{b} {A}_{1} {A}_{2} + {m}_{sn} {B}_{1} \{ {\dot{z}}_{6 n} {C}_{αγ η n} - ( \dot{α} + {\dot{η}}_{n} ) {z}_{6 n} {S}_{αγη n} - \\ \dot{α} {A}_{4} \} + {m}_{an} {B}_{2} \{ ( \dot{α} + {\dot{θ}}_{n} ) {e}_{1 n} {C}_{αγ θ n} - \dot{α} {A}_{6} \} + \\ {m}_{wn} {B}_{3} \{ ( \dot{α} + {\dot{θ}}_{n} ) {e}_{3 n} {S}_{αγ θ n} - \dot{α} {A}_{6} \} ] - \ddot{α} {m}_{ba} {A}_{2} + \\ {\dot{α}}^{2} {m}_{ba} {A}_{1} - {\ddot{z}}_{6 n} {m}_{sn} {a}_{1 n} {C}_{αγ η n} + 2 {\dot{z}}_{6 n} ( \dot{α} + {\dot{η}}_{n} ) {m}_{sn} {a}_{1 n} {S}_{αγ η n} + \\ {\ddot{η}}_{n} {m}_{sn} {z}_{6 n} {a}_{1 n} {S}_{αγ η n} + {\dot{η}}_{n} ( 2 \dot{α} + {\dot{η}}_{n} ) {m}_{sn} {z}_{6 n} {a}_{1 n} {C}_{αγη n} - \\ {\ddot{θ}}_{n} {m}_{aw1n} {a}_{1 n} {C}_{αγθ n} + {\dot{θ}}_{n} ( 2 \dot{α} + {\dot{θ}}_{n} ) {m}_{aw1n} {a}_{1 n} {S}_{αγθ n} + \\ \ddot{α} {a}_{1 n} \{ {m}_{sawcn} {S}_{αγ n} - {m}_{sawbn} {C}_{α} + {m}_{sn} {z}_{6 n} {S}_{αγη n} - {m}_{aw1n} {C}_{αγθ n} \} + \\ {\dot{α}}^{2} {a}_{1 n} \{ {m}_{sawcn} {C}_{αγ n} + {m}_{sawbn} {S}_{α} + {m}_{sn} {z}_{6 n} {C}_{αγ η n} + {m}_{aw1n} {S}_{αγθ n} \} - \\ {\ddot{z}}_{0} [ \{ {m}_{b} ( {b}_{0} {S}_{α} + {c}_{0} {C}_{α} ) + {m}_{aw1n} {S}_{αγη n} + {z}_{6 n} {m}_{sn} {C}_{αγη n} + \\ {m}_{sawcn} {C}_{αγ n} + {m}_{sawbn} {S}_{α} \} {S}_{β} + ( {m}_{ba} + {m}_{sawan} ) {C}_{β} ] + \\ {\dot{z}}_{0} ( 1 - \dot{β} ) ( {m}_{ba} + {m}_{sawan} ) sin β - g [ {m}_{ba} {C}_{β} + {m}_{b} {A}_{1} {S}_{β} + \\ \{ {m}_{sn} {z}_{6 n} {C}_{αγ η n} + {m}_{aw1n} {S}_{αγθ n} + {m}_{sawcn} {C}_{αγ n} + \\ {m}_{sawbn} {S}_{α} \} {S}_{β} + {m}_{sawan} {C}_{β} ] + {λ}_{3 n} \{ ( {z}_{12 n} {C}_{α} + {e}_{3 n} {S}_{α γ θ n} + \\ {c}_{2 n} {C}_{αγ n} + {b}_{2 n} {S}_{α} ) {S}_{β} - {a}_{1 n} {C}_{β} \}\end{matrix}}{- ( {m}_{saw2n} + {m}_{ba1} + {m}_{b} {A}_{1}^{2} + {m}_{sn} {B}_{1}^{2} + {m}_{an} {B}_{2}^{2} + {m}_{wn} {B}_{3}^{2} )} & ( 95 ) \\ \frac{ⅆ}{ⅆ t} ( \frac{\partial L}{\partial \dot{α}} ) - \frac{\partial L}{\partial α} = \frac{\partial F}{\partial \dot{α}} + {\sum }_{l , n} {λ}_{l n} {a}_{ln2} l = 1 , 2 , 3 n = i , ii , iii , iv & ( 96 ) \\ - \ddot{β} {m}_{ba} ( {b}_{0} cos α - {c}_{0} sin α ) + \dot{β} \dot{α} {m}_{ba} ( {b}_{0} sin α + {c}_{0} cos α ) + {\ddot{z}}_{0} {m}_{b} cos β ( {b}_{0} cos α - {c}_{0} sin α ) - \dot{β} {\dot{z}}_{0} {m}_{b} sin β ( {b}_{0} cos α - {c}_{0} sin α ) - \dot{α} {\dot{z}}_{0} {m}_{b} cos β ( {b}_{0} sin α - {c}_{0} cos α ) + \ddot{α} ⟨ {m}_{bb1} + {m}_{saw1n} + {m}_{sn} {z}_{6 n} [ {z}_{6 n} + 2 \{ {c}_{1 n} cos {η}_{n} - {b}_{2 n} sin ( {γ}_{n} + {η}_{n} ) \} ] - 2 {m}_{aw1n} \{ {c}_{2 n} sin {θ}_{n} - {b}_{2 n} cos ( {γ}_{n} + {θ}_{n} ) \} ⟩ + \dot{α} ⟨ {m}_{sn} {\dot{z}}_{6 n} [ {z}_{6 n} + 2 \{ {c}_{1 n} cos {η}_{n} - {b}_{2 n} sin ( {γ}_{n} + {η}_{n} ) \} ] + & ( 97 ) \\ {m}_{sn} {z}_{6 n} [ {\dot{z}}_{6 n} - 2 {\dot{η}}_{n} \{ {c}_{1 n} sin {η}_{n} + {b}_{2 n} cos ( {γ}_{n} + {η}_{n} ) \} ] - 2 {\dot{θ}}_{n} {m}_{aw1n} \{ {c}_{2 n} cos {θ}_{n} + {b}_{2 n} sin ( {γ}_{n} + {θ}_{n} ) \} ⟩ + {\ddot{z}}_{6 n} {m}_{sn} \{ {c}_{1 n} sin {η}_{n} + {b}_{2 n} cos ( {γ}_{n} + {η}_{n} ) \} + {\dot{z}}_{6 n} {\dot{η}}_{n} {m}_{sn} \{ {c}_{1 n} cos {η}_{n} - {b}_{2 n} sin ( {γ}_{n} + {η}_{n} ) \} + {\ddot{η}}_{n} {m}_{sn} {z}_{6 n} \{ {z}_{6 n} + {c}_{1 n} cos {η}_{n} - {b}_{2 n} sin ( {γ}_{n} + {η}_{n} ) \} + {\dot{η}}_{n} {m}_{sn} {\dot{z}}_{6 n} \{ {z}_{6 n} + {c}_{1 n} cos {η}_{n} - {b}_{2 n} sin ( {γ}_{n} + {η}_{n} ) \} + & \\ {\dot{η}}_{n} {m}_{sn} {z}_{6 n} \{ {\dot{z}}_{6 n} - {\dot{η}}_{n} [ {c}_{1 n} sin {η}_{n} + {b}_{2 n} cos ( {γ}_{n} + {η}_{n} ) ] \} + \ddot{θ} [ {m}_{aw21n} - {m}_{aw1n} \{ {c}_{2 n} sin {θ}_{n} - {b}_{2 n} cos ( {γ}_{n} + {θ}_{n} ) \} ] - {\dot{θ}}_{n}^{2} {m}_{aw1n} \{ {c}_{2 n} cos {θ}_{n} + {b}_{2 n} sin ( {γ}_{n} + {θ}_{n} ) \} ] + \ddot{β} {a}_{1 n} \{ {m}_{sawcn} sin ( α + {γ}_{n} ) - {m}_{sawbn} cos α + & \\ {m}_{sn} {z}_{6 n} sin ( α + {γ}_{n} + {η}_{n} ) - {m}_{aw1n} cos ( α + {γ}_{n} + {θ}_{n} ) \} + \dot{β} {a}_{1 n} \{ \dot{α} [ {m}_{sawcn} cos ( α + {γ}_{n} ) + {m}_{sawbn} sin α ] + {m}_{sn} {\dot{z}}_{6 n} sin ( α + {γ}_{n} + {η}_{n} ) + ( \dot{α} + {\dot{η}}_{n} ) {m}_{sn} {z}_{6 n} cos ( α + {γ}_{n} + {η}_{n} ) + ( \dot{α} + {\dot{θ}}_{n} ) {m}_{saw1n} sin ( α + {γ}_{n} + {θ}_{n} ) \} + {\ddot{z}}_{0} \{ {m}_{aw1n} cos ( α + {γ}_{n} + {θ}_{n} ) - {z}_{6 n} {m}_{sn} sin ( α + {γ}_{n} + {η}_{n} ) - {m}_{sawcn} sin ( α + {γ}_{n} ) + {m}_{sawbn} cos α \} cos β \} + & \\ {\dot{z}}_{0} \{ - ( \dot{α} + {\dot{θ}}_{n} ) {m}_{aw1n} sin ( α + {γ}_{n} + {θ}_{n} ) - {z}_{6 n} {m}_{sn} sin ( α + {γ}_{n} + {η}_{n} ) - ( \dot{α} + {\dot{θ}}_{n} ) {z}_{6 n} {m}_{sn} cos ( α + {γ}_{n} + {η}_{n} ) - \dot{α} {m}_{sawcn} cos ( α + {γ}_{n} ) - \dot{α} {m}_{sawbn} sin α \} cos β - \dot{β} {\dot{z}}_{0} \{ {m}_{aw1n} cos ( α + {γ}_{n} + {θ}_{n} ) - {z}_{6 n} {m}_{sn} sin ( α + {γ}_{n} + {η}_{n} ) - {m}_{sawcn} sin ( α + {γ}_{n} ) + {m}_{sawbn} cos α \} cos β \} - \{ {\dot{β}}^{2} {m}_{b} ( {b}_{0} cos α - {c}_{0} sin α ) + \dot{α} \dot{β} {m}_{ba} \} ( {b}_{0} sin α + {c}_{0} cos α ) - & \\ \vert {\dot{β}}^{2} ⟨ {m}_{sn} \{ {z}_{6 n} cos ( α + {γ}_{n} + {η}_{n} ) + {c}_{1 n} cos ( α + {γ}_{n} ) + {b}_{2 n} sin α \} \{ - {z}_{6 n} sin ( α + {γ}_{n} + {η}_{n} ) - {c}_{1 n} sin ( α + {γ}_{n} ) + {b}_{2 n} cos α \} + {m}_{an} \{ {e}_{1 n} sin ( α + {γ}_{n} + {θ}_{n} ) + {c}_{2 n} cos ( α + {γ}_{n} ) + {b}_{2 n} sin α \} \{ {e}_{1} cos ( α + {γ}_{n} + {θ}_{n} ) - {c}_{2 n} sin ( α + {γ}_{n} ) + {b}_{2 n} cos α \} + {m}_{wn} \{ {e}_{3 n} sin ( α + {γ}_{n} + {θ}_{n} ) + {c}_{2 n} cos ( α + {γ}_{n} ) + {b}_{2 n} sin α \} \{ {e}_{3} cos ( α + {γ}_{n} + {θ}_{n} ) - {c}_{2 n} sin ( α + {γ}_{n} ) + {b}_{2 n} cos α \} ⟩ + {\dot{z}}_{6 n} \dot{β} {m}_{sn} {a}_{1 n} sin ( α + {γ}_{n} + {η}_{n} ) + & \\ {\dot{η}}_{n} \dot{β} {m}_{sn} {z}_{6 n} {a}_{1 n} cos ( α + {γ}_{n} + {η}_{n} ) + \dot{θ} \dot{β} {m}_{aw1n} {a}_{1 n} sin ( α + {γ}_{n} + {θ}_{n} ) + \dot{α} \dot{β} {a}_{1 n} \{ {m}_{sawcn} cos ( α + {γ}_{n} ) + {m}_{sawbn} sin α + {m}_{sn} {z}_{6 n} cos ( α + {γ}_{n} + {η}_{n} ) + {m}_{aw1n} sin ( α + {γ}_{n} + {θ}_{n} ) \} - {\dot{z}}_{0} \{ {\dot{z}}_{6 n} {m}_{sn} sin ( α + {γ}_{n} + {η}_{n} ) + ( \dot{α} + {\dot{θ}}_{n} ) {m}_{aw1n} sin ( α + {γ}_{n} + {θ}_{n} ) + ( \dot{α} + {\dot{η}}_{n} ) {z}_{6 n} {m}_{sn} cos ( α + {γ}_{n} + {θ}_{n} ) + \dot{α} {m}_{sawcn} cos ( α + {γ}_{n} ) + \dot{α} {m}_{sawbn} sin α \} cos β & \\ \dot{β} {\dot{z}}_{0} [ \{ {m}_{aw1n} cos ( α + {γ}_{n} + {θ}_{n} ) - {z}_{6 n} {m}_{sn} sin ( α + {γ}_{n} + {η}_{n} ) - {m}_{sawn} sin ( α + {γ}_{n} ) + {m}_{sawbn} cos α \} sin β \vert + {gm}_{b} ( {b}_{0} cos α - {c}_{0} sin α ) cos β - g \{ {m}_{sn} {z}_{6 n} sin ( α + {γ}_{n} + {η}_{n} ) - {m}_{aw1n} cos ( α + {γ}_{n} + {θ}_{n} ) + {m}_{sawcn} sin ( α + {γ}_{n} ) - {m}_{sawbn} cos α \} cos β = {λ}_{3 n} - {z}_{12 n} sin α + {e}_{3 n} cos ( α + {γ}_{n} + {θ}_{n} ) - {c}_{2 n} sin ( α + {γ}_{n} ) + {b}_{2 n} cos α \} cos β & \\ {\ddot{z}}_{0} \{ {m}_{b} {A}_{2} + {m}_{aw1n} {C}_{αγθ n} - {z}_{6 n} {m}_{sn} {S}_{αγ η n} - {m}_{sawcn} {S}_{αγ n} + {m}_{sawbn} {C}_{α} \} {C}_{β} - \ddot{β} {m}_{ba} {A}_{2} + \ddot{α} \{ {m}_{bb1} + {m}_{saw1n} + {m}_{sn} {z}_{6 n} ( {z}_{6 n} + 2 {E}_{1 n} ) - 2 {m}_{aw1n} {H}_{1 n} \} + 2 \dot{α} \{ {m}_{sn} {\dot{z}}_{6 n} ( {z}_{6 n} + {E}_{1 n} ) - {m}_{sn} {z}_{6 n} {\dot{η}}_{n} {E}_{2 n} - {\dot{θ}}_{n} {m}_{aw1n} {H}_{2 n} \} + {\ddot{z}}_{6 n} {m}_{sn} {E}_{2 n} + {\dot{z}}_{6 n} {\dot{η}}_{n} {m}_{sn} {E}_{1 n} + {\ddot{η}}_{n} {m}_{sn} {z}_{6 n} \{ {z}_{6 n} + {E}_{1 n} \} + {\dot{η}}_{n} {m}_{sn} {\dot{z}}_{6 n} \{ 2 {z}_{6 n} + {E}_{1 n} \} - {\dot{η}}_{n}^{2} {m}_{sn} {z}_{6 n} {E}_{2 n} + \ddot{θ} ( {m}_{aw21n} - {m}_{aw1n} {H}_{1 n} ) - {\dot{θ}}_{n}^{2} {m}_{aw1n} {H}_{2 n} + \ddot{β} {a}_{1 n} ( {m}_{sawcn} {S}_{αγ n} - {m}_{sawbn} {C}_{α} + {m}_{sn} {z}_{6 n} {S}_{αγ η n} - {m}_{aw1n} {C}_{αγ θ n} ) + \dot{β} {a}_{1 n} \{ \dot{α} ( {m}_{sawcn} {C}_{αγ n} + {m}_{sawbn} {S}_{α} ) + {m}_{sn} {\dot{z}}_{6 n} {S}_{αγ η n} + ( \dot{α} + {\dot{η}}_{n} ) {m}_{sn} {z}_{6 n} {C}_{αγ η n} + ( \dot{α} + {\dot{θ}}_{n} ) {m}_{aw1n} {S}_{α γ θ n} \} - {\dot{β}}^{2} {m}_{b} {A}_{2} {A}_{1} - [ {\dot{β}}^{2} \{ {m}_{sn} {B}_{1} ( - {z}_{6 n} {S}_{αγ η n} - {A}_{4} ) + & ( 98 ) \\ {m}_{an} {B}_{2} ( {e}_{1} {C}_{αγθ n} - {A}_{6} ) + {m}_{wn} {B}_{3} ( {e}_{3} {C}_{αγθ n} - {A}_{6} ) \} + {\dot{z}}_{6 n} \dot{β} {m}_{sn} {a}_{1 n} {S}_{αγ η n} + {\dot{η}}_{n} \dot{β} {m}_{sn} {z}_{6 n} {a}_{1 n} {C}_{αγ η n} + \dot{θ} \dot{β} {m}_{aw1n} {a}_{1 n} {S}_{αγ θ n} + \dot{α} \dot{β} {a}_{1 n} \{ {m}_{sawcn} {C}_{αγ n} + {m}_{sawbn} {S}_{α} + {m}_{sn} {z}_{6 n} {C}_{αγ η n} + {m}_{aw1n} {S}_{αγθ n} \} ] + {gm}_{b} {A}_{2} {C}_{β} - g \{ {m}_{sn} {z}_{6 n} {S}_{αγ η n} - {m}_{aw1n} {C}_{αγ θ n} + {m}_{sawcn} {S}_{αγ n} - {m}_{sawbn} {C}_{α} \} {C}_{β} = {λ}_{3 n} \{ - {z}_{12 n} {S}_{α} + {e}_{3 n} {C}_{α γ θ n} - {c}_{2 n} {S}_{αγ n} + {b}_{2 n} {C}_{α} \} {C}_{β} & \\ {\ddot{z}}_{0} \{ {m}_{b} {A}_{2} + {m}_{aw1n} {C}_{αγθ n} - {z}_{6 n} {m}_{sn} {S}_{αγ η n} - {m}_{sawcn} {S}_{αγ n} + {m}_{sawbn} {C}_{α} \} {C}_{β} - \ddot{β} {m}_{ba} {A}_{2} + \ddot{α} \{ {m}_{bb1} + {m}_{saw1n} + {m}_{sn} {z}_{6 n} ( {z}_{6 n} + 2 {E}_{1 n} ) - 2 {m}_{aw1n} {H}_{1 n} \} + {m}_{sn} ( 2 \dot{α} {\dot{z}}_{6 n} + {\ddot{η}}_{n} {z}_{6 n} + 2 {\dot{η}}_{n} {\dot{z}}_{6 n} ) ( {z}_{6 n} + {E}_{1 n} ) - 2 \dot{α} ( {m}_{sn} {z}_{6 n} {\dot{η}}_{n} {E}_{2 n} + {\dot{θ}}_{n} {m}_{aw1n} {H}_{2 n} ) + {\ddot{z}}_{6 n} {m}_{sn} {E}_{2 n} - {\dot{η}}_{n}^{2} {m}_{sn} {z}_{6 n} {E}_{2 n} + \ddot{θ} ( {m}_{aw21n} - {m}_{aw1n} {H}_{1 n} ) - {\dot{θ}}_{n}^{2} {m}_{aw1n} {H}_{2 n} + \ddot{β} {a}_{1 n} ( {m}_{sawcn} {S}_{αγ n} - {m}_{sawbn} {C}_{α} + {m}_{sn} {z}_{6 n} {S}_{αγη n} - {m}_{aw1n} {C}_{αγ θ n} ) - {\dot{β}}^{2} \{ {m}_{b} {A}_{2} {A}_{1} + {m}_{sn} {B}_{1} ( - {z}_{6 n} {S}_{αγ η n} - {A}_{4} ) + {m}_{an} {B}_{2} ( {e}_{1} {C}_{αγ θ n} - {A}_{6} ) + {m}_{wn} {B}_{3} ( {e}_{3} {C}_{α γ θ n} - {A}_{6} ) \} + g {m}_{b} {A}_{2} {C}_{β} - g \{ {m}_{sn} {z}_{6 n} {S}_{αγ η n} - {m}_{aw1n} {C}_{αγ θ n} + {m}_{sawcn} {S}_{α γ n} - {m}_{sawbn} {C}_{α} \} {C}_{β} = {λ}_{3 n} ( - {z}_{12 n} {S}_{α} + {e}_{3 n} {C}_{αγ θ n} - {c}_{2 n} {S}_{αγ n} + {b}_{2 n} {C}_{α} ) {C}_{β} & ( 99 ) \\ ∴ \\ \ddot{α} = \frac{\begin{matrix}{\ddot{z}}_{0} \{ {m}_{b} {A}_{2} + {m}_{aw1n} {C}_{αγ θ n} - {z}_{6 n} {m}_{sn} {S}_{αγ η n} - {m}_{sawcn} {S}_{α γ n} + \\ {m}_{sawbn} {C}_{α} \} {C}_{β} {m}_{sn} ( 2 \dot{α} {\dot{z}}_{6 n} + {\ddot{η}}_{n} {z}_{6 n} + 2 {\dot{η}}_{n} {\dot{z}}_{6 n} ) ( {z}_{6 n} + {E}_{1 n} ) - \\ 2 \dot{α} ( {m}_{sn} {z}_{6 n} {\dot{η}}_{n} {E}_{2 n} + {\dot{θ}}_{n} {m}_{aw1n} {H}_{2 n} ) + {\ddot{z}}_{6 n} {m}_{sn} {E}_{2 n} - {\dot{η}}_{n}^{2} {m}_{sn} {z}_{6 n} {E}_{2 n} + \\ \ddot{θ} ( {m}_{aw21n} - {m}_{aw1n} {H}_{1 n} ) - {\dot{θ}}_{n}^{2} {m}_{aw1n} {H}_{2 n} + \ddot{β} {a}_{1 n} ( {m}_{sawcn} {S}_{α γ n} - \\ {m}_{sawbn} {C}_{α} + {m}_{sn} {z}_{6 n} {S}_{αγ η n} - {m}_{aw1n} {C}_{αγ θ 1} ) - {\dot{β}}^{2} \{ {m}_{b} {A}_{2} {A}_{1} + \\ {m}_{sn} {B}_{1} ( - {z}_{6 n} {S}_{αγ η n} - {A}_{4} ) + {m}_{an} {B}_{2} ( {e}_{1} {C}_{α γ θ n} - {A}_{6} ) + \\ {m}_{wn} {B}_{3} ( {e}_{3} {C}_{αγ θ n} - {A}_{6} ) \} + g {m}_{b} {A}_{2} {C}_{β} - g \{ {m}_{sn} {z}_{6 n} {S}_{αγ η n} - \\ {m}_{aw1n} {C}_{αγ θ n} + {m}_{sawcn} {S}_{αγ n} - {m}_{sawbn} {C}_{α} \} {C}_{β} - \ddot{β} {m}_{ba} {A}_{2} + \\ {λ}_{3 n} ( {z}_{12 n} {S}_{α} - {e}_{3 n} {C}_{αγ θ n} + {c}_{2 n} {S}_{αγ n} - {b}_{2 n} {C}_{α} ) {C}_{β}\end{matrix}}{- \{ {m}_{bb1} + {m}_{saw1n} + {m}_{sn} {z}_{6 n} ( {z}_{6 n} + 2 {E}_{1 n} ) - 2 {m}_{aw1n} {H}_{1 n} \}} & ( 100 ) \\ \frac{ⅆ}{ⅆ t} ( \frac{\partial L}{\partial {\dot{η}}_{n}} ) - \frac{\partial L}{\partial {η}_{n}} = \frac{\partial F}{\partial {\dot{η}}_{n}} + {\sum }_{l , n} {λ}_{ln} {a}_{ln3} l = 1 , 2 , 3 n = i , ii , iii , iv & ( 101 ) \\ {m}_{sn} {\ddot{η}}_{n} {z}_{6 n}^{2} + 2 {m}_{sn} {\dot{η}}_{n} {\dot{z}}_{6 n} {z}_{6 n} + \ddot{α} {m}_{sn} {z}_{6 n} \{ {z}_{6 n} + {c}_{1 n} cos {η}_{n} - {b}_{2 n} sin ( {γ}_{n} + {η}_{n} ) \} + \dot{α} {m}_{sn} {z}_{6 n} \{ {\dot{z}}_{6 n} - {\dot{η}}_{n} [ {c}_{1 n} sin {η}_{n} + {b}_{2 n} cos ( {γ}_{n} + {η}_{n} ) ] \} + \ddot{β} {m}_{sn} {z}_{6 n} {a}_{1 n} sin ( α + {γ}_{n} + {η}_{n} ) + \dot{β} {m}_{sn} {\dot{z}}_{6 n} {a}_{1 n} sin ( α + {γ}_{n} + {η}_{n} ) + \dot{β} ( \dot{α} + {\dot{η}}_{n} ) {m}_{sn} {z}_{6 n} {a}_{1 n} cos ( α + {γ}_{n} + {η}_{n} ) - {\ddot{z}}_{0} {z}_{6 n} {m}_{sn} sin ( α + {γ}_{n} + {η}_{n} ) cos β - {\dot{z}}_{0} {\dot{z}}_{6 n} {m}_{sn} sin ( α + {γ}_{n} + {η}_{n} ) cos β - ( \dot{α} + {\dot{η}}_{n} ) {\dot{z}}_{0} {z}_{6 n} {m}_{sn} cos ( α + {γ}_{n} + {η}_{n} ) cos β - \dot{β} {\dot{z}}_{0} {\dot{z}}_{6 n} {m}_{sn} sin ( α + {γ}_{n} + {η}_{n} ) sin β - & ( 102 ) \\ ⟨ {\dot{α}}^{2} {m}_{sn} {z}_{6 n} \{ - {c}_{1 n} sin {η}_{n} - {b}_{2 n} cos ( {γ}_{n} + {η}_{n} ) \} + {\dot{β}}^{2} {m}_{sn} \{ {z}_{6 n} cos ( α + {γ}_{n} + {η}_{n} ) + {c}_{1 n} cos ( α + {γ}_{n} ) + {b}_{2 n} sin α \} \{ - {z}_{6 n} sin ( α + {γ}_{n} + {η}_{n} ) \} + {\dot{z}}_{6 n} \dot{α} {m}_{sn} \{ {c}_{1 n} cos {η}_{n} - {b}_{2 n} sin ( {γ}_{n} + {η}_{n} ) \} + {\dot{z}}_{6 n} \dot{β} {m}_{sn} {a}_{1 n} sin ( α + {γ}_{n} + {η}_{n} ) - {\dot{η}}_{n} \dot{α} {m}_{sn} {z}_{6 n} \{ {c}_{1 n} sin {η}_{n} + {b}_{2 n} cos ( {γ}_{n} + {η}_{n} ) \} + {\dot{η}}_{n} \dot{β} {m}_{sn} {z}_{6 n} {a}_{1 n} cos ( α + {γ}_{n} + {η}_{n} ) + \dot{α} \dot{β} {a}_{1 n} {m}_{sn} {z}_{6 n} cos ( α + {γ}_{n} + {η}_{n} ) + g {m}_{sn} {z}_{6 n} sin ( α + {γ}_{n} + {η}_{n} ) cos β - {\dot{z}}_{0} \{ {z}_{6 n} {m}_{sn} sin ( α + {γ}_{n} + {η}_{n} ) + ( \dot{α} + {\dot{η}}_{n} ) {\dot{z}}_{0} {z}_{6 n} {m}_{sn} cos ( α + {γ}_{n} + {η}_{n} ) \} cos β + \dot{β} {\dot{z}}_{0} {\dot{z}}_{6 n} {m}_{sn} sin ( α + {γ}_{n} + {η}_{n} ) sin β ⟩ = - {λ}_{1 n} ( {z}_{6 n} - {d}_{1 n} ) cos {η}_{n} + {λ}_{2 n} ( {z}_{6 n} - {d}_{1 n} ) sin {η}_{n} & \\ {m}_{sn} {\ddot{η}}_{n} {z}_{6 n}^{2} + 2 {m}_{sn} {\dot{η}}_{n} {\dot{z}}_{6 n} {z}_{6 n} + \ddot{α} {m}_{sn} {z}_{6 n} \{ {z}_{6 n} + {E}_{1} \} + \dot{α} {m}_{sn} {\dot{z}}_{6 n} \{ 2 {z}_{6 n} + {E}_{1} \} - \dot{α} {m}_{sn} {z}_{6 n} {\dot{η}}_{n} {E}_{2} + \ddot{β} {m}_{sn} {z}_{6 n} {a}_{1 n} {S}_{αγη n} + \dot{β} {m}_{sn} {z}_{6 n} {a}_{1 n} {S}_{αγη n} + \dot{β} ( \dot{α} + {\dot{η}}_{n} ) {m}_{sn} {z}_{6 n} {a}_{1 n} {C}_{αγη n} - {\ddot{z}}_{0} {z}_{6 n} {m}_{sn} {S}_{αγ η n} {C}_{β} + {\dot{α}}^{2} {m}_{sn} {z}_{6 n} {E}_{2} + {\dot{β}}^{2} {m}_{sn} {B}_{1} {z}_{6 n} {S}_{αγ η n} - {\dot{z}}_{6 n} \dot{α} {m}_{sn} {E}_{1} - {\dot{z}}_{6 n} \dot{β} {m}_{sn} {a}_{1 n} {S}_{αγη n} + {\dot{η}}_{n} \dot{α} {m}_{sn} {z}_{6 n} {E}_{2} - {\dot{η}}_{n} \dot{β} {m}_{sn} {z}_{6 n} {a}_{1 n} {C}_{αγ η n} - \dot{α} \dot{β} {a}_{1 n} {m}_{sn} {z}_{6 n} {C}_{α γ η n} - g {m}_{sn} {z}_{6 n} {S}_{α γ η n} {C}_{β} = - {λ}_{1 n} ( {z}_{6 n} - {d}_{1 n} ) {C}_{η n} + {λ}_{2 n} ( {z}_{6 n} - {d}_{1 n} ) {S}_{η n} & ( 103 ) \\ {m}_{sn} {z}_{6 n} \{ {\ddot{η}}_{n} {z}_{6 n} + 2 {\dot{η}}_{n} {\dot{z}}_{6 n} + \ddot{α} ( {z}_{6 n} + {E}_{1} ) + 2 \dot{α} {\dot{z}}_{6 n} + \ddot{β} {a}_{1 n} {S}_{αγ η n} - {\ddot{z}}_{0} {S}_{αγ η n} {C}_{β} + {\dot{α}}^{2} {E}_{2} + {\dot{β}}^{2} {B}_{1} {S}_{αγ η n} - g {S}_{αγ η n} {C}_{β} \} = - {λ}_{1 n} ( {z}_{6 n} - {d}_{1 n} ) {C}_{η n} + {λ}_{2 n} ( {z}_{6 n} - {d}_{1 n} ) {S}_{η n} & ( 104 ) \\ ∴ \\ {λ}_{1 n} = \frac{\begin{matrix}{m}_{sn} {z}_{6 n} \{ {\ddot{η}}_{n} {z}_{6 n} + 2 {\dot{η}}_{n} {\dot{z}}_{6 n} + \ddot{α} ( {z}_{6 n} + {E}_{1} ) + 2 \dot{α} {\dot{z}}_{6 n} + \ddot{β} {a}_{1 n} {S}_{αγ η n} - \\ {\ddot{z}}_{0} {S}_{αγη n} {C}_{β} + {\dot{α}}^{2} {E}_{2} + {\dot{β}}^{2} {B}_{1} {S}_{αγ η n} - g {S}_{α γ η n} {C}_{β} \} - {λ}_{2 n} ( {z}_{6 n} - {d}_{1 n} ) {S}_{η n}\end{matrix}}{- ( {z}_{6 n} - {d}_{1 n} ) {C}_{η n}} & ( 105 ) \\ \frac{ⅆ}{ⅆ t} ( \frac{\partial L}{\partial {\dot{θ}}_{n}} ) - \frac{\partial L}{\partial {θ}_{n}} = \frac{\partial F}{\partial {\dot{θ}}_{n}} + {\sum }_{l , n} {λ}_{l n} {a}_{l n4} l = 1 , 2 , 3 n = i , ii , iii , iv & ( 106 ) \\ {\ddot{θ}}_{n} {m}_{aw21n} + \ddot{α} [ {m}_{aw21n} - {m}_{aw1n} \{ {c}_{2 n} sin {θ}_{n} - {b}_{2 n} cos ( {γ}_{n} + {θ}_{n} ) \} - \dot{α} {\dot{θ}}_{n} {m}_{aw1n} \{ {c}_{2 n} cos {θ}_{n} + {b}_{2 n} sin ( {γ}_{n} + {θ}_{n} ) \} - \ddot{β} {m}_{aw1n} {a}_{1 n} cos ( α + {γ}_{n} + {θ}_{n} ) + \dot{β} ( \dot{α} + {\dot{θ}}_{n} ) {m}_{aw1n} {a}_{1 n} sin ( α + {γ}_{n} + {θ}_{n} ) + {\ddot{z}}_{0} {m}_{aw1n} cos ( α + {γ}_{n} + {θ}_{n} ) cos β - ( \dot{α} + {\dot{θ}}_{n} ) {\dot{z}}_{0} {m}_{aw1n} sin ( α + {γ}_{n} + {θ}_{n} ) cos β - \dot{β} {\dot{z}}_{0} {m}_{aw1n} cos ( α + {γ}_{n} + {θ}_{n} ) sin β - [ - {k}_{zi} {e}_{0 i}^{2} \{ sin ( {γ}_{i} + {θ}_{i} ) - sin ( {γ}_{ii} + {θ}_{ii} ) \} cos ( {γ}_{n} + {θ}_{n} ) {X}_{s} - {k}_{ziii} {e}_{0 iii}^{2} \{ sin ( {γ}_{iii} + {θ}_{iii} ) - sin ( {γ}_{iv} + {θ}_{iv} ) \} cos ( {γ}_{n} + {θ}_{n} ) {X}_{s} - {\dot{α}}^{2} {m}_{aw1n} \{ {c}_{2 n} cos {θ}_{n} + {b}_{2 n} sin ( {γ}_{n} + {θ}_{n} ) \} + & ( 107 ) \\ {\dot{β}}^{2} ⟨ {m}_{an} \{ {e}_{1 n} sin ( α + {γ}_{n} + {θ}_{n} ) + {c}_{2 n} cos ( α + {γ}_{n} ) + {b}_{2 n} sin α \} {e}_{1 n} cos ( α + {γ}_{n} + {θ}_{n} ) + {m}_{wn} \{ {e}_{3 n} sin ( α + {γ}_{n} + {θ}_{n} ) + {c}_{2 n} cos ( α + {γ}_{n} ) + {b}_{2 n} sin α \} {e}_{3 n} cos ( α + {γ}_{n} + {θ}_{n} ) ⟩ - \dot{θ} \dot{α} {m}_{aw1n} \{ {c}_{2 n} cos {θ}_{n} + {b}_{2 n} sin ( {γ}_{n} + {θ}_{n} ) \} + \dot{θ} \dot{β} {m}_{aw1n} {a}_{1 n} sin ( α + {γ}_{n} + {θ}_{n} ) + \dot{α} \dot{β} {a}_{1 n} {m}_{aw1n} sin ( α + {γ}_{n} + {θ}_{\dot{n}} ) - g {m}_{aw1n} cos ( α + {γ}_{n} + {θ}_{n} ) cos β - {\dot{z}}_{0} ( \dot{α} + {\dot{θ}}_{n} ) {m}_{aw1n} sin ( α + {γ}_{n} + {θ}_{n} ) cos β - \dot{β} {\dot{z}}_{0} {m}_{aw1n} cos ( α + {γ}_{n} + {θ}_{n} ) sin β ] = {λ}_{1 n} {e}_{2 n} sin {θ}_{n} + {λ}_{2 n} {e}_{2 n} cos {θ}_{n} + {λ}_{3 n} {e}_{3 n} cos ( α + {γ}_{n} + {θ}_{n} ) cos β & \\ {\ddot{θ}}_{n} {m}_{aw21n} + \ddot{α} ( {m}_{aw21n} - {m}_{aw1n} {H}_{1} ) - \dot{α} {\dot{θ}}_{n} {m}_{aw1n} {H}_{2} - \ddot{β} {m}_{aw1n} {a}_{1 n} {C}_{αγ θ n} + \dot{β} ( \dot{α} + {\dot{θ}}_{n} ) {m}_{aw1n} {a}_{1 n} {S}_{αγ θ n} + {\ddot{z}}_{0} {m}_{aw1n} {C}_{αγθ n} {C}_{β} - [ - {k}_{zi} {e}_{0 i}^{2} \{ sin ( {γ}_{i} + {θ}_{i} ) + sin ( {γ}_{ii} + {θ}_{ii} ) \} {X}_{s} - {k}_{ziii} {e}_{0 iii}^{2} \{ sin ( {γ}_{iii} + {θ}_{iii} ) + sin ( {γ}_{iv} + {θ}_{iv} ) \} cos ( {γ}_{n} + {θ}_{n} ) {X}_{s} - {\dot{α}}^{2} {m}_{aw1n} {H}_{2} + {\dot{β}}^{2} ( {m}_{an} {B}_{2} {e}_{1 n} {C}_{αγ θ n} + {m}_{wn} {B}_{3} {e}_{3 n} {C}_{αγ θ n} ) - \dot{θ} \dot{α} {m}_{aw1n} {H}_{2} + \dot{θ} \dot{β} {m}_{aw1n} {a}_{1 n} {S}_{αγ θ n} + \dot{α} \dot{β} {a}_{1 n} {m}_{aw1n} {S}_{αγ θ n} - g {m}_{aw1n} {C}_{αγ θ n} {C}_{β} ] = {λ}_{1 n} {e}_{2 n} {S}_{θ n} + {λ}_{2 n} {e}_{2 n} {C}_{θ n} + {λ}_{3 n} {e}_{3 n} {C}_{αγθ n} {C}_{β} & ( 108 ) \\ {\ddot{θ}}_{n} {m}_{aw21n} + \ddot{α} ( {m}_{aw21n} - {m}_{aw1n} {H}_{1} ) - \ddot{β} {m}_{aw1n} {a}_{1 n} {C}_{αγ θ n} + {\ddot{z}}_{0} {m}_{aw1n} {C}_{αγ θ n} {C}_{β} + {\dot{α}}^{2} {m}_{aw1n} {H}_{2} - {\dot{β}}^{2} ( {m}_{an} {B}_{2} {e}_{1 n} {C}_{αγ θ n} + {m}_{wn} {B}_{3} {e}_{3 n} {C}_{αγ θ n} ) + g {m}_{aw1n} {C}_{αγ θ n} {C}_{β} + {k}_{zi} {e}_{0 i}^{2} \{ sin ( {γ}_{i} + {θ}_{i} ) + sin ( {γ}_{ii} + {θ}_{ii} ) \} cos ( {γ}_{n} + {θ}_{n} ) + {k}_{ziii} {e}_{0 iii}^{2} \{ sin ( {γ}_{iii} + {θ}_{iii} ) + sin ( {γ}_{iv} + {θ}_{iv} ) \} cos ( {γ}_{n} + {θ}_{n} ) = {λ}_{1 n} {e}_{2 n} {S}_{θ n} + {λ}_{2 n} {e}_{2 n} {C}_{θ n} + {λ}_{3 n} {e}_{3 n} {C}_{α γ θ n} {C}_{β} & ( 109 ) \\ ∴ \\ {\ddot{θ}}_{n} = \frac{\begin{matrix}\ddot{α} ( {m}_{aw21n} - {m}_{aw1n} {H}_{1} ) - \ddot{β} {m}_{aw1n} {a}_{1 n} {C}_{αγ θ n} + {\ddot{z}}_{0} {m}_{aw1n} {C}_{αγ θ n} {C}_{β} + \\ {\dot{α}}^{2} {m}_{aw1n} {H}_{2} - {\dot{β}}^{2} ( {m}_{an} {B}_{2} {e}_{1 n} {C}_{αγ θ n} + {m}_{wn} {B}_{3} {e}_{3 n} {C}_{α γ θ n} ) + \\ g {m}_{aw1n} {C}_{αγ θ n} {C}_{β} - {λ}_{1 n} {e}_{2 n} {S}_{θ n} - {λ}_{2 n} {e}_{2 n} {C}_{θ n} - {λ}_{3 n} {e}_{3 n} {C}_{αγθ n} {C}_{β} + \\ {k}_{zi} {e}_{0 i}^{2} \{ sin ( {γ}_{i} + {θ}_{i} ) + sin ( {γ}_{ii} + {θ}_{ii} ) \} cos ( {γ}_{n} + {θ}_{n} ) + \\ {k}_{ziii} {e}_{0 iii}^{2} \{ sin ( {γ}_{iii} + {θ}_{iii} ) + sin ( {γ}_{iv} + {θ}_{iv} ) \} cos ( {γ}_{n} + {θ}_{n} )\end{matrix}}{- {m}_{aw21n}} & ( 110 ) \\ \frac{ⅆ}{ⅆ t} ( \frac{\partial L}{\partial {\dot{z}}_{6 n}} ) - \frac{\partial L}{\partial {z}_{6 n}} = \frac{\partial F}{\partial {\dot{z}}_{6 n}} + {\sum }_{l , n} {λ}_{l n} {a}_{l n5} l = 1 , 2 , 3 n = i , ii , iii , iv & ( 111 ) \\ {m}_{sn} {\ddot{z}}_{6 n} + \ddot{α} {m}_{sn} \{ {c}_{1 n} sin {η}_{n} + {b}_{2 n} cos ( {γ}_{n} + {η}_{n} ) \} + \dot{α} {\dot{η}}_{n} {m}_{sn} \{ {c}_{1 n} cos {η}_{n} - {b}_{2 n} sin ( {γ}_{n} + {η}_{n} ) \} - \ddot{β} {m}_{sn} {a}_{1 n} cos ( α + {γ}_{n} + {η}_{n} ) + \dot{β} ( \dot{α} + {\dot{η}}_{n} ) {m}_{sn} {a}_{1 n} sin ( α + {γ}_{n} + {η}_{n} ) + {\ddot{z}}_{0} {m}_{sn} cos ( α + {γ}_{n} + {η}_{n} ) cos β - ( \dot{α} + {\dot{η}}_{n} ) {\dot{z}}_{0} {m}_{sn} sin ( α + {γ}_{n} + {η}_{n} ) cos β - \dot{β} {\dot{z}}_{0} {m}_{sn} cos ( α + {γ}_{n} + {η}_{n} ) sin β - ⟨ {m}_{sn} {\dot{η}}_{n}^{2} {z}_{6 n} + {\dot{α}}^{2} {m}_{sn} [ {z}_{6 n} + \{ {c}_{1 n} cos {η}_{n} - {b}_{2 n} sin ( {γ}_{n} + {η}_{n} ) \} ] + {\dot{β}}^{2} {m}_{sn} \{ {z}_{6 n} cos ( α + {γ}_{n} + {η}_{n} ) + {c}_{1 n} cos ( α + {γ}_{n} ) + {b}_{2 n} sin α \} cos ( α + {γ}_{n} + {η}_{n} ) + {\dot{η}}_{n} \dot{α} {m}_{sn} \{ 2 {z}_{6 n} + {c}_{1 n} cos {η}_{n} - {b}_{2 n} sin ( {γ}_{n} + {η}_{n} ) \} + {\dot{η}}_{n} \dot{β} {m}_{sn} {a}_{1 n} sin ( α + {γ}_{n} + {η}_{n} ) + \dot{α} \dot{β} {a}_{1 n} {m}_{sn} sin ( α + {γ}_{n} + {η}_{n} ) - g {m}_{sn} cos ( α + {γ}_{n} + {η}_{n} ) cos β - {k}_{sn} ( {z}_{6 n} - {l}_{sn} ) + {\dot{z}}_{0} ( \dot{α} + {\dot{η}}_{n} ) {m}_{sn} sin ( α + {γ}_{n} + {η}_{n} ) cos β - \dot{β} {\dot{z}}_{0} {m}_{sn} cos ( α + {γ}_{n} + {η}_{n} ) sin β ⟩ = - {c}_{sn} {\dot{z}}_{6 n} - {λ}_{1 n} sin {η}_{n} - {λ}_{2 n} cos {η}_{n} & ( 112 ) \\ {m}_{sn} \{ {\ddot{z}}_{6 n} + \ddot{α} {E}_{2} - \ddot{β} {a}_{1 n} {C}_{αγ η n} - {\dot{η}}_{n}^{2} {z}_{6 n} - {\dot{α}}^{2} ( {z}_{6 n} + {E}_{1} ) - {\dot{β}}^{2} {B}_{1} {C}_{αγ η n} - 2 {\dot{η}}_{n} \dot{α} {z}_{6 n} + g {C}_{αγ η n} {C}_{β} \} + {k}_{sn} ( {z}_{6 n} - {l}_{sn} ) = - {c}_{sn} {\dot{z}}_{6 n} - {λ}_{1 n} {S}_{η n} - {λ}_{2 n} {C}_{η n} & ( 113 ) \\ ∴ \\ {λ}_{2 n} = \frac{\begin{matrix}{m}_{sn} \{ {\ddot{z}}_{6 n} + \ddot{α} {E}_{2} - \ddot{β} {a}_{1 n} {C}_{αγη n} - {\dot{η}}_{n}^{2} {z}_{6 n} - {\dot{α}}^{2} ( {z}_{6 n} + {E}_{1} ) - \\ {\dot{β}}^{2} {B}_{1} {C}_{αγ η n} - 2 {\dot{η}}_{n} \dot{α} {z}_{6 n} + g {C}_{αγη n} {C}_{β} \} + {k}_{sn} ( {z}_{6 n} - {l}_{sn} ) + \\ {c}_{sn} {\dot{z}}_{6 n} + {λ}_{1 n} {S}_{η n}\end{matrix}}{- {C}_{η n}} & ( 114 ) \\ \frac{ⅆ}{ⅆ t} ( \frac{\partial L}{\partial {\dot{z}}_{12 n}} ) - \frac{\partial L}{\partial {z}_{12 n}} = \frac{\partial F}{\partial {\dot{z}}_{12 n}} + {\sum }_{l , n} {λ}_{l n} {a}_{l n6} l = 1 , 2 , 3 n = i , ii , iii , iv & \\ \begin{matrix}{k}_{wn} ( {z}_{12 n} - {l}_{wn} ) = - {c}_{wn} {\dot{z}}_{12 n} + {λ}_{3 n} cos α cos β \\ = - {c}_{wn} {\dot{z}}_{12 n} + {λ}_{3 n} {C}_{α} {C}_{β}\end{matrix} & ( 115 ) \\ ∴ \\ {λ}_{3 n} = \frac{{c}_{wn} {\dot{z}}_{12 n} + {k}_{wn} ( {z}_{12 n} - {l}_{wn} )}{{C}_{α}} & ( 116 )\end{matrix}$$

From the differentiated constraints it follows that:

$$\begin{matrix}{\ddot{θ}}_{n} {e}_{2 n} {S}_{θ n} + {\dot{θ}}_{n}^{2} {e}_{2 n} {C}_{θ n} - {\ddot{z}}_{6 n} {S}_{η n} - {\dot{z}}_{6 n} {\dot{η}}_{n} {C}_{η n} - {\ddot{η}}_{n} ( {z}_{6 n} - {d}_{1 n} ) {C}_{η n} - {\dot{η}}_{n} {\dot{z}}_{6 n} {C}_{η n} + {\dot{η}}_{n}^{2} ( {z}_{6 n} - {d}_{1 n} ) {S}_{η n} = 0 \\ {\ddot{θ}}_{n} {e}_{2 n} {C}_{θ n} - {\dot{θ}}_{n}^{2} {e}_{2 n} {S}_{θ n} - {\ddot{z}}_{6 n} {C}_{η n} + {\dot{z}}_{6 n} {\dot{η}}_{n} {S}_{η n} + {\ddot{η}}_{n} ( {z}_{6 n} - {d}_{1 n} ) {S}_{η n} + {\dot{η}}_{n} {\dot{z}}_{6 n} {S}_{η n} + {\dot{η}}_{n} ( {z}_{6 n} - {d}_{1 n} ) {C}_{η n} = 0 & ( 117 ) \\ ∴ \\ {\ddot{η}}_{n} = \frac{\begin{matrix}{\ddot{θ}}_{n} {e}_{2 n} {S}_{θ n} + {\dot{θ}}_{n}^{2} {e}_{2 n} {C}_{θ n} - {\ddot{z}}_{6 n} {S}_{η n} - \\ 2 {\dot{η}}_{n} {\dot{z}}_{6 n} {C}_{η n } + {\dot{η}}_{n}^{2} ( {z}_{6 n} - {d}_{1 n} ) {S}_{η n}\end{matrix}}{( {z}_{6 n} - {d}_{1 n} ) {C}_{η n}} & ( 118 ) \\ {\ddot{z}}_{6 n} = \frac{\begin{matrix}{\ddot{θ}}_{n} {e}_{2 n} {C}_{θ n} - {\dot{θ}}_{n}^{2} {e}_{2 n} {S}_{θ n} + {\ddot{η}}_{n} ( {z}_{6 n} - {d}_{1 n} ) {S}_{η n} + \\ 2 {\dot{η}}_{n} {\dot{z}}_{6 n} {S}_{η n} + {\dot{η}}_{n}^{2} ( {z}_{6 n} - {d}_{1 n} ) {C}_{η n}\end{matrix}}{{C}_{η n}} \\ \text{and} & ( 119 ) \\ {\dot{z}}_{12 n} = \frac{\begin{matrix}\{ \dot{α} {z}_{12 n} {S}_{α} - ( \dot{α} + {\dot{θ}}_{n} ) {e}_{3 n} {C}_{α γ θ n} + \dot{α} {c}_{2 n} {S}_{αγ n} - \dot{α} {b}_{2 n} {C}_{α} \} {C}_{β} - {\dot{z}}_{0} + \\ \dot{β} [ \{ {z}_{12 n} {C}_{α} + {e}_{3 n} {S}_{α γ θ n} + {c}_{2 n} {C}_{αγ n} + {b}_{2 n} {S}_{α} \} {S}_{β} + {a}_{1 n} {C}_{β} ] + {\dot{R}}_{n} ( t )\end{matrix}}{{C}_{α} {C}_{β}} & ( 120 )\end{matrix}$$

Supplemental differentiation of equation (116) for the later entropy production calculation yields:

k_{wn}\dot{z}₁₂ₙ=−c_{wn}\ddot{z}₁₂ₙ+\dot{λ}₃ₙC_{α}C_{β}−\dot{α}λ₃ₙS_{α}C_{β}−\dot{β}λ₃ₙC_{α}S_{β} (121)

therefore

$${\ddot{z}}_{12 n} = \frac{{\dot{λ}}_{3 n} {C}_{α} {C}_{β} - \dot{α} {λ}_{3 n} {S}_{α} {C}_{β} - \dot{β} {λ}_{3 n} {C}_{α} {S}_{β} - {k}_{wn} {\dot{z}}_{12 n}}{{c}_{wn}} \qquad ( 122 )$$

or from the third equation of constraint:

$$\begin{matrix}{\ddot{z}}_{0} + \{ {\ddot{z}}_{12 n} cos α - {\dot{z}}_{12 n} \dot{α} cos α - \ddot{α} {z}_{12 n} sin α - \dot{α} {\dot{z}}_{12 n} sin α - {\dot{α}}^{2} {z}_{12 n} cos α + ( \ddot{α} + {\dot{θ}}_{n} ) {e}_{3 n} cos ( α + {γ}_{n} + {θ}_{n} ) - {( \dot{α} + {\dot{θ}}_{n} )}^{2} {e}_{3 n} sin ( α + {γ}_{n} + {θ}_{n} ) - \ddot{α} {c}_{2 n} sin ( α + {γ}_{n} ) - {\dot{α}}^{2} {c}_{2 n} cos ( α + {γ}_{n} ) + \ddot{α} {b}_{2 n} cos α - {\dot{α}}^{2} {b}_{2 n} sin α \} cos β - \dot{β} \{ {\dot{z}}_{12 n} cos α - \dot{α} {z}_{12 n} sin α + ( \dot{α} + {\dot{θ}}_{n} ) {e}_{3 n} cos ( α + {γ}_{n} + {θ}_{n} ) - \dot{α} {c}_{2 n} sin ( α + {γ}_{n} ) + \dot{α} {b}_{2 n} cos α \} sin β - \ddot{β} [ \{ {z}_{12 n} cos α + {e}_{3 n} sin ( α + {γ}_{n} + {θ}_{n} ) + {c}_{2 n} cos ( α + {γ}_{n} ) + {b}_{2 n} sin α \} sin β + {a}_{1 n} cos β ] - \dot{β} [ \{ {\dot{z}}_{12 n} cos α - \dot{α} {z}_{12 n} sin α + ( \dot{α} + {\dot{θ}}_{n} ) {e}_{3 n} cos ( α + {γ}_{n} + {θ}_{n} ) - ( \dot{α} + {\dot{γ}}_{n} ) {c}_{2 n} sin ( α + {γ}_{n} ) + \dot{α} {b}_{2 n} cos α \} sin β + \dot{β} \{ {z}_{12 n} cos α + {e}_{3 n} sin ( α + {γ}_{n} + {θ}_{n} ) + {c}_{2 n} cos ( α + {γ}_{n} ) + {b}_{2 n} sin α \} cos β - \dot{β} {a}_{1 n} sin β ] - {\ddot{R}}_{n} ( t ) = 0 & ( 123 ) \\ {\ddot{z}}_{12 n} = \frac{\begin{matrix}{\ddot{z}}_{0} + \{ - {\dot{z}}_{12 n} \dot{α} cos α - \ddot{α} {z}_{12 n} sin α - \dot{α} {\dot{z}}_{12 n} sin α - {\dot{α}}^{2} {z}_{12 n} cos α + \\ ( \ddot{α} + {\dot{θ}}_{n} ) {e}_{3 n} cos ( α + {γ}_{n} + {θ}_{n} ) - {( \dot{α} + {\dot{θ}}_{n} )}^{2} {e}_{3 n} sin ( α + {γ}_{n} + {θ}_{n} ) - \\ \ddot{α} {c}_{2 n} sin ( α + {γ}_{n} ) - {\dot{α}}^{2} {c}_{2 n} cos ( α + {γ}_{n} ) + \ddot{α} {b}_{2 n} cos α - \\ {\dot{α}}^{2} {b}_{2 n} sin α \} cos β - \dot{β} \{ {\dot{z}}_{12 n} cos α - \dot{α} {z}_{12 n} sin α + \\ ( \dot{α} + {\dot{θ}}_{n} ) {e}_{3 n} cos ( α + {γ}_{n} + {θ}_{n} ) - \dot{α} {c}_{2 n} sin ( α + {γ}_{n} ) + \\ \dot{α} {b}_{2 n} cos α \} sin β - \ddot{β} [ \{ {z}_{12 n} cos α + {e}_{3 n} sin ( α + {γ}_{n} + {θ}_{n} ) + \\ {c}_{2 n} cos ( α + {γ}_{n} ) + {b}_{2 n} sin α \} sin β + {a}_{1 n} cos β ] - \\ \dot{β} [ \{ {\dot{z}}_{12 n} cos α - \dot{α} {z}_{12 n} sin α + ( \dot{α} + {\dot{θ}}_{n} ) {e}_{3 n} cos ( α + {γ}_{n} + {θ}_{n} ) - \\ ( \dot{α} + {\dot{γ}}_{n} ) {c}_{2 n} sin ( α + {γ}_{n} ) + \dot{α} {b}_{2 n} cos α \} sin β + \\ \dot{β} \{ {z}_{12 n} cos α + {e}_{3 n} sin ( α + {γ}_{n} + {θ}_{n} ) + {c}_{2 n} cos ( α + {γ}_{n} ) + \\ {b}_{2 n} sin α \} cos β - \dot{β} {a}_{1 n} sin β ] - {\ddot{R}}_{n} ( t )\end{matrix}}{( - cos α cos β )} & ( 124 )\end{matrix}$$

IV. Equations for Entropy Production

Minimum entropy production (for use in the fitness function of the genetic algorithm) is expressed as:

$$\begin{matrix}\frac{{d}_{β} S}{ⅆ t} = \frac{\begin{matrix}- 2 {\dot{β}}^{2} [ \dot{α} {m}_{b} {A}_{1} {A}_{2} + {m}_{sn} {B}_{1} \{ {\dot{z}}_{6 n} {C}_{αγ η n} - ( \dot{α} + {\dot{η}}_{n} ) {z}_{6 n} {S}_{αγη n} - \\ \dot{α} {A}_{4} \} + {m}_{an} {B}_{2} \{ ( \dot{α} + {\dot{θ}}_{n} ) {e}_{1 n} {C}_{αγθ n} - \dot{α} {A}_{6} \} + \\ {m}_{wn} {B}_{3} \{ ( \dot{α} + {\dot{θ}}_{n} ) {e}_{3 n} {S}_{αγθ n} - \dot{α} {A}_{6} \} - {\dot{z}}_{0} ( {m}_{ba} + {m}_{sawan} ) {S}_{β} / 2 ]\end{matrix}}{{m}_{saw2n} + {m}_{ba1} + {m}_{b} {A}_{1}^{2} + {m}_{sn} {B}_{1}^{2} + {m}_{an} {B}_{2}^{2} + {m}_{wn} {B}_{3}^{2}} & ( 125 ) \\ \frac{{d}_{α} S}{ⅆ t} = \frac{- 2 {\dot{α}}^{2} \{ {m}_{sn} \dot{α} {\dot{z}}_{6 n} ( {z}_{6 n} + {E}_{1 n} ) + {m}_{sn} {z}_{6 n} {\dot{η}}_{n} {E}_{2 n} + {\dot{θ}}_{n} {m}_{aw1n} {H}_{2 n} \}}{{m}_{bb1} + {m}_{saw1n} + {m}_{sn} {z}_{6 n} ( {z}_{6 n} + 2 {E}_{1 n} ) - 2 {m}_{aw1n} {H}_{1 n}} & ( 126 ) \\ \frac{{d}_{{η}_{n}} S}{ⅆ t} = {\dot{η}}_{n}^{3} t g {η}_{n} - \frac{2 {\dot{η}}_{n}^{2} {\dot{z}}_{6 n}}{{z}_{6 n} - {d}_{1 n}} & ( 127 ) \\ \frac{{d}_{{z}_{6 n}} S}{ⅆ t} = 2 {\dot{η}}_{n} {\dot{z}}_{6 n}^{2} tg {η}_{n} & ( 128 ) \\ \frac{{d}_{{z}_{12 n}} S}{ⅆ t} = {\dot{z}}_{12 n}^{2} ( \dot{α} + \dot{α} tg α + 2 \dot{β} tg β ) & ( 129 )\end{matrix}$$

The learning module 101 gains pseudo-sensor signals based on the kinetic models of the vehicle and suspensions obtained by the above-described methods. Then, the learning module 101 directs the learning control unit to operate based on the pseudo-sensor signals. Further, at the optimized part, the learning module 101 calculates the time differential of the entropy from the learning control unit and time differential of the entropy inside the controlled process. In this embodiment, the entropy inside the controlled processes is obtained from the kinetic models as described above. This embodiment utilizes the time differential of the entropy dS_{cs}/dt (where S_{cs}, is S_{c} for the suspension) relative to the vehicle body and dSₛ/dt to which time differential of the entropy dSₛₛ/dt (where the subscript ss refers to the suspension) relative to the suspension is added. Further, this embodiment employs the damper coefficient control type shock absorber. Since the learning control unit (control unit of the actual control module 101) controls the throttle amount of the oil passage in the shock absorbers, the speed element is not included in the output of the learning control unit. Therefore, the entropy of the learning control unit is reduced, and tends toward zero.

The optimized part defines the performance function as a difference between the time differential of the entropy from the learning control unit and time differential of the entropy inside the controlled process. The optimized part genetically evolves teaching signals (input/output values of the fuzzy neural network) in the learning control unit with the genetic algorithm so that the above difference (i.e., time differential of the entropy for the inside of the controlled process in this embodiment) becomes small. The learning control unit is optimized based on the learning of the teaching signals.

Then, the parameters (fuzzy rule based in the fuzzy reasoning in this embodiment) for the control unit at the actual control module 101 are determined based on the optimized learning control unit. Thereby, the optimal regulation of the suspensions with nonlinear characteristic can be allowed.

Various kinds of methods are used in active or semi-active suspension systems, to control the damping force of the vehicle suspension. In some systems, the transfer function of the suspension system is controlled by various numbers of sensors providing data to a classic control algorithm (e.g., a PID algorithm). Alternatively, modern control algorithms can be used, but such systems typically use many sensors to get sufficient information about the vehicle condition.

This disclosure describes an intelligent control system with a reduced number of sensors without reducing performance of the fuzzy controller. Information from the sensor signal is extracted and the knowledge base is created to realize both good riding comfort and stability. The result is evaluated by simulation and field tests.

In order to make it possible to represent non-linear movement, four local coordinates for each suspension and three for the vehicle body, totaling 19 local coordinates are considered using the mathematical vehicle model described in connection with FIGS. 3-7 above. Equations of motion are derived above based on Lagrange's approach.

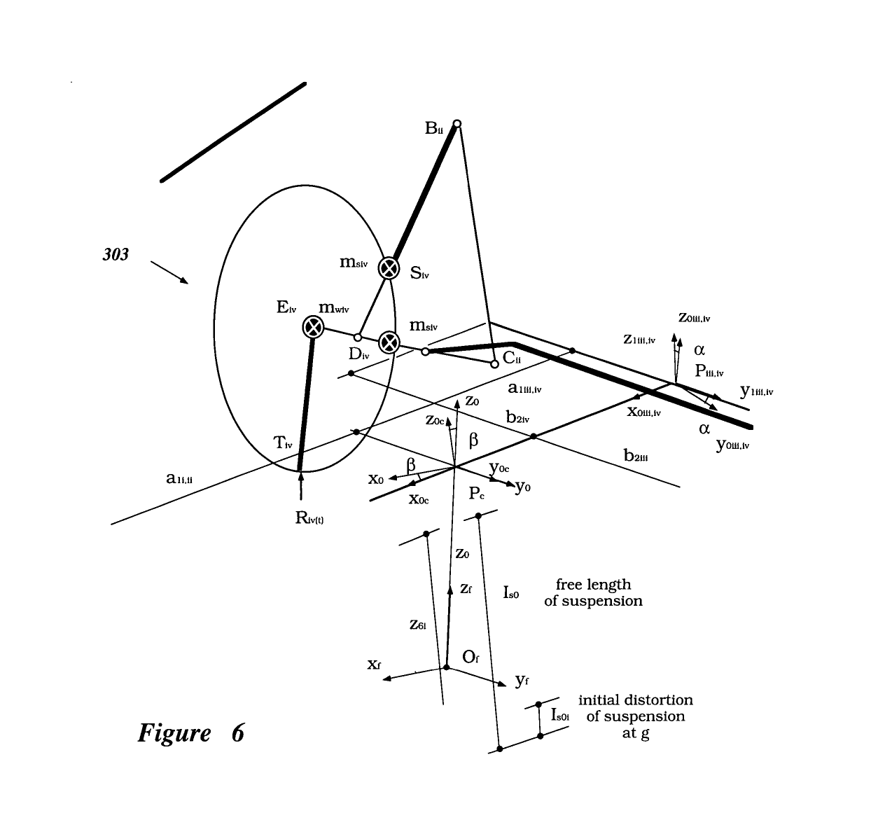

Principal parameters of the test vehicle are shown in Table 1 and the characteristics of the variable dampers are shown in FIG. 6. In one embodiment, the valves of the dampers are controlled by a stepper motor with nine steps from the softest position to the hardest. In the example described below, it takes 7.5 ms to make a one-step shift. Faster or slower one-step shifts can also be used.

TABLE 1

| Parameter | Front | Rear | Units |
|---|---|---|---|
| Mb: Body mass | 1594 | | kg |
| Ms: Suspension mass | 3.9 | 5.6 | kg |
| Ma: Lower arm mass | 4.4 | 6.6 | kg |
| Mw: Wheel mass | 28.3 | 37 | kg |
| Ks: Suspension spring constant | 50000 | 45000 | N/m |
| Kw: Tire spring constant | 191300 | 131300 | N/m |
| Cw: Tire damping coefficient | 100 | 100 | Ns/m |
| Kz: Torsion bar spring constant | 26300 | 14300 | N/m |

| | | |
|---|---|---|
| Ibx: Body roll moment of inertia | 431 | kgm² |
| Iby: Body pitch moment of inertia | 1552 | kgm² |
| a₁: Wheel base | 2.78 | m |

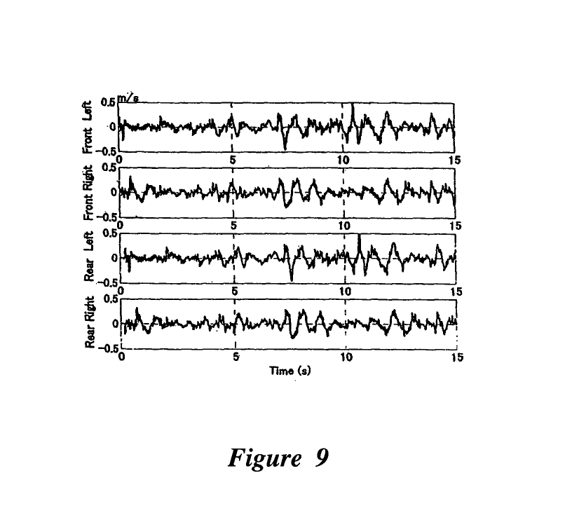

Measured road profile data are differentiated and used as input velocity signals of each wheel as shown in FIG. 9. The road related to the data shown in FIG. 9 is referred to as the teaching signal road. Signals from the rear wheels are delayed for 200 ms corresponding to the time difference between the front wheels and the rear wheels at a vehicle speed of 50 km/h.

The behavior of the car body is often discussed in terms of acceleration and jerk. However, acceleration and jerk are not necessarily well suited to control both vehicle stability and riding comfort. The stability is dominated mainly by low frequency components around 1 Hz, and the comfort by frequency components above 4 or 5 Hz. Three axes of heave, pitch, and roll also are considered.

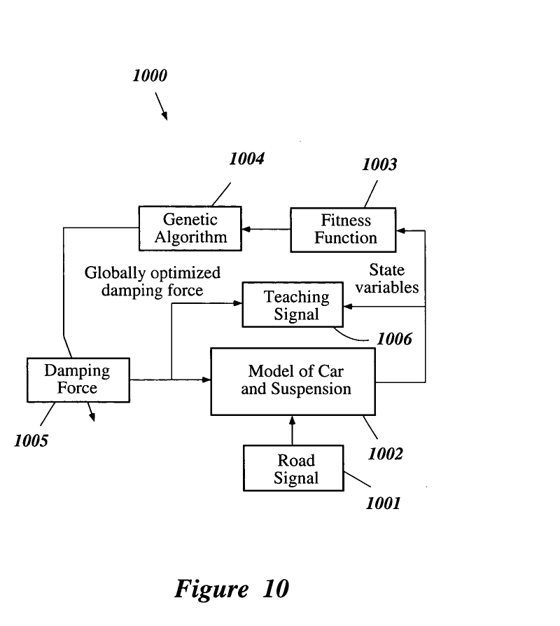

FIG. 10 is a block diagram of a system 1000 for generating a teaching signal. In the system 1000, a road signal 1001 is provided to a model 1002 that models the car and suspension. State variable outputs from the model 1002 are provided to a teaching signal memory 1006 and to a fitness function 1003. The Fitness Function (FF) 1003 is provided to a genetic algorithm 1004. The genetic algorithm 1004 is provided to optimize damping forces provided to the model 1002 and to the teaching signal memory 1006.

In one embodiment, the following Fitness Function (FF) 1003 is used to reduce the low frequency component of pitch angular acceleration to get better stability and high frequency components of heave acceleration to get better riding comfort.

FF=|Aₚ(1)|+|Aₕ(5)|+|ₕ(9)|+|ₕ(12)|+|Aₕ(13)|

where Aₚ(1) is the amplitude of the 1 Hz pitch angular acceleration, and Aₕ(n) is the n Hz component of the heave acceleration.

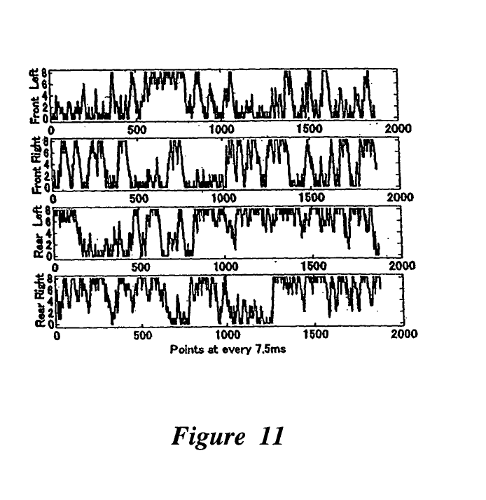

The equations of motion from the mathematical vehicle model described above are used in the model 1002 (configured, such as, for example, as a Simulink model) to describe the dynamics of the vehicle and suspension system when disturbed by the road signal. The output from the model 1002 is used to generate the teaching signal, as shown in FIG. 10. Using the road signal 1001 and damping coefficients for the four dampers being controlled, the mathematical model 1002 calculates the motions of the car and suspension. The Genetic Algorithm 1004 searches for the best damping coefficients (for the dampers) that minimize the FF 1003 at each timestep (e.g., 7.5 ms). A series of such damping coefficients are stored as teaching signal data in the teaching signal memory 1006. A sample teaching signal is shown in FIG. 11.

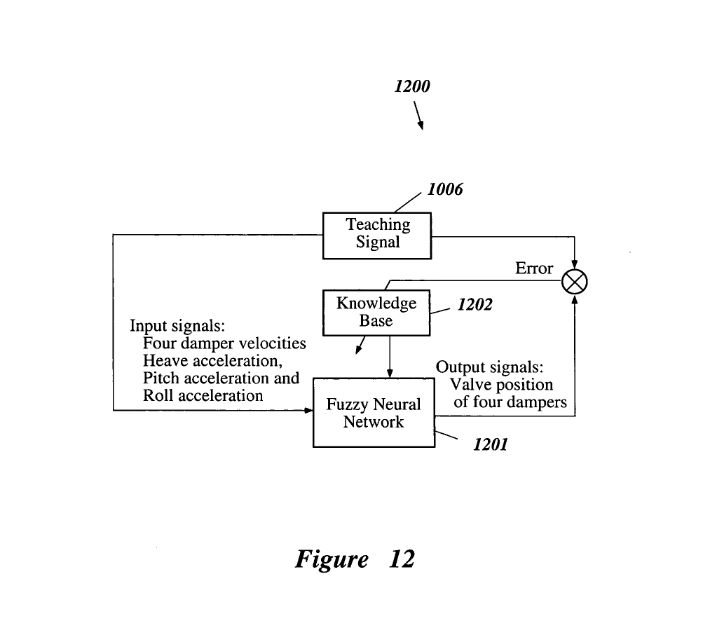

FIG. 12 is a block diagram of a learning scheme for training a Fuzzy Neural Network (FNN) 1201 in a seven-sensor system. Inputs to the FNN 1201 include four damper velocities, have acceleration, pitch acceleration, and roll acceleration. Outputs of the FNN 1201 include valve positions of the four dampers. The valve position outputs from the FNN 1201 are subtracted from the valve positions in the teaching signal to produce an error signal that is provided to configure a Knowledge Base (KB) 1202.

An adaptive fuzzy modeler (such as, for example, an Adaptive Fuzzy Modeler by STMicroelectronics) can be used for learning. In one embodiment, the adaptive fuzzy modeler builds rules through an unsupervised learning on a Winner-Take-All Fuzzy Associative memory neural network. The tuning of the position and the shape of each input/output membership function is carried out by a Supervised Learning on a multiplayer Backward-propagation Fuzzy Associate Memory neural network. In one embodiment, the fuzzy model is of zero-order Sugeno type.

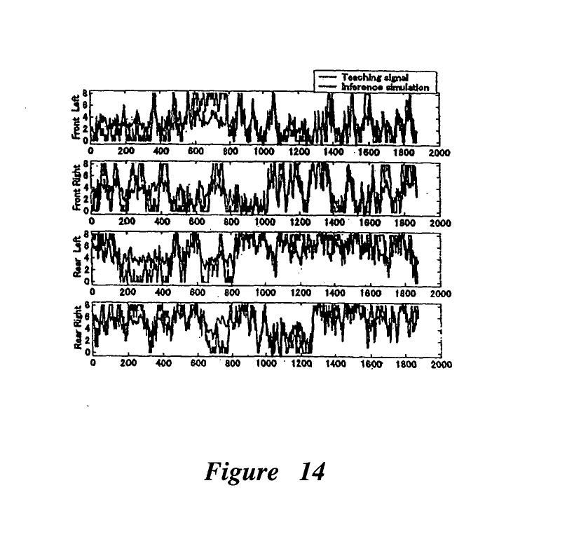

Since the damping force is a non-linear function of the damper velocity, in one embodiment, seven kinds of signal sources are used to control the body movement along three axes with such independent dampers acting as actuators. In such case, three body acceleration signals of heave, pitch, and roll and four damper velocity signals are used as input for fuzzy inference, as shown in FIG. 12. The knowledge base 1202 is obtained by learning the teaching signal from the teaching signal storage 1006. FIG. 14 shows the inference simulation by the knowledge base compared with the teaching signal.

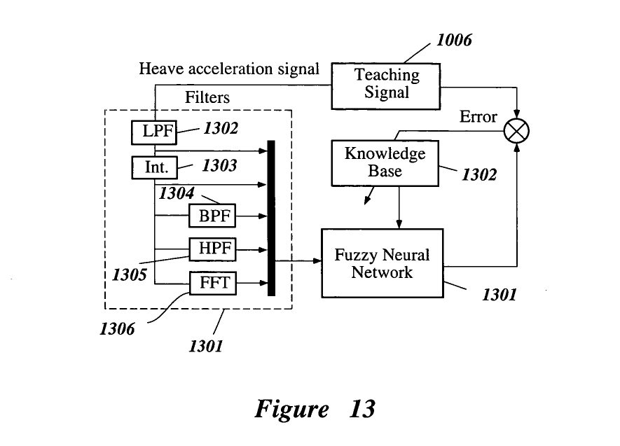

The movements of heave, pitch, and roll of the car body are in the mode of coupled vibration and are relatively closely related to each other. Vertical translation motion induces pitching and rolling motion. Therefore the latter two movements can be estimated by observing the movement of heave. The heave signal typically has certain information about the wheel movement. In this case, several kinds of information can be extracted from the heave acceleration signal through filters, as shown in FIG. 13.

In FIG. 13, the heave acceleration signal from the teaching signal storage 1006 is provided for a first input of a subtractor and to a lowpass filter 1302 in a filters block 1301. An output of the lowpass filter is provided to an integrator 1303 and to a first input of a FNN 1301. An output of the integrator 1303 is provided to a second input of the FNN 1301 and to a bandpass filter 1304, a highpass filter 1305 and to a Fast Fourier Transform (FFT) module 1306. Outputs of the bandpass filter 1304, a highpass filter 1305 and to a Fast Fourier Transform (FFT) module 1306 are provided to respective inputs of the FNN 1301. Valve position outputs from the FNN 1301 are provided to a second input of the subtractor. An output of the subtractor is an error signal that is provided to configure a KB 1302. The KB 1302 is provided to the FNN 1301.

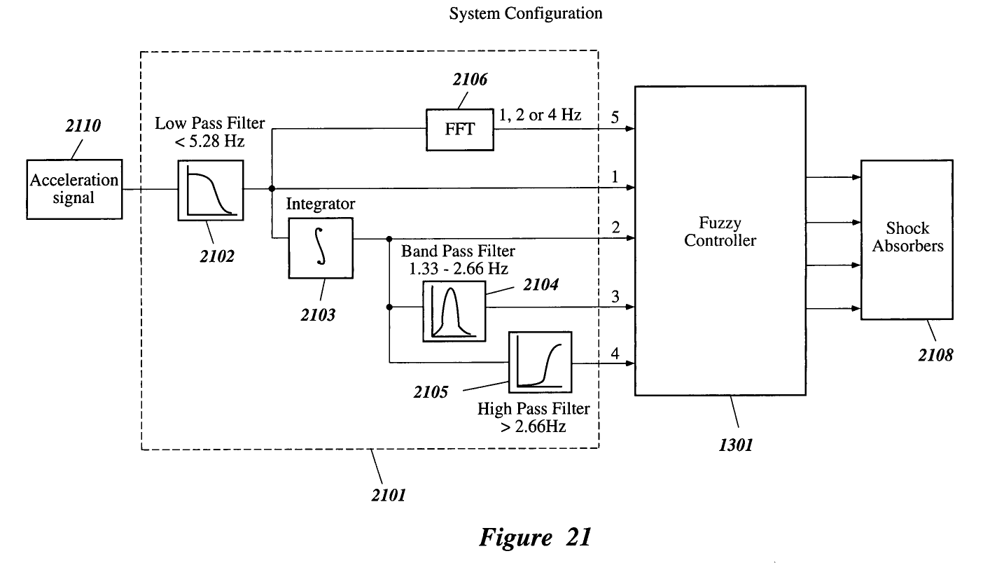

FIG. 21 shows an alternate embodiment of the inputs to the FNN 1301, wherein the heave acceleration signal 2110 is filtered by filters block 2101. In the filters block 2101 a low pass filter 2102 for noise canceling. An output of the lowpass filter 2102 is provided to the FNN 1301 as input 1 and to the velocity signal input through an integrator 2103. The velocity output of the integrator 2103 is provided to the FNN 1301 as input 2 and to inputs of a bandpass filter 2104 and a highpass filter 2105. Information of the movement around the natural frequency of the car body is extracted by the bandpass filter for input 3 of the FNN 1301. The frequency components above 5 Hz, are extracted by a highpass filter 2105 and an FFT 2106 to represent road roughness, are applied as inputs 4 and 5 respectively.

The same teaching signal is used for learning as is used for a seven-sensor system. FIG. 9 shows the inference simulation by the knowledge base compared with the teaching signal. Fuzzy modeling parameters and the results of learning are shown in Table 2.

TABLE 2

| Fuzzy system | Seven-sensor | Single-sensor |
|---|---|---|
| Modeling parameters | | |
| Antecedent number | 7 | 5 |
| Consequent number | 4 | 5 |
| Fuzzy set number | 4 | 4 |
| Inference method | Product | Product |
| Antecedent shape | Gaussian | Gaussian |
| Learning result | | |
| Rule number | 333 | 248 |
| Error | 6.526 | 5.457 |

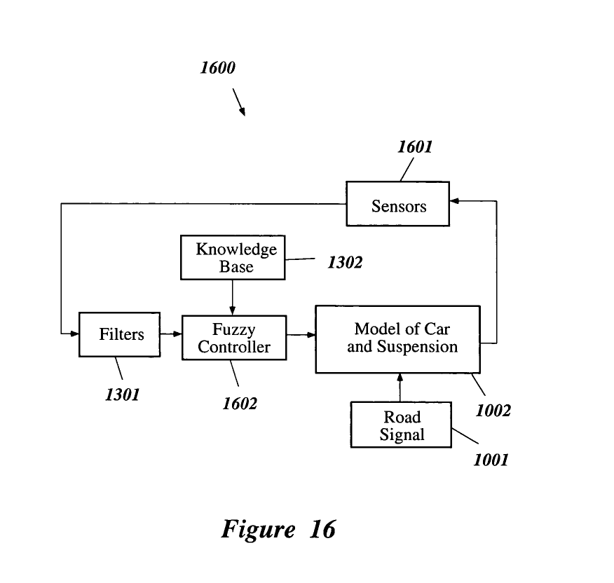

FIG. 16 is a block diagram of a fuzzy control simulation 1600. In the simulation 1600, Simulation is carried out using the model 1002 except that the damping coefficients are controlled by a fuzzy controller 1602 that uses the KB 1302. Sensors 1601 detect heave acceleration of the system and the measured heave is provided to the filters 1301 (or alternatively 2101) to generate inputs for a FNN in the fuzzy controller 1602.

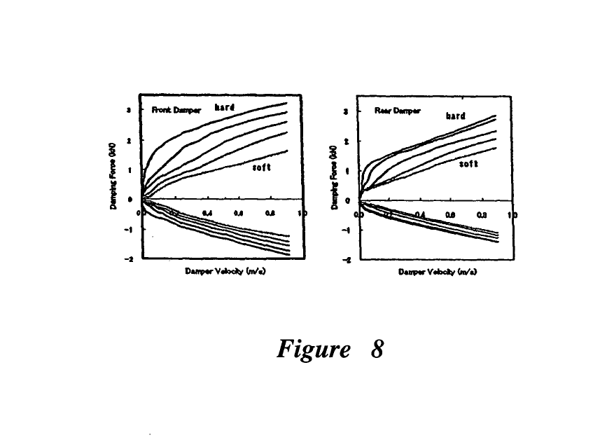

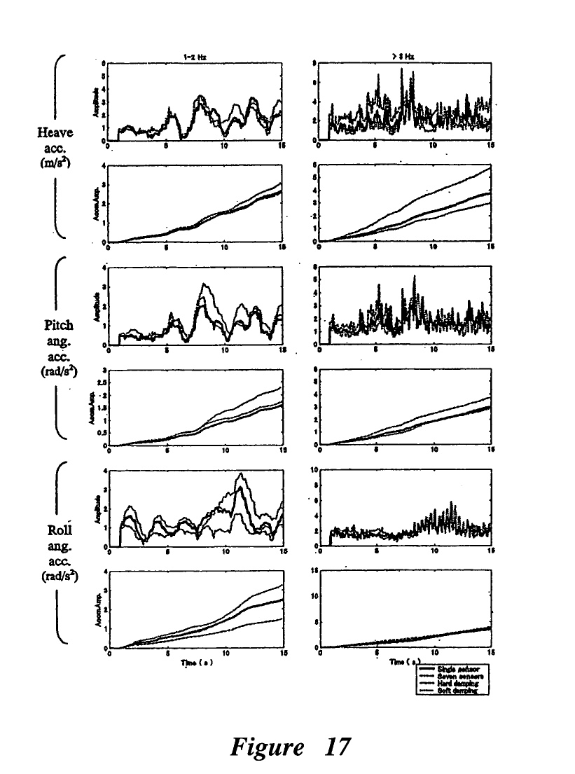

Both of the simulation results by the seven-sensor and the single-sensor systems are shown in FIG. 17. Simulation results without control are also added in the figure for reference. During hard damping, the damping coefficient is kept at or near the maximum position as in shown in FIG. 8. During soft damping, the damping coefficient is kept at or near the minimum position as in shown in FIG. 8.

The figure shows three groups; heave, pitch, and roll. The lower raw data of each group shows accumulated amplitude to show the difference between lines while the upper raw data shows the time history of the amplitude itself.

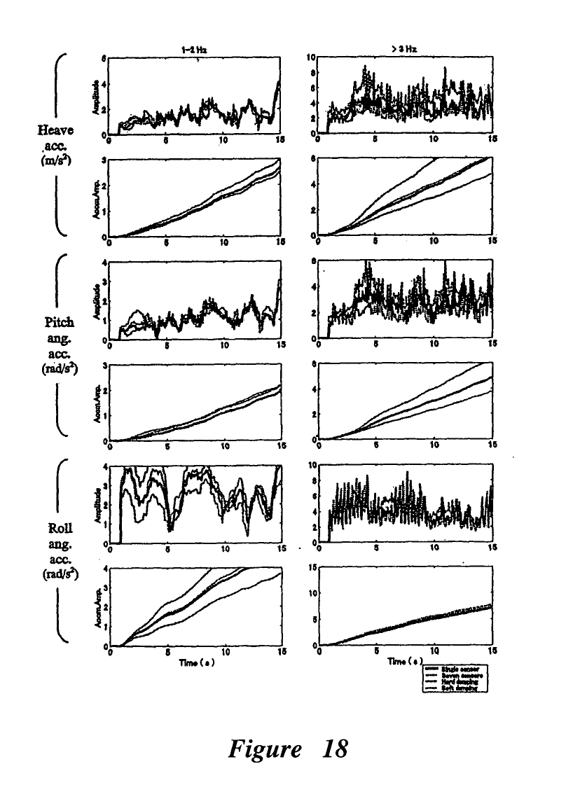

In order to investigate the robustness of the knowledge base, another simulation is carried out (shown in FIG. 18) with stochastic road signals that have characteristics different from the teaching signal road.

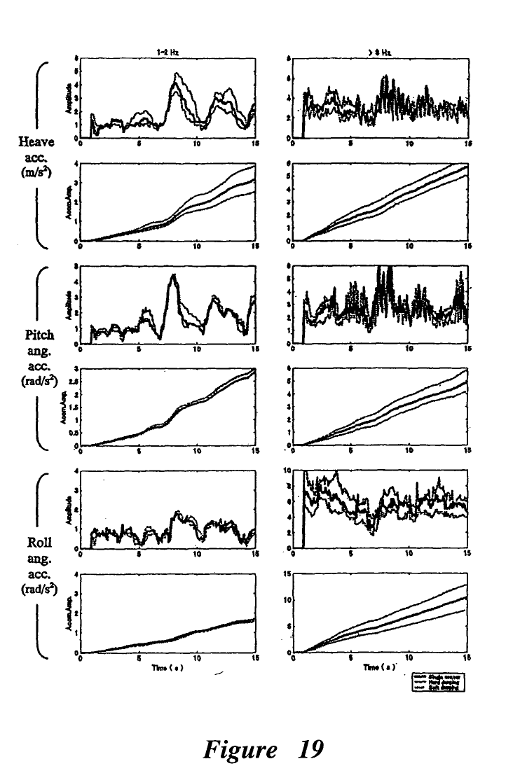

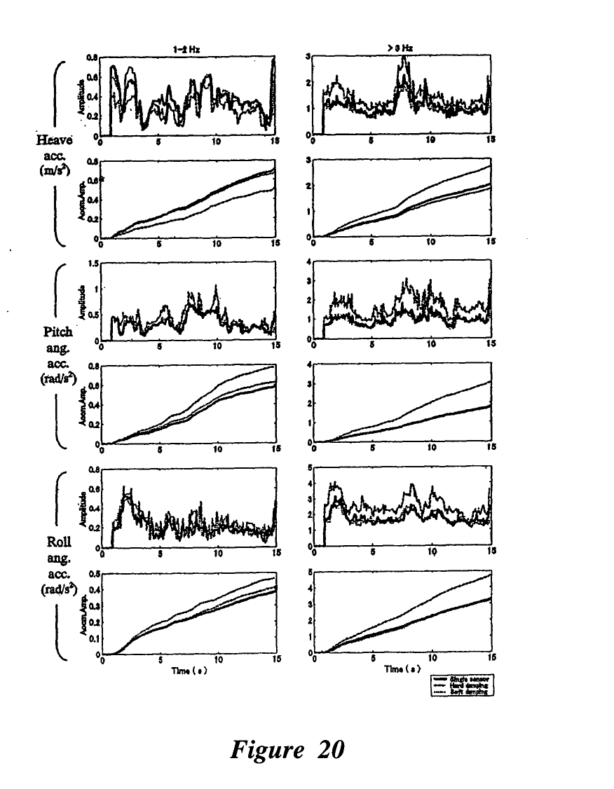

Field test with a single-sensor system and with a fixed damping coefficients on the teaching signal road are shown in FIG. 19. The test condition in FIG. 19 was similar to the simulation except that the road was changed after the road signal measurement and that the signal of the accelerometer on the vehicle body contains more high-frequency components than the simulation. FIG. 20 shows additional field test results on a second road in order to further demonstrate investigate the robustness of the control system.

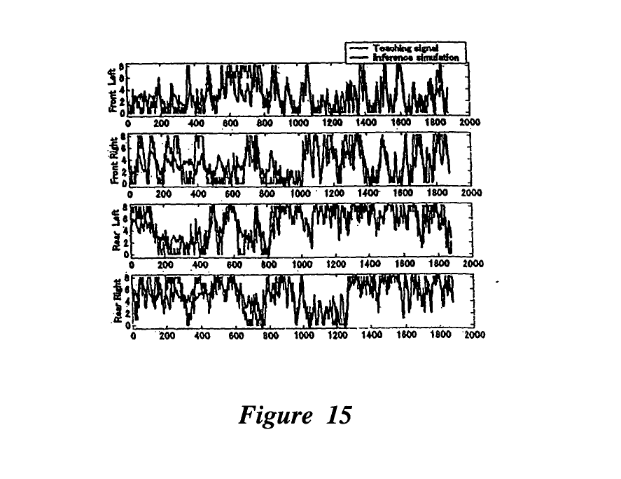

The learning results show that the error of a single sensor system tends to be smaller, even though it has a fewer number of rules (see Table 2), which is also found on the inference simulation (FIGS. 14-15).

Control performance of the fuzzy controller with these knowledge bases is, in general, similar as the road signals of the teaching signal road are applied, as seen in FIG. 17. Low frequency components of the pitch movement are well reduced as intended by the fitness function though the high frequency components of heave are insufficient.

However, the single-sensor system shows an advantage on different roads because of its robustness (FIG. 18). In the single-sensor system, various frequency components are reduced by the fitness function better than in the seven-sensor system.

The single-sensor system shows a similar control performance in the field (FIG. 19) as the simulation. It works well even on other roads (FIG. 20), which means that the knowledge base has learned important information about the characteristics of the vehicle behavior, and thus, the fuzzy system can extract information properly from the single signal source of the heave acceleration.

Thus, model-based design methodology of a robust intelligent semi-active suspension control system can be applied to a passenger car. A globally optimized teaching signal for damper control can be generated by a generic algorithm, the fitness function of which is settled to satisfy conflicting requirements of riding comfort and stabile of the car body. A fuzzy controller can be realized to accurately and robust control with properly selected input signals that are provided by a single accelerometer through appropriate filters. It is described that the knowledge base can be optimized for various kinds of stochastic road signals on a computer without carrying out actual field tests.

Although the foregoing has been a description and illustration of specific embodiments of the invention, various modifications and changes can be made thereto by persons skilled in the art, without departing from the scope and spirit of the invention as defined by the following claims.

What is claimed is:

1. A control system for optimizing the performance of a vehicle suspension system by controlling the damping factor of one or more shock absorbers, comprising:
a fuzzy neural network having a knowledge base trained by using a teaching signal;
one or more sensors to sense heave acceleration and produce a heave acceleration signal;
a lowpass filter to remove high-frequency noise from said heave acceleration signal to produce a filtered heave acceleration signal for said fuzzy neural network;
an integrator to produce a velocity signal from said filtered heave acceleration signal for said fuzzy neural network;
a bandpass filter to produce a bandpass filtered velocity signal for said fuzzy neural network;
a high filter to produce a highpass filtered velocity signal for said fuzzy neural network; and
a Fourier transform to extract frequency components of said velocity signal for said fuzzy neural network.

2. The control system of claim 1, wherein said bandpass filter selects frequency components related to natural frequencies of the vehicle body.

3. The control system of claim 1, wherein said highpass filter selects frequency components above 5 Hertz.

4. The control system of claim 1, wherein said highpass filter selects frequency components related to wheel hops.

5. The control system of claim 1, wherein said Fourier transform provides frequency components around 1 Hertz.

6. The control system of claim 1, wherein said Fourier transform filter selects frequency components related to road roughness.

7. The control system of claim 1, wherein said teaching signal is generated by applying a learning road signal to a model of said suspension system and optimizing damping factor of said shock absorbers by a genetic algorithm.

8. The control system of claim 7, wherein a fitness function used by said genetic algorithm is configured to reduce relatively low frequency components of pitch angular acceleration to provide better stability.

9. The control system of claim 7, wherein a fitness function used by said genetic algorithm is configured to reduce relatively high frequency components of heave acceleration to provide better riding comfort.

10. The control system of claim 7, wherein a fitness function used by said genetic algorithm is configured to reduce relatively low frequency components of pitch angular acceleration and to reduce relatively high frequency components of heave acceleration.

11. An optimization control method for controlling a vehicle suspension system comprising:
generating a teaching signal by:
applying a road signal to a model of a vehicle and suspension system; and
using a genetic optimizer to optimize damping forces of a plurality of shock absorbers in said suspension system disturbed by said road signal;
generating a knowledge base for a fuzzy neural network by;
filtering a heave acceleration signal portion of said teaching signal to generate a plurality of inputs for said fuzzy neural network;
developing an error signal by comparing damper control values in said teaching signal to damper control values produced by said fuzzy neural network; and
configuring said knowledge base to reduce said error signal; and
providing said knowledge base to a fuzzy neural network in a fuzzy controller to control said vehicle suspension system.

12. The optimization control method of claim 11, wherein said genetic optimizer uses a fitness function configured to reduce relatively low frequency components of pitch angular acceleration and to reduce relatively high frequency components of heave acceleration.

13. The optimization control method of claim 11, wherein said genetic optimizer uses a fitness function configured to reduce relatively low frequency components of pitch angular acceleration.

14. The optimization control method of claim 1, wherein said control unit comprises a learning control module and an actual control module, said method further including the steps of optimizing a control parameter based on said genetic algorithm by using a performance function, determining a control parameter of said actual control module based on said control parameter and controlling said shock absorber using said actual control module.

15. The optimization control method of claim 14, wherein said step of optimization of said learning control unit is performed using a simulation model, said simulation model based on a kinetic model of a vehicle suspension system.

16. The optimization control method of claim 14, wherein said shock absorber is arranged to alter a damping force by altering a cross-sectional area of an oil passage, and said control unit controls a throttle valve to thereby adjust said cross-sectional area of said oil passage.

17. A method for control of a plant comprising:
applying a road signal to a model of a vehicle and suspension system and using a genetic optimizer in a first control system to optimize damping forces of a plurality of shock absorbers in said suspension system disturbed by said road signal;
generating a knowledge base for a fuzzy neural network by filtering a heave acceleration signal portion of said teaching signal to generate a plurality of inputs for said fuzzy neural network and configuring said knowledge base by comparing outputs of said fuzzy neural network to at least a portion of said training signal; and
providing said knowledge base to a second control system to control said vehicle suspension system.

18. The method of claim 17, wherein said first control system comprises a heave signal input.

19. The method of claim 17, wherein said second control system comprises a heave signal input.

20. The method of claim 17, wherein said model comprises a dynamic model.

21. The method of claim 17, wherein said second control system receives sensor input data from one or more acceleration sensors.

22. The method of claim 17, wherein said filtering comprises lowpass filtering, bandpass filtering, and highpass filtering.

23. The method of claim 17, wherein said filtering comprises applying a Fourier transform to portions of said heave acceleration signal.

24. The control system of claim 17, wherein said filtering comprises bandpass filtering to select frequency components related to natural frequencies of the vehicle body.

25. The control system of claim 17, wherein said filtering comprises lowpass filtering to remove noise followed by highpass filtering to select frequency components above 5 Hertz.

26. The control system of claim 17, wherein said filtering comprises highpass filtering to select frequency components related to wheel hops.

27. The control system of claim 17, wherein said filtering comprises lowpass filtering to remove noise followed by Fourier transforming to provide frequency components around 1 Hertz.

28. The control system of claim 17, wherein said filtering comprises Fourier transforming to select frequency components related to road roughness.

29. The control system of claim 17, wherein said filtering comprises integrating an acceleration signal to produce a velocity signal followed by highpass filtering to select frequency components related to wheel hops.

30. The control system of claim 17, wherein said filtering comprises integrating an acceleration signal to produce a velocity signal followed by bandpass filtering to select frequency components related to natural frequencies of the vehicle body.

31. A control system, comprising:
a fuzzy controller configured to control damping coefficients of shock absorbers in a vehicle suspension system;
at least one sensor to provide sensor data; and
means for filtering said sensor data to produce a plurality of input signals for a fuzzy neural network in said fuzzy controller.

32. The control system of claim 31, wherein said means for filtering comprises at least one of an integrator, a differentiator, a low-pass filter, a band-pass filter, and a high-pass filter.

33. The control system of claim 31, wherein said means for filtering comprises a Fourier transform process for extracting one or more focused frequency components.

34. The control system of claim 31, wherein said means for filtering comprises band-pass filtering corresponding to a resonance frequency of a heave movement, a pitch movement, or a roll movement.

35. A control system for optimizing the performance of a vehicle suspension system by controlling the damping factor of one or more shock absorbers, comprising:
a fuzzy neural network having a knowledge base trained by using a teaching signal;
one or more sensors to sense heave acceleration and produce a heave acceleration signal;
a lowpass filter to remove high-frequency noise from said heave acceleration signal to produce a filtered heave acceleration signal for said fuzzy neural network;
an integrator to produce a velocity signal from said filtered heave acceleration signal for said fuzzy neural network;
a bandpass filter to produce a bandpass filtered velocity signal for said fuzzy neural network;
a high filter to produce a highpass filtered velocity signal for said fuzzy neural network; and
a Fourier transform to extract frequency components of said filtered heave acceleration signal for said fuzzy neural network.

36. The control system of claim 35, wherein said bandpass filter selects frequency components related to natural frequencies of the vehicle body.

37. The control system of claim 35, wherein said highpass filter selects frequency components above 5 Hertz.

38. The control system of claim 35, wherein said highpass filter selects frequency components related to wheel hops.

39. The control system of claim 35, wherein said Fourier transform provides frequency components around 1 Hertz.

40. The control system of claim 35, wherein said Fourier transform filter selects frequency components related to road roughness.

41. The control system of claim 35, wherein said teaching signal is generated by applying a learning road signal to a model of said suspension system and optimizing damping factor of said shock absorbers by a genetic algorithm.

42. The control system of claim 41, wherein a fitness function used by said genetic algorithm is configured to reduce relatively low frequency components of pitch angular acceleration to provide better stability.

43. The control system of claim 41, wherein a fitness function used by said genetic algorithm is configured to reduce relatively high frequency components of heave acceleration to provide better riding comfort.

44. The control system of claim 41, wherein a fitness function used by said genetic algorithm is configured to reduce relatively low frequency components of pitch angular acceleration and to reduce relatively high frequency components of heave acceleration.
